(19) United States
(12) Patent Application Publication
(10) Pub. No.: US 2024/0380629 A1
(43) Pub. Date: Nov. 14, 2024

(54) PROGRAM, INFORMATION PROCESSING METHOD, TERMINAL, AND SERVER

(71) Applicant: LY CORPORATION, Tokyo (JP)

(72) Inventors: Ryosuke HAMASAKO, Tokyo (JP); Yosuke MAZAKI, Tokyo (JP)

(73) Assignee: LY CORPORATION, Tokyo (JP)

(21) Appl. No.: 18/779,869

(22) Filed: Jul. 22, 2024

Related U.S. Application Data
(63) Continuation of application No. PCT/JP2023/002558, filed on Jan. 27, 2023.

(30) Foreign Application Priority Data
Jan. 28, 2022 (JP) 2022-012460
Jan. 28, 2022 (JP) 2022-012461
Jan. 28, 2022 (JP) 2022-012462

(51) Int. Cl. H04L 12/18; H04L 51/224

(52) U.S. Cl. CPC H04L 12/1822; H04L 51/224

(57) ABSTRACT

Provided are non-transitory computer readable mediums storing a program, information processing methods, terminals, and servers. A non-transitory computer readable medium storing a program that, when executed by processing circuitry, causes a terminal to output sound information and video information transmitted and received in a first group of an online meeting, by performing a method, which includes receiving, by a communication device of the terminal, information transmitted to the first group and related to an invitation to a second group given to a user of the terminal; and performing, by the processing circuitry, control to give notification of the information related to the invitation may be provided.

### CROSS-REFERENCE TO RELATED APPLICATIONS

This application is a continuation of, and claims the benefit of priority under 35 U.S.C. §§ 120 and 365(c) from PCT International Application No. PCT/JP2023/002558, which has an international filing date of Jan. 27, 2023 and claims priority to Japanese Application Nos. JP2022-012460, JP2022-012461, and JP2022-012462, filed Jan. 28, 2022, the entire contents of each of which are hereby incorporated by reference.

### BACKGROUND

### Technical Field

The present disclosure relates to information processing methods, non-transitory computer readable mediums storing a computer program for performing the methods, terminals for performing the methods, servers for performing the methods, and the like.

### Background Art

Technology for enabling users to communicate with each other includes, for example, a technology related to electronic conferencing.

### SUMMARY

According to an example embodiment, there is provided a non-transitory computer readable medium storing a program that, when executed by processing circuitry, causes a terminal to output sound information and video information transmitted and received in a first group of an online meeting, by performing a method including receiving, by a communication device of the terminal, information transmitted to the first group and related to an invitation to a second group given to a user of the terminal, and performing, by the processing circuitry of the terminal, control to give notification of the information related to the invitation.

The information related to the invitation may be transmitted from a first user included in the second group to the first group, or transmitted from the second group to the first group.

The notification of the information related to the invitation may be given by displaying the information on a display of the terminal.

The information related to the invitation may include first information for participating in the second group, and the method may further include causing the terminal to perform processing related to participating in the second group by the processing circuitry, based on an input to the first information by the user of the terminal.

The method may further include causing the terminal to display information indicating the second group and information indicating a third group on a display of the terminal, and controlling the terminal to change, by the processing circuitry, a display mode of the information indicating the second group, based on reception of the information related to the invitation.

The information related to the invitation may be transmitted from a first user included in the second group to the first group, and the method may further include causing the terminal to display, on a display of the terminal, information regarding the first user included in the information related to the invitation.

The information regarding the first user may include video information transmitted from a first terminal of the first user.

The methods may further include causing the terminal to perform, by the processing circuitry, processing to invite the first user included in the second group to the first group, based on an input made by the user of the terminal to the information regarding the first user displayed on the display.

The information related to the invitation may be first invitation information, and the method further include causing the terminal to display, if second invitation information different from the first invitation information is received by the communication device, information regarding a first inviter of the first invitation information and information regarding a second inviter of the second invitation information on a display of the terminal.

The method may further include causing the terminal to transmit, by the communication device, to the second group, information related to an invitation to the first group given to a second user included in the second group.

The information related to the invitation to the first group may include information regarding a message for the second group.

The method may further include causing the terminal to transmit, by the communication device, second information indicating interest in the second group to the second group or a second user included in the second group, based on an input made to the terminal by the user of the terminal.

The second information may include information related to making a request to transmit the information related to the invitation.

The method may further include causing the terminal to display third information that is based on information transmitted and received in the second group on a display of the terminal, and transmitting, by the communication device, the second information based on an input to the third information.

The notification of the information related to the invitation may be given by displaying the information on a display of the terminal, and the method may further include causing the terminal to transmit, by the processing circuitry, information related to declining the invitation to an inviter that has transmitted the information related to the invitation, based on an input to the information related to the invitation.

The method may further include causing the terminal to perform, by the processing circuitry, control related to participating in the second group if a set time period has elapsed since, or a set time has arrived after the notification of the information related to the invitation is given.

According to an example embodiment, there is provided an information processing method to be performed by a terminal that outputs sound information and video information transmitted and received in a first group of an online meeting. The method may include receiving, by a communication device of the terminal, information transmitted to the first group and related to an invitation to a second group given to a user of the terminal, and performing, by processing circuitry of the terminal, control to give notification of the information related to the invitation.

According to an example embodiment, there is provided a terminal configured to output sound information and video information transmitted and received in a first group of an online meeting. The terminal may include a communication device configured to receive information transmitted to the first group and related to an invitation to a second group given to a user of the terminal, and processing circuitry configured to perform control to give notification of the information related to the invitation.

According to an example embodiment, there is provided a terminal configured to output sound information and video information transmitted and received in a first group of an online meeting. The terminal may include a processor configured to read a program stored in a memory and execute processing based on the program such that the processor is configured to cause the terminal to receive, by a communication device of the terminal, information transmitted to the first group and related to an invitation to a second group given to a user of the terminal, and perform control to give notification of the information related to the invitation.

According to an example embodiment, there is provided a server configured to relay sound information and video information transmitted and received in a first group of an online meeting, and relay sound information and video information transmitted and received in a second group different from the first group. The server may include a communication device configured to receive information transmitted by a second terminal of a second user included in the second group and related to an invitation to the second group given to a first user included in the first group, and processing circuitry configured to perform control to cause the communication device to transmit the information related to the invitation to a terminal included in the first group.

### BRIEF DESCRIPTION OF DRAWINGS

FIG. 1-1 is a diagram showing a configuration of a communication system according to an example embodiment.

FIG. 1-2 is a diagram showing an example of functions realized by a controller of a server according to a first example embodiment.

FIG. 1-3 is a diagram showing an example of information stored in a storage of the server according to the first example embodiment.

FIG. 1-4 is a diagram showing an example of account registration data according to the first example embodiment.

FIG. 1-5 is a diagram showing an example of a meeting management database according to the first example embodiment.

FIG. 1-6 is a diagram showing an example of functions realized by a controller of a terminal according to the first example embodiment.

FIG. 1-7 is a diagram showing an example of information stored in a storage of the terminal according to the first example embodiment.

FIG. 1-8 is a diagram showing an example of a screen displayed on a display of the terminal according to the first example embodiment.

FIG. 1-9 is a diagram showing an example of a screen displayed on a display of the terminal according to the first example embodiment.

FIG. 1-10 is a flowchart showing an example of a flow of processing executed in a communication system according to a first example embodiment.

FIG. 1-11 is a flowchart showing an example of a flow of in-room moving image distribution processing according to the first example embodiment.

FIG. 1-12 is a flowchart showing an example of a flow of room topic update processing according to the first example embodiment.

FIG. 1-13 is a diagram showing an example of a screen displayed on a display of a terminal according to a modification of the first example embodiment.

FIG. 2-1 is a diagram showing an example of a screen displayed on a display of a terminal according to a second example embodiment.

FIG. 2-2 is a diagram showing an example of a screen displayed on the display of the terminal according to the second example embodiment.

FIG. 2-3 is a diagram showing an example of a screen displayed on the display of the terminal according to the second example embodiment.

FIG. 2-4 is a diagram showing an example of a screen displayed on the display of the terminal according to the second example embodiment.

FIG. 2-5 is a flowchart showing an example of a flow of processing executed in a communication system according to the second example embodiment.

FIG. 2-6 is a flowchart showing an example of a flow of room change processing according to the second example embodiment.

FIG. 3-1 is a diagram showing an example of a screen displayed on a display of a terminal according to a third example embodiment.

FIG. 3-2 is a flowchart showing an example of a flow of room topic update processing according to the third example embodiment.

FIG. 3-3 is a diagram showing an example of a screen displayed on a display of a terminal according to a first modification of the third example embodiment.

FIG. 3-4 is a diagram showing an example of a screen displayed on the display of the terminal according to a second modification of the third example embodiment.

FIG. 3-5 is a flowchart showing an example of a flow of processing executed in a communication system according to the second modification of the third example embodiment.

FIG. 3-6 is a flowchart showing an example of a flow of room merge processing according to the second modification of the third example embodiment.

FIG. 4-1 is a diagram showing an example of a meeting management database according to a fourth example embodiment.

FIG. 4-2 is a diagram showing an example of a screen displayed on a display of a terminal according to the fourth example embodiment.

FIG. 4-3 is a diagram showing an example of a screen displayed on the display of the terminal according to the fourth example embodiment.

FIG. 4-4 is a flowchart showing an example of a flow of processing executed in a communication system according to the fourth example embodiment.

FIG. 5-1 is a diagram showing an example of a meeting management database according to a fifth example embodiment.

FIG. 5-2 is a diagram showing an example of a screen displayed on a display of a terminal according to the fifth example embodiment.

FIG. 5-3 is a diagram showing an example of a screen displayed on the display of the terminal according to the fifth example embodiment.

FIG. 5-4 is a flowchart showing an example of a flow of processing executed in a communication system according to the fifth example embodiment.

FIG. 5-5 is a flowchart showing an example of a flow of other-room member invitation processing according to the fifth example embodiment.

FIG. 5-6 is a diagram showing a screen displayed on a display of a terminal according to a modification of the fifth example embodiment.

FIG. 5-7 is a flowchart showing a flow of other-room member invitation processing according to a modification of the fifth example embodiment.

FIG. 5-8 is a flowchart showing a flow of other-room member invitation processing according to a modification the fifth example embodiment.

FIG. 6-1 is a diagram showing an example of a screen displayed on a display of a terminal according to a sixth example embodiment.

FIG. 6-2 is a flowchart showing an example of a flow of other-room member invitation processing according to the sixth example embodiment.

FIG. 6-3 is a diagram showing an example of a screen displayed on a display of a terminal according to a modification of the sixth example embodiment.

FIG. 6-4 is a flowchart showing an example of a flow of other-room member invitation processing according to the modification of the sixth example embodiment.

FIG. 7-1 is a diagram showing an example of a screen displayed on a display of a terminal according to a seventh example embodiment.

FIG. 7-2 is a diagram showing an example of a screen displayed on the display of the terminal according to the seventh example embodiment.

FIG. 7-3 is a flowchart showing an example of a flow of other-room member invitation processing according to the seventh example embodiment.

FIG. 8-1 is a diagram showing an example of a screen displayed on a display of a terminal according to an eighth example embodiment.

FIG. 8-2 is a flowchart showing an example of a flow of processing executed in a communication system according to the eighth example embodiment.

FIG. 8-3 is a flowchart showing an example of a flow of other-room interest presentation processing according to the eighth example embodiment.

FIG. 9-1 is a diagram showing an example of a screen displayed on a display of a terminal according to a ninth example embodiment.

FIG. 9-2 is a flowchart showing an example of a flow of processing executed in a communication system according to the ninth example embodiment.

FIG. 9-3 is a flowchart showing an example of a flow of in-room moving image distribution processing according to the ninth example embodiment.

FIG. 10-1 is a diagram showing an example of a meeting management database according to a tenth example embodiment.

FIG. 10-2 is a diagram showing an example of a screen displayed on a display of a terminal according to the tenth example embodiment.

FIG. 10-3 is a diagram showing an example of a screen displayed on the display of the terminal according to the tenth example embodiment.

FIG. 10-4 is a diagram showing an example of a screen displayed on the display of the terminal according to the tenth example embodiment.

FIG. 10-5 is a flowchart showing an example of a flow of processing executed in a communication system according to the tenth example embodiment.

FIG. 10-6 is a diagram showing an example of a screen displayed on the display of the terminal according to a first modification of the tenth example embodiment.

FIG. 10-7 is a diagram showing an example of a screen displayed on the display of the terminal according to a second modification of the tenth example embodiment.

FIG. 11-1 is a diagram showing an example of a screen displayed on a display of a terminal according to an eleventh example embodiment.

FIG. 11-2 is a diagram showing an example of a screen displayed on the display of the terminal according to the eleventh example embodiment.

FIG. 11-3 is a flowchart showing an example of a flow of processing executed in a communication system according to the eleventh example embodiment.

FIG. 11-4 is a flowchart showing an example of a flow of in-room moving image distribution processing according to the eleventh example embodiment.

FIG. 12-1 is a diagram showing an example of a screen displayed on a display of a terminal according to a twelfth example embodiment.

FIG. 13-1 is a diagram showing an example of a screen displayed on a display of a terminal according to a thirteenth example embodiment.

FIG. 13-2 is a diagram showing an example of a screen displayed on the display of the terminal according to the thirteenth example embodiment.

FIG. 13-3 is a diagram showing an example of a screen displayed on the display of the terminal according to the thirteenth example embodiment.

FIG. 13-4 is a diagram showing an example of a screen displayed on the display of the terminal according to the thirteenth example embodiment.

### DETAILED DESCRIPTION

Compliance with Legal Requirements

It should be noted that the disclosure provided herein is premised on compliance with legal requirements such as secrecy of communication in a country in which the present disclosure is to be implemented.

### EMBODIMENTS

The phrase “in anon-limiting example” is used in some parts of the present specification for ease of understanding, while it should be noted that not only those parts but the entirety of the following example embodiments is not limited to the content described therein.

The following describes some example embodiments for implementing a program and the like according to the present disclosure with reference to the drawings.

In a non-limiting example, the term “system” can include a plurality of devices.

The plurality of devices may be a combination of devices of the same type, or may be a combination of devices of different types, or may be a combination of devices of the same type and devices of different types.

Note that, in a non-limiting example, the system can also be considered as performing certain types of processing with the plurality of devices cooperating with each other.

In a non-limiting example, a “system related to a client (client device) and a server” can be considered as at least one of the following:
(1) a terminal and a server;
(2) a server; or
(3) a terminal.

In the case (1), the system includes at least one terminal and at least one server, in a non-limiting example. The system in this example is a client-server system.

The server includes the following devices, which may be a single device or a combination of a plurality of devices, in a non-limiting example.

Specifically, in a non-limiting example, the server may have any of at least one processor (in a non-limiting example, a CPU: Central Processing Unit, a GPU: Graphics Processing Unit, an APU: Accelerated Processing Unit, a DSP: Digital Signal Processor (in a non-limiting example, an ASIC: Application Specific Integrated Circuit, an FPGA: Field Programmable Gate Array) etc.), a computer device (a processor and a memory), a control device, an arithmetic unit, or a processing unit, and may include two or more of any of the above devices of the same type (in a non-limiting example, two CPUs, a homogeneous multi-core processor etc.) or include two or more of any of the above devices of different types (in a non-limiting example, a CPU and a GPU, a heterogeneous multi-core processor etc.), or may be a combination of two or more devices (in a non-limiting example, a processor and a computer device, a processor and an arithmetic unit, a heterogeneous configuration of two or more devices, etc.).

Note that the processor may be a virtual processor.

When the server that includes a single device executes a certain type of processing, the single device executes the processing described in the example embodiments. If the server includes a plurality of devices, one device may execute a part of the processing and another device may execute the other part of the processing. In a non-limiting example, if the server includes a processor and an arithmetic unit, the processor may execute first processing and the arithmetic unit may execute second processing.

If the server includes a plurality of devices, the devices may be provided at locations physically separated from each other.

Functions of the server may be provided in the form of PaaS. IaaS, or SaaS in cloud computing, in a non-limiting example.

A controller of the system can be at least either a controller of the terminal or a controller of the server. That is, in a non-limiting example, any of the following can be the controller of the system: (1A) only the controller of the terminal; (1B) only the controller of the server; and (1C) both the controller of the terminal and the controller of the server.

Control and processing (hereinafter collectively referred to as “control and the like”) performed by the controller of the system may be: (1A) performed only by the controller of the terminal; (1B) performed only by the controller of the server; or (1C) performed by both the controller of the terminal and the controller of the server.

In the case (1C), in a non-limiting example, apart of control and the like performed by the controller in the system may be performed by the controller of the terminal, and the remaining part of the control and the like may be performed by the controller of the server. In this case, the allocation of the control and the like may be equal or different from the equal allocation.

If the server includes a single device, the term “a communication device of the server” may refer to a communication device included in the single device. If the server includes a plurality of devices, the communication device of the server may include communication devices included in the respective devices.

In anon-limiting example, if the server includes a first device and a second device, the first device has a first communication device, and the second device has a second communication device, the term “a communication device of the server” may refer to a concept that includes the first communication device and the second communication device.

In the case (2), the system may include a plurality of server (hereinafter referred to as a “server system”), in a non-limiting example. In this case, the aforementioned configuration can be similarly applied to each of the servers.

Control and the like performed by the server system may be performed by: (2A) only one of the plurality of servers: (2B) only another one of the servers; or (2C) one server and another server out of the plurality of servers.

In the case (2C), in a non-limiting example, apart of control and the like performed by the server system may be performed by one server, and the remaining part of the control and the like may be performed by another server. In this case, the allocation of the control and the like may be equal or different from the equal allocation.

In the case (3), the system may include a plurality of terminals, in a non-limiting example.

In anon-limiting example, this system can be as follows:
a system in which the terminals have server functions (distributed system), which can be realized by using a blockchain technology, in a non-limiting example, or
a system in which the terminals wirelessly communicate with each other, which can be realized by performing communication in a P2P (peer-to-peer) method using a short-range wireless communication technology, such as Bluetooth (registered trademark), in a non-limiting example.

Note that the above is not limited to the controller, but also applies to functional devices such as an input/output device, a communication device, a storage device, and a clock that can be constituent elements of the system.

In the following example embodiments, a system that includes a terminal and a server (in a non-limiting example, a client-server system) will be described, in a non-limiting example.

Note that the server system of the above case (2) can be applied as the server.

Instead of the system that includes a terminal and a server, the system of the above case (3) can be applied as a system that does not include a server, in a non-limiting example.

An example embodiment m this case can be configured based on the aforementioned blockchain technology or the like. For example, data stored and managed in a server that will be described in the following example embodiments is kept (stored) on a blockchain, in a non-limiting example. The terminal generates a transaction to the blockchain, and data kept on the blockchain can be updated if the transaction is approved on the blockchain.

Note that even if the term “terminal” is used, this is not limited to the meaning of a terminal as a client device in a client-server system.

That is, the term “terminal” may include a concept of a device that is not included in a client-server system.

In the present specification, the expression “by means of a communication I/F” is used as appropriate. This expression means that a device transmits and receives various types of information and data via the communication I/F (via a communication part) based on control performed by a controller (a processor, etc.), in a non-limiting example.

Regarding the phrases “related to” and “associated with” used herein, “B related to A” and “B associated with A” may mean that B has a certain relationship with A, in a non-limiting example. A specific example will be described later.

When a device performs processing targeting two or more objects, e.g. “transmitting A and B” or “receiving A and B” herein, the processing may be performed at the same timing for A and B (hereinafter referred to as “synchronously”) or at different timings for A and B (hereinafter referred to as “asynchronously”).

In a non-limiting example, when first information and second information are transmitted, this may include both concepts of transmitting the first information and the second information at the same timing and transmitting the first information and the second information at different timings.

Note that, considering a lag (time lag), “synchronously” may include “substantially synchronously”.

Note that, when it is stated that processing is performed at different timings for A and B, this need only mean that the processing is performed targeting A and B. and the purpose does not necessarily have to be the same.

In a non-limiting example, when it is stated that the first information and the second information are transmitted as mentioned above, the first information and the second information need only be transmitted, and this may include a case where the first information and the second information are transmitted for the same purpose as well as a case where the first information and the second information are transmitted for different purposes.

The following example embodiments will describe an online meeting service as an example of a service for a user to conduct a meeting online. An application for realizing the online meeting service is referred to as an “online meeting application”.

As used herein, the term “contents” may refer to information transmitted from a transmission source to a transmission destination. The term “contents” may refer to one or more contents.

In a non-limiting example, the term “contents” may include text contents in the form of text, image contents in the form of an image (including at least either a still image or a moving image), sound contents in the form of sound (including audio), and the like.

Note that the term “content” may also include operational contents such as a button and an icon to be operated by the user, and link contents such as link information (including a URI (Uniform Resource Identifier) in a non-limiting example).

The term “text” may include, in a non-limiting example, at least one of characters of any country, extended characters, machine-dependent characters, numbers, symbols, graphics, and symbols represented by character codes.

Note that the term “text” need not necessarily include at least one of the aforementioned characters, extended characters, machine-dependent characters, numbers, symbols, graphics, and symbols, and may include any other types of text.

The term “image” may include, in a non-limiting example, at least one of various types of image information such as an icon, a button, a stamp, an emoticon, and a banner image.

### EXAMPLE EMBODIMENTS

Some example embodiments will be described below.

Recently, in a non-limiting example, there are increasing opportunities for communication between users, such as conversations, meetings, dinner parties, and drinking parties, using voice and video (or at least voice).

First, the term “group” is described.

As one concept, a group may be understood as a gathering (group, division) consisting of at least one user when users communicate using an application or the like. The term “group” can also be considered as a type of data (data configuration) since the group is managed as data on a device.

Given below is a description of a non-limiting example of an “online meeting application” as an application for users of a terminals 20 to conduct an online meeting using voice and video.

Although the word “meeting” is used here, it is not limited to meaning a consultation and may also be used to mean any other type of communication such as a conversation, a dinner party, or a drinking party. The application used here may use audio only.

In the following, the term “room” is used as an example of a method that realizes (expresses) a group on the online meeting application. Similar to the term “group”, the term “room” can be considered as a gathering that includes at least one user, and can also be considered as a type of data (data configuration) since it is managed as data on the device.

Note that the term “team”, “channel”, or the like may also be used as another example of a method that realizes (expresses) a group on the online meeting application.

The rooms may include a meeting room for conducting a meeting, a later-described waiting room, and the like, in anon-limiting example. The terms “room A, room B, room C, . . . ” refer to meeting rooms, and the waiting room is distinguished from these rooms. Based on the above, the terms “group” and “room” are essentially synonymous in the description of the first to twelfth example embodiments. That is, users included in a group (hereinafter referred to as “group members”) are users included in a room (hereinafter referred to as “room members”).

Note that a room can also be considered as a type of UI (GUI) from the viewpoint of the terminal (user). Thus, the term “room” may also be considered as a group expressed by a UI (GUI). The same applies to the terms “team”, “channel”, and the like.

As used herein, the term “moving image information” may refer to information including video information and sound information. The term “moving image information” may optionally refer to video information involving sound information.

In some example embodiment, the term “moving image information” may refer to information that involves a moving image only (=video information) and does not contain sound information.

As used herein, expressions such as “at least one of.” when preceding a list of elements, modify the entire list of elements and do not modify the individual elements of the list. Thus, for example, both “at least one of A, B, or C” and “at least one of A, B, and C” mean either A, B, C or any combination thereof. Likewise, A and/or B means A, B, or A and B.

While the term “same,” “equal” or “identical” is used in description of example embodiments, it should be understood that some imprecisions may exist. Thus, when one element is referred to as being the same as another element, it should be understood that an element or a value is the same as another element within a desired manufacturing or operational tolerance range (e.g., 10%).

When the term “about,” “substantially” or “approximately” is used in this specification in connection with a numerical value, it is intended that the associated numerical value includes a manufacturing or operational tolerance (e.g., ±10%) around the stated numerical value. Moreover, when the word “about,” “substantially” or “approximately” is used in connection with geometric shapes, it is intended that precision of the geometric shape is not required but that latitude for the shape is within the scope of the disclosure. Further, regardless of whether numerical values or shapes are modified as “about” or “substantially,” it will be understood that these values and shapes should be construed as including a manufacturing or operational tolerance (e.g., ±10%) around the stated numerical values or shapes.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component region, layer or section without departing from the teachings of example embodiments.

### First Example Embodiment

In the first example embodiment, a room member of one meeting room is enabled to know information such as topics in other meeting rooms.

The content described in the first example embodiment can also be applied to any other example embodiments and modifications.

Constituent elements that are the same as those already described are assigned the same reference numerals, and redundant descriptions are omitted.

### System Configuration

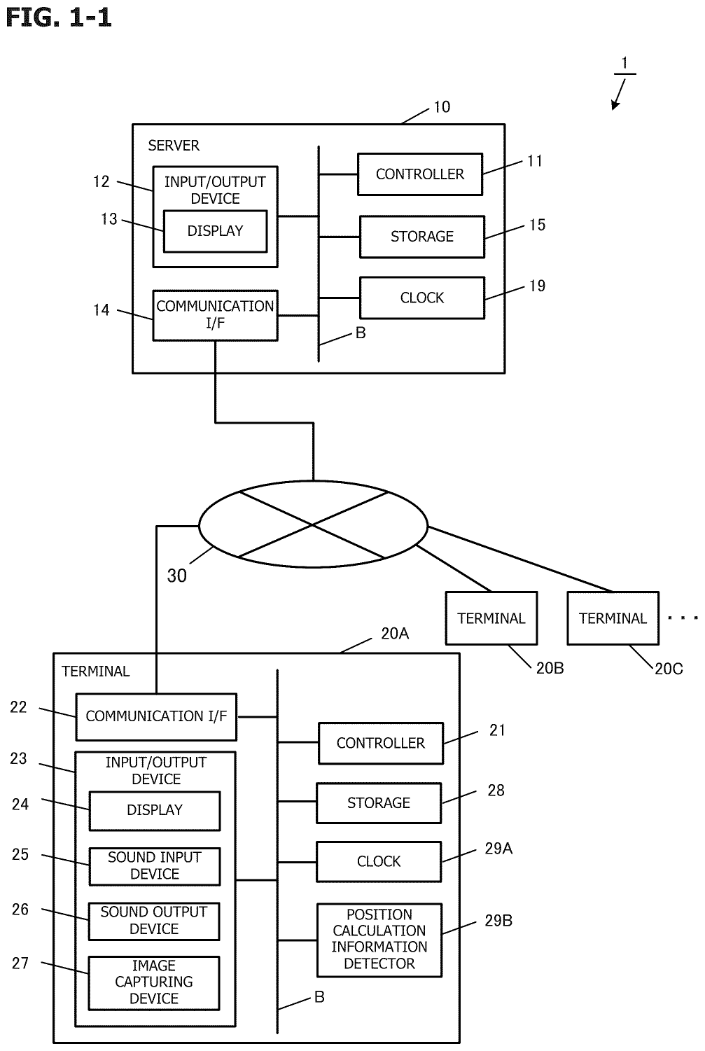

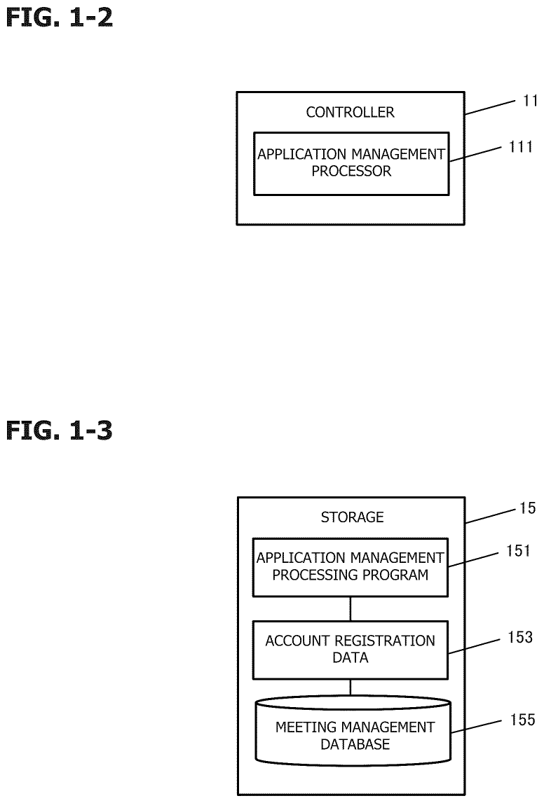

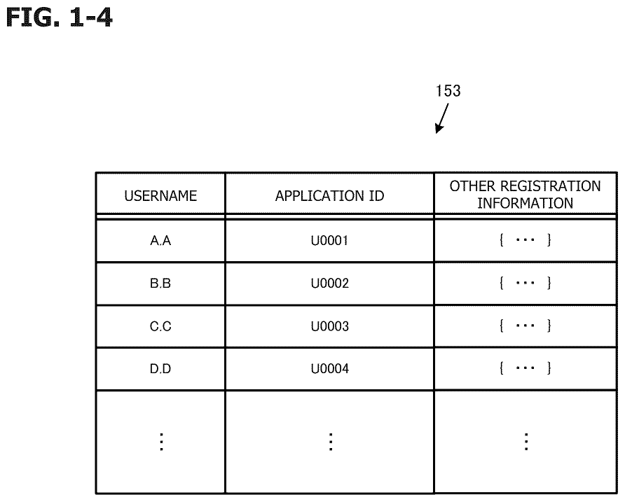

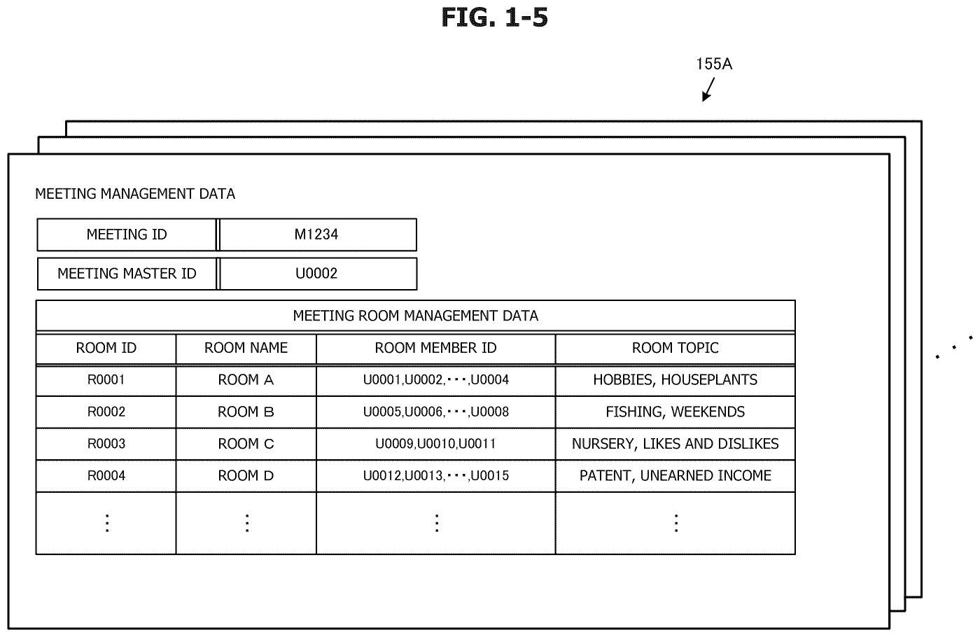

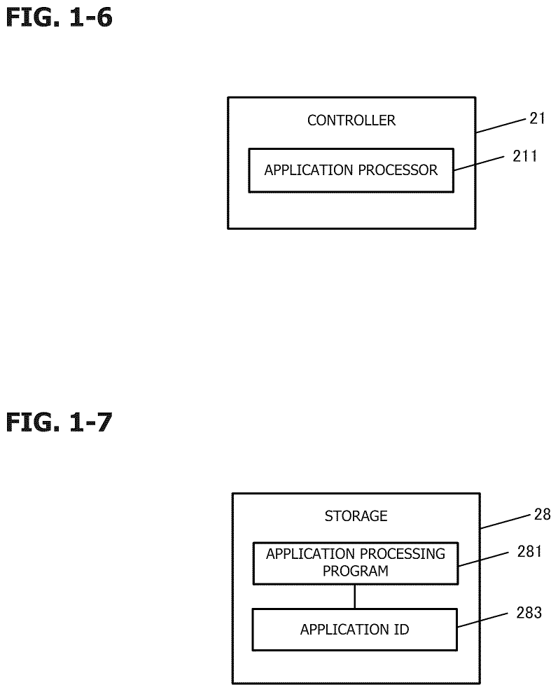

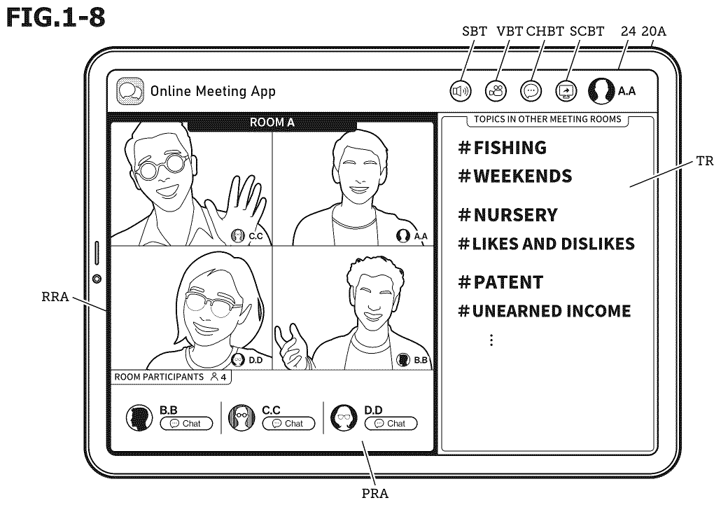

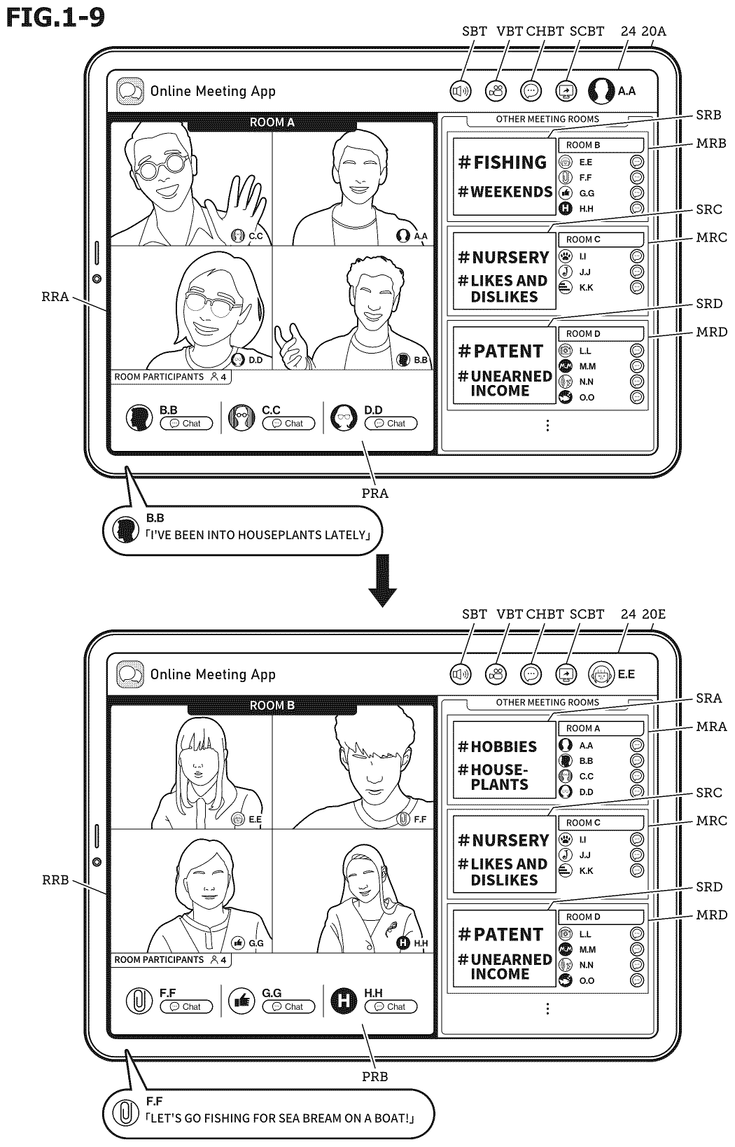

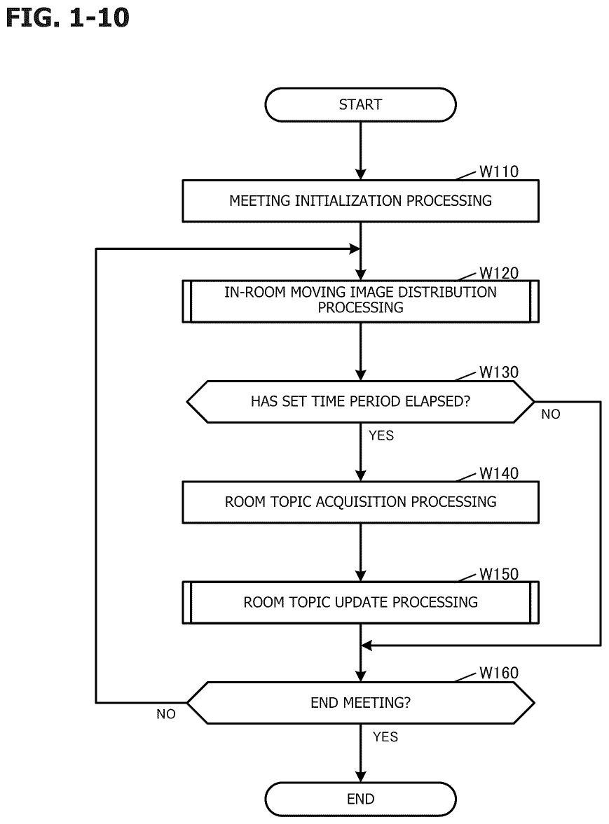

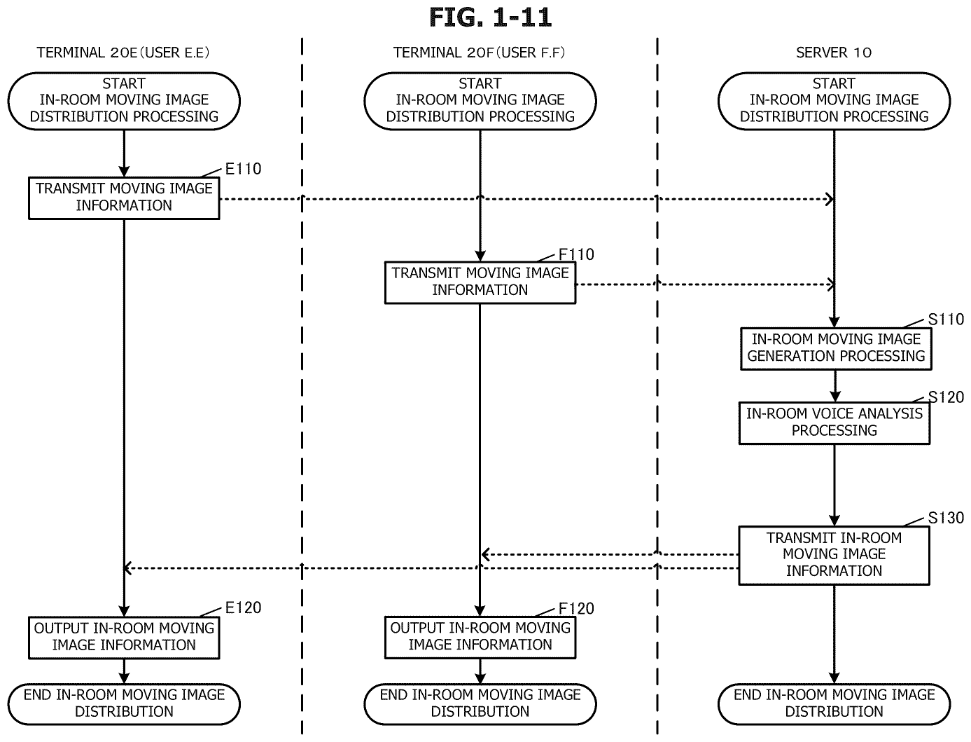

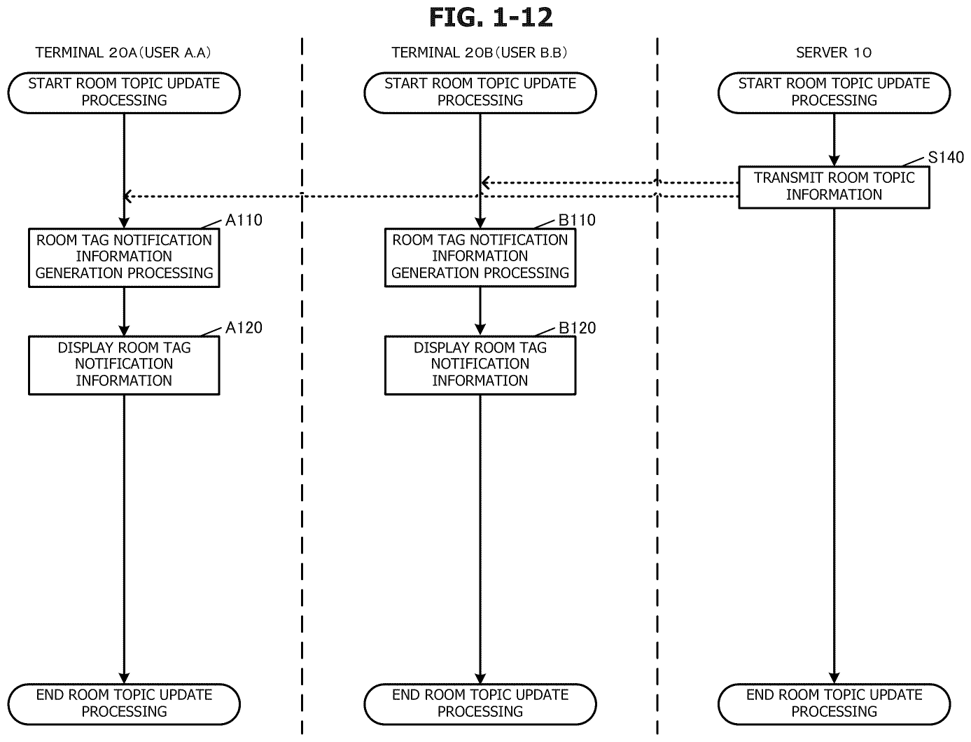

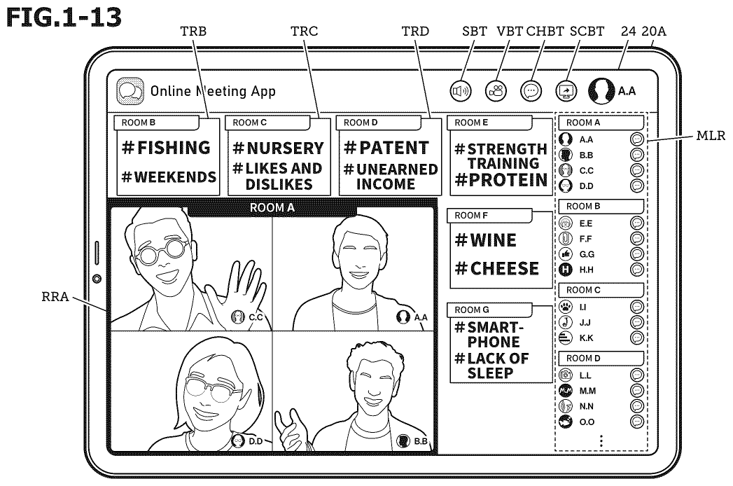

FIG. 1-1 is a diagram showing an example of a system configuration of a communication system 1 in an example embodiment of the present disclosure.

In the communication system 1, a server 10 and a plurality of terminals 20 (terminals 20A, 20B, 20C, . . . ) are connected to each other via a network 30, in a non-limiting example.

The server 10 serves to provide a desired (or alternatively, predetermined) service (in a non-limiting example, an online meeting service etc.) to terminals 20 owned by respective users, via the network 30. The server 10 can also be expressed as an online meeting server or the like, in a non-limiting example. In the present example embodiment, an online meeting service provider (operator) is a user of the server 10.

Note that the number of servers 10 and the number of terminals 20 to be connected to the network 30 are not limited.

Each of the terminals 20 (terminals 20A, 20B, 20C, . . . ) may be any information processing terminal that is capable of implementing functions described in embodiments. Non-limiting examples of the terminals 20 include a smartphone, a mobile phone (a feature phone), a tablet terminal, a computer (non-limiting examples of which include a desktop, a laptop, and a tablet), a media computer platform (non-limiting examples of which include cable and satellite set-top boxes and a digital video recorder), a handheld computer device (non-limiting examples of which include a personal digital assistant (PDA) and an electronic mail client), a wearable terminal (an eyeglasses-type device, a watch-type device, etc.), a virtual reality (VR) terminal, a smart speaker (an audio recognition device), and other types of computers and communication platforms. The terminals 20 may also be referred to as “information processing terminals”.

The configurations of the terminals 20A. 20B, and 20C can essentially be the same, not as a limitation but as an example. A terminal that is used by a user X may be, but not necessarily need to be, referred to as a “terminal 20X”, and user information that is associated with the user X or the terminal 20X in a desired (or alternatively, predetermined) service will be referred to as “user information X”.

The user information is information regarding a user associated with an account that is used by the user in the desired (or alternatively, predetermined) service. Non-limiting examples of the user information include information that is input by the user or is assigned by the desired (or alternatively, predetermined) service, and is associated with the user, such as the user's name, an icon image of the user, the user's age, the user's sex, the user's address, the user's hobbies/preferences, and the user's identifier, and the user information may optionally be any one of or a combination of two or more of these pieces of information.

The network 30 serves to connect one or more terminals 20 and one or more servers 10 to each other. That is, the network 30 serves as a communication network that provides a connection path to enable the various types of devices described above to transmit and receive data after the devices are connected to each other.

One or more portions of the network 30 may optionally be a wired network or a wireless network. Non-limiting examples of the network 30 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of a public switched telephone network (PSTN), a mobile phone network, integrated service digital networks (ISDNs), a radio LAN, long term evolution (LTE), code division multiple access (CDMA), Bluetooth (registered trademark), satellite communication, and a combination of two or more of these networks. The network 30 may be constituted by a single network 30 or a plurality of networks 30.

The server 10 (a non-limiting example of a server, an information processing device, and an information management derive) has the function of providing a desired (or alternatively, predetermined) service to the terminals 20. The server 10 may be any information processing device that is capable of implementing functions described in embodiments. Non-limiting examples of the server 10 include a server device, a computer (non-limiting examples of which include a desktop, a laptop, and a tablet), a media computer platform (non-limiting examples of which include cable and satellite set-top boxes and a digital video recorder), a handheld computer device (non-limiting examples of which include a PDA and an electronic mail client), and other types of computers and communication platforms. The server 10 may also be referred to as an “information processing device”. If there is no need to distinguish the server 10 and the terminals 20, each of the server 10 and the terminals 20 may optionally be referred to as an “information processing device”.

### Hardware (HW) Configurations of Devices

The HW configurations of the devices included in the communication system 1 will be described.

### (1) HW Configurations of Terminals

FIG. 1-1 shows an example of the HW configuration of each terminal 20.

Each terminal 20 includes a controller 21 (central processing unit: CPU), a storage 28, a communication I/F (interface) 22, an input/output device 23, a clock 29A, and a position calculation information detector 29B. The HW constituent elements of each terminal 20 are connected to each other via a bus B, in a non-limiting example. Note that the HW configuration of each terminal 20 does not necessarily have to include all of the constituent elements. Each terminal 20 may optionally be configured such that one or more constituent elements are removable, in a non-limiting example.

The communication UF 22 transmits and receives various types of data via the network 30. Communication may be carried out in a wired or wireless manner, and may be based on any communication protocol that enables mutual communication to be carried out. The communication IF 22 functions to communicate with various types of devices such as the server 10 via the network 30. The communication I/F 22 transmits various types of data to various types of devices such as the server 10 in accordance with instructions from the controller 21. Further, the communication UF 22 receives various types of data transmitted from various types of devices such as the server 10 and conveys the data to the controller 21. The communication I/F 22 may also be simply referred to as a “communication part”. The communication I/F 22 may also be referred to as a “communication circuit” in cases where the communication I/F is constituted by a physically structured circuit.

The input/output device 23 includes a device that inputs various operations made to the terminal 20, a device that outputs a result of processing performed by the terminal 20, and the like. The input/output device 23 may optionally be constituted by a single device into which an input device and an output device are integrated, or an input device and an output device that are separate from each other.

The input device is implemented by any one of or a combination of two or more of all types of devices capable of accepting input from a user and conveying information regarding the input to the controller 21. Non-limiting examples of the input device include a touch panel, a touch display, hardware keys of a keyboard or the like, a pointing device such as a mouse, a camera (input of operations via moving images), and a microphone (input of operations using voice).

The output device is implemented by any one of or a combination of two or more of all types of devices capable of outputting a result of processing performed by the controller 21. Non-limiting examples of the output device include a touch panel, a touch display, a speaker (sound output), a lens (non-limiting examples of which include 3D (three-dimensional) output and hologram output), and a printer.

Merely as an example, the input/output device 23 includes a display 24, a sound input device 25, a sound output device 26, and an image capturing device 27, in a non-limiting example.

The display 24 is implemented by any one of or a combination of two or more of all types of devices capable of providing display in accordance with display data written in a frame buffer. Non-limiting examples of the display 24 include a touch panel, a touch display, a monitor (non-limiting examples of which include a liquid crystal display and an organic electroluminescence display (OELD)), a head mounted display (HDM), and devices capable of displaying images, text information, and the like using projection mapping or holograms, or in the air (may optionally be a vacuum). Note that the display 24 may optionally be capable of displaying display data in 3D.

The sound input device 25 is used to input sound data (which may be speech data. The same applies hereinafter). The sound input device 25 includes a microphone and so on.

The sound output device 26 is used to output sound data. The sound output device 26 includes a speaker and so on.

The image capturing device 27 is used to acquire image data (which may include still image data and moving image data; the same applies hereinafter). The image capturing device 27 includes a camera and so on.

If the input/output device 23 is a touch panel, the input/output device 23 and the display 24 may also have substantially the same size and shape and be arranged opposing each other.

The clock 29A is a built-in clock of the terminal 20 and outputs time information (time measurement information). The clock 29A includes a clock that employs a crystal oscillator, or the like, in a non-limiting example. The clock 29A may also be referred to as a “time measurement device” or a“time information detecting device”, in a non-limiting example.

Note that the clock 29A may optionally include a clock to which NITZ (Network Identity and Time Zone) standards or the like are applied.

The position calculation information detector 29B is a functional unit that detects (measures) information (hereinafter referred to as “position calculation information”) that is desired for the controller 21 to calculate (measure) the position of the terminal 20. The position calculation information detector 29B may also be referred to as a “position calculation sensor unit”, in a non-limiting example.

Non-limiting examples of the position calculation information detector 29B include a satellite positioning sensor (a satellite positioning unit) that is a sensor or a unit for calculating the position of the terminal 20 using a satellite positioning system such as GPS (Global Positioning System), an inertial measurement sensor (IMU (Inertial Measurement Unit)) that is a sensor or a unit for calculating the position of the terminal 20 using an inertial navigation system, and a ultrawide band (UWB) positioning sensor (UWB positioning unit) that is a sensor or a unit for calculating the position of the terminal 20 using a UWB.

The satellite positioning unit includes an RF (Radio Frequency) receiving circuit that converts RF signals, which include a positioning satellite signal emitted from a positioning satellite and received by an antenna (not illustrated), into digital signals and a baseband processing circuit that captures the positioning satellite signal by performing correlation operation processing or the like on a digital signal output from the RF receiving circuit and outputs information such as satellite orbit data and time data that are taken from the positioning satellite signal, as position calculation information, in a non-limiting example.

The inertial measurement unit includes an inertial sensor that detects information necessary to calculate the position of the terminal 20 through an inertial navigation operation. The inertial sensor includes a three-axis acceleration sensor and a three-axis gyroscope sensor, and outputs acceleration detected by the acceleration sensor and angular velocity detected by the gyroscope sensor, as position calculation information, in a non-limiting example.

The UWB positioning unit includes a ultrawide band RF (Radio Frequency) receiving circuit that converts ultrawide band RF signals, which include a positioning ultrawide band pulse signal emitted from a positioning beacon and received by an antenna (not illustrated), into digital signals and a relative position calculation processing circuit that calculates the position of the terminal 20 relative to the positioning beacon based on digital signals output from the ultrawide band RF receiving circuit, in a non-limiting example.

Note that the UWB positioning unit may optionally cause the terminal 20 to function as a positioning beacon by transmitting a ultrawide band RF signal including a positioning ultrawide band pulse signal from the antenna (not illustrated), in in a non-limiting example.

The controller 21 calculates the position of the terminal 20 at periodical timings or specified timings based on the position calculation information detected by the position calculation information detector 29B, in a non-limiting example. The position of the terminal will be referred to as a “terminal position”, and the calculated terminal position will be referred to as a “calculated terminal position”. The controller 21 may optionally associate the calculated terminal position with date and time at which the calculated terminal position is calculated, and store the calculated terminal position as calculated terminal position history data in the storage 28.

The controller 21 includes a physically structured circuit for executing functions that are implemented in accordance with codes or commands included in a program, and is implemented by a data processing device embedded in hardware, in a non-limiting example. Accordingly, the controller 21 may optionally be referred to as a “control circuit”.

Non-limiting examples of the controller 21 include a central processing unit (CPU), a microprocessor, a processor core, a multiprocessor, an ASIC (Application-Specific Integrated Circuit), and a FPGA (Field Programmable Gate Array).

The storage 28 functions to store various programs and various types of data that are desired for the terminal 20 to operate. Non-limiting examples of the storage 28 include various storage media such as an HDD (Hard Disk Drive), an SSD (Solid State Drive), a flash memory, a RAM (Random Access Memory), and a ROM (Read Only Memory). The storage 28 may optionally be referred to as a “memory”.

The terminal 20 stores a program P in the storage 28, and the controller 21 executes the program P to perform processing while serving as devices that are included in the controller 21. That is, the program P stored in the storage 28 causes the terminal 20 to implement the functions to be executed by the controller 21. The program P may optionally be referred to as a “program module”.

### (2) HW Configuration of Server

FIG. 1-1 shows an example of the HW configurations of the server 10.

The server 10 includes a controller (CPU) 11, a storage 15, a communication I/F (interface) 14, an input/output device 12, and a clock 19. The HW constituent elements of the server 10 are connected to each other via a bus B, in a non-limiting example. Note that the HW configuration of the server 10 does not necessarily have to include all of the constituent elements. The HW of the server 10 may optionally be configured such that one or more constituent elements are removable, in a non-limiting example.

The controller 11 includes a physically structured circuit for executing functions that are implemented in accordance with codes or commands included in a program, and is implemented by a data processing device embedded in hardware, in a non-limiting example.

The controller 11 is typically a central processing unit (CPU), and may optionally be a microprocessor, a processor core, a multiprocessor, an ASIC, or a FPGA. In the present disclosure, the controller 11 is not limited to these examples.

The storage 15 functions to store various programs and various types of data that are necessary for the server 10 to operate. The storage 15 is implemented by various storage media such as an HDD, an SSD, and a flash memory. However, in the present disclosure, the storage 15 is not limited to these examples. The storage 15 may optionally be referred to as a “memory”.

The communication I/F 14 transmits and receives various types of data via the network 30. Communication may be carried out in a wired or wireless manner, and may be based on any communication protocol that enables mutual communication to be carried out. The communication I/F 14 functions to communicate with various types of devices such as the terminals 20 via the network 30. The communication I/F 14 transmits various types of data to various types of devices such as the terminals 20 in accordance with instructions from the controller 11. Further, the communication I/F 14 receives various types of data transmitted from various types of devices such as the terminals 20 and conveys the data to the controller 11. The communication I/F 14 may also be simply referred to as a “communication part”. The communication I/F 14 may also be referred to as a “communication circuit” in cases where the communication I/F is constituted by a physically structured circuit.

The input/output device 12 includes a device that inputs various operations to the server 10, a device that outputs the results of processing performed by the server 10, and the like. The input/output device 12 may optionally be constituted by an input device and an output device that are integrated or that are separate from each other.

The input device is implemented by any one of or a combination of two or more of all types of devices capable of accepting input from a user and conveying information regarding the input to the controller 11. The input device is implemented by hardware keys, atypical example of which is a keyboard, and a pointing device such as a mouse. Note that the input device may optionally include a touch panel, a camera (input of operations via moving images), or a microphone (input of operations using voice), in a non-limiting example.

The output device is implemented by any one of or a combination of two or more of all types of devices capable of outputting a result of processing performed by the controller 11. Non-limiting examples of the output device include a touch panel, a touch display, a speaker (sound output), a lens (non-limiting examples of which include 3D (three-dimensional) output and hologram output), and a printer.

In an example only, the input/output device 12 includes a display 13, not as a limitation but as an example.

The display 13 is implemented by a display or the like. The display is typically implemented by a monitor (non-limiting examples of which include a liquid crystal display and an organic electroluminescence display (OELD)). Note that the display may optionally be a head mounted display (HDM) or the like. Note that the display may optionally be capable of displaying display data in 3D. In the present disclosure, the display is not limited to these examples.

The clock 19 is a built-in clock of the server 10 and outputs time information (time measurement information). The clock 19 includes an RTC (Real Time Clock) as a hardware clock, a system clock, or the like, in anon-limiting example. The clock 19 may also be referred to as a “time measurement device” or a “time information detecting device”, in a non-limiting example.

### (3) Others

The server 10 stores a program P in the storage 15, and the controller 11 executes the program P to perform processing while serving as devices that are included in the controller 11. That is, the program P stored in the storage 15 causes the server 10 to implement the functions to be executed by the controller 11. The program P may optionally be referred to as a “program module”.

The same applies to other devices.

Some example embodiments of the present disclosure will be described assuming that the example embodiments are implemented as a result of CPU(s) of the terminals 20 and/or the server 10 executing the program P.

Note that the controller 21 of each terminal 20 and/or the controller 11 of the server 10 may optionally implement processing by using not only the CPU(s) including a control circuit, but also a logic circuit (hardware) or a dedicated circuit that is formed on an integrated circuit (an IC (Integrated Circuit) chip or an LSI (Large Scale Integration) chip) or the like. Further, these circuits may optionally be implemented by one or more integrated circuits, and a plurality of types of processing described in the embodiments may optionally be implemented by a single integrated circuit. LSI may be referred to as VLSI, super LSI, ultra LSI, or the like depending on the degree of integration. Accordingly, the controller 21 may optionally be referred to as a “control circuit”.

The program P (non-limiting examples of which include a software program, a computer program, and a program module) in the disclosed example embodiments of the present disclosure may optionally be provided in a state where the program is stored in a computer-readable storage medium. The program P can be stored in a “non-transitory tangible medium”. Further, the program P may optionally be a program for implementing some of the functions described in the example embodiments of the present disclosure. Furthermore, the program P may optionally be a differential file (differential program) that is configured to implement the functions described in the example embodiments of the present disclosure in combination with a program P that is already recorded in a storage medium.

Regarding the phrase “a program of the system (a program executed by the system)”, the system is as described above. The term “program” of the aforementioned system refers to a program that can be executed by the entire system. This program may be, in a non-limiting example, constituted by programs of individual devices included in the system. The programs stored in the devices included in the system may differ from each other. That is, the devices included in the system need not use a common program.

In a non-limiting example, when the system includes a terminal and a server, and a program of the system is denoted as P1, the program P1 of the system may be constituted by a program P2 stored in the terminal and a program P3 stored in the server. The programs P2 and P3 are for executing the program of the system and may be different programs. In a non-limiting example, the program P2 stored in the terminal may be a program for executing first processing and transmitting the results of performing the first processing to the server, and the program P3 stored in the server may be a program for executing second processing in response to the received results of performing the first processing and transmitting the results of performing the second processing to the terminal.

The storage medium may include one or more semiconductor-based or other integrated circuits (ICs, non-limiting examples of which include field programmable gate arrays (FPGAs) and application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM drives, secure digital cards, drives, any other appropriate storage media, and a suitable combination of two or more of these storage media. Where appropriate, the storage medium may consist only of a volatile storage medium or a non-volatile storage medium, or a combination of volatile and non-volatile storage media. Note that the storage medium is not limited to these examples, and may be any device or medium that is capable of storing the program P. Further, the storage medium may optionally be referred to as a “memory”.

The server 10 and/or the terminals 20 can implement functions of a plurality of functional units described in the embodiments by reading the program P stored in the storage medium and executing the read program P.

The program P according to the present disclosure may optionally be provided to the server 10 and/or the terminals 20 via any transmission medium (e.g., a communication network, broadcast waves, etc.) that is capable of transmitting the program. The server 10 and/or the terminals 20 implement(s) the functions of the functional units described in the example embodiments by executing the program P downloaded via the Internet or the like, in a non-limiting example.

The example embodiments of the present disclosure can also be implemented in the form of a data signal in which the program P is embodied through electronic transmission.

At least a portion or all of processing executed in the server 10 and/or the terminals 20 may optionally be implemented through a cloud computing constituted by one or more computers.

At least a portion or all of processing executed in the terminals 20 may optionally be carried out by the server 10. In this case, the server 10 may optionally carry out at least a portion or all of processing carried out by functional units of the controller 21 of each terminal 20.

At least a portion or all of processing executed in the server 10 may optionally be carried out by the terminals 20. In this case, the terminals 20 may optionally carry out at least a portion or all of processing carried out by functional units of the controller 11 of the server 10.

In the example embodiments of the present disclosure, configurations for determination are not essential unless explicitly mentioned otherwise, and desired (or alternatively, predetermined) processing may be activated when a determination condition is satisfied, or desired (or alternatively, predetermined) processing may be activated when a determination condition is not satisfied, without limitation thereto.

The program according to the present disclosure is implemented using a script language such as ActionScript or JavaScript (registered trademark), a compiler language such as Objective-C or Java (registered trademark), or a markup language such as HTML Living Standard, for example, although there is no limitation thereto.

In a non-limiting example, the program executed by the terminal may be a program executed as a native application, a program executed as a web application, or a program executed as a hybrid application.

### Functional Configuration

### (1) Functional Configuration of Server

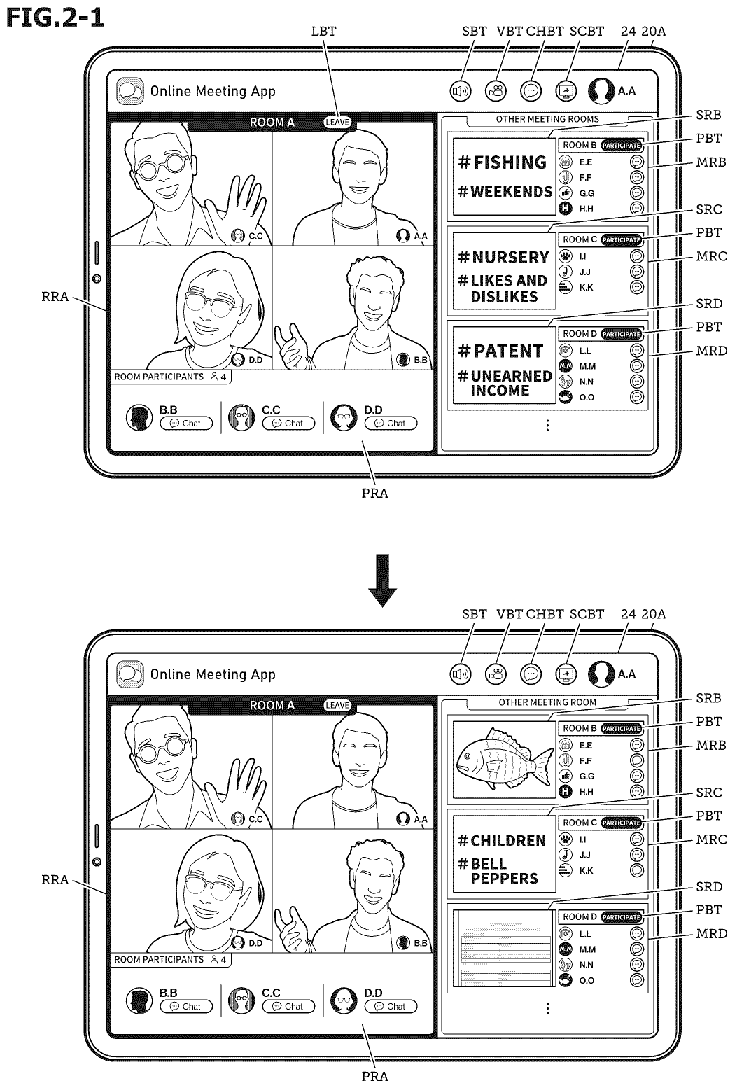

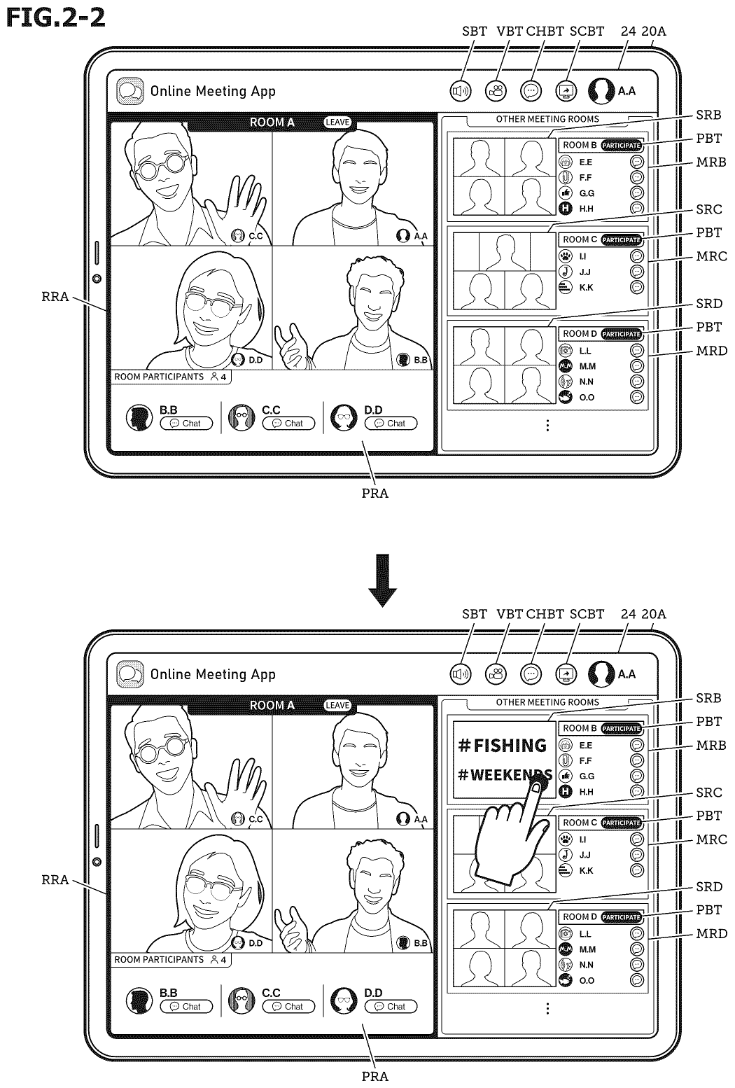

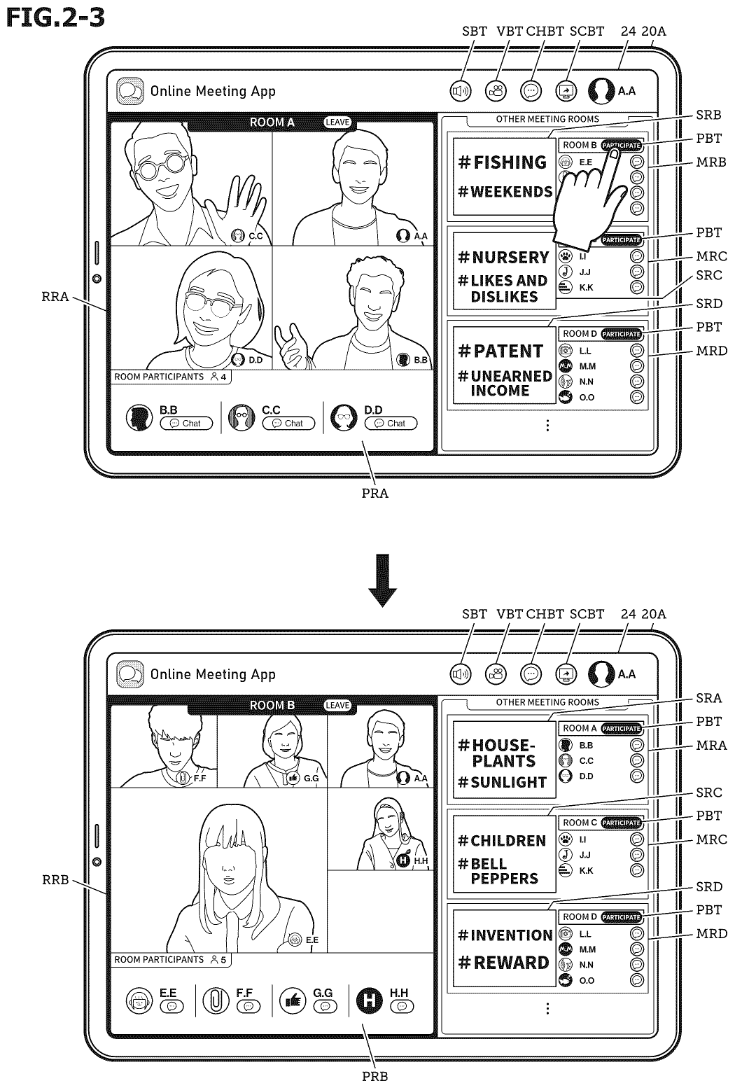

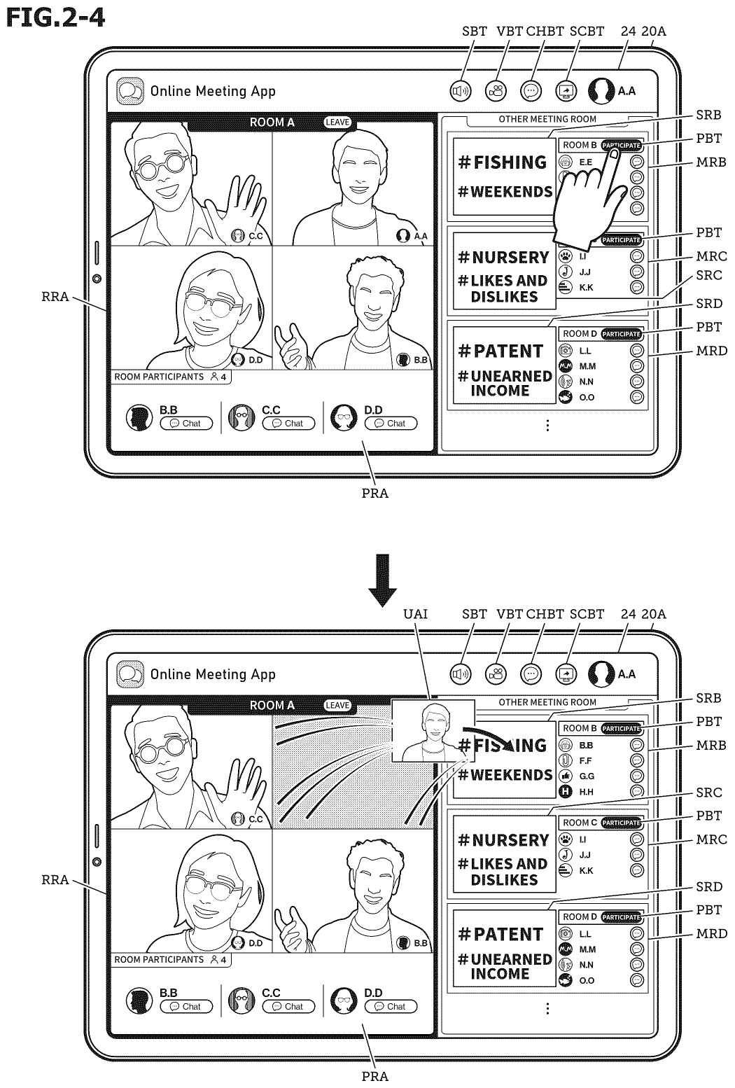

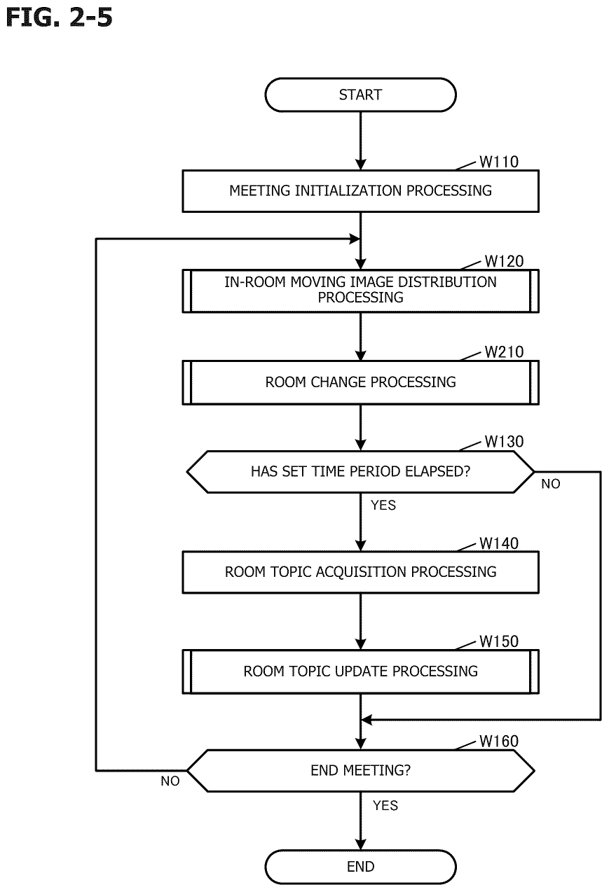

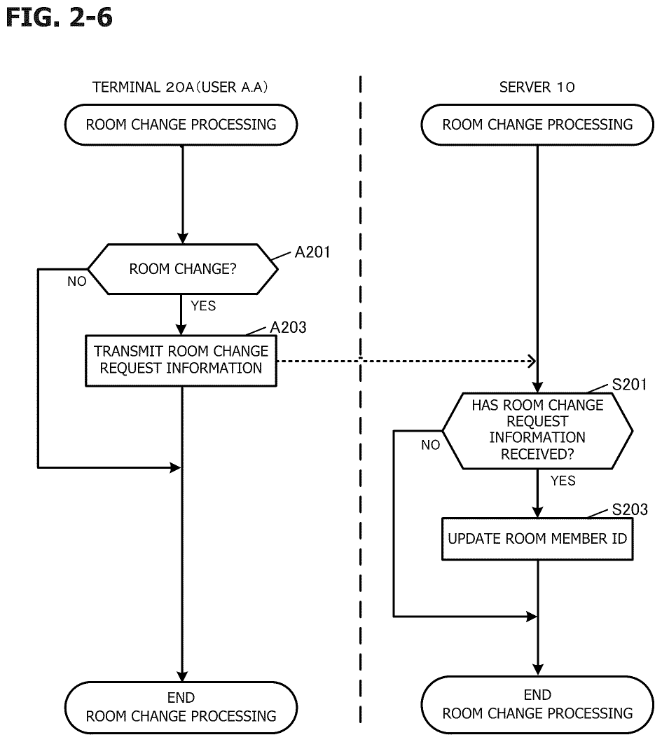

FIG. 1-2 is a diagram showing an example of functions implemented by the controller 11 of the server 10 in the present example embodiment.

In anon-limiting example, the controller 11 includes, as a functional unit, an application management processor 111 that performs application management processing in accordance with an application management processing program 151 stored in the storage 15.

FIG. 1-3 is a diagram showing an example of information stored in the storage 15 of the server 10 in the present example embodiment.

In a non-limiting example, the application management processing program 151 that is executed as application management processing, account registration data 153, and a meeting management database 155 are stored in the storage 15.

The account registration data 153 is registered data regarding accounts of an application (online meeting application), and FIG. 1-4 shows an example of the data configuration.

In a non-limiting example, a username, an application ID, and other registered information are stored in association with each other in the account registration data 153.

The username is the name of an account of a terminal 20 that uses this application. In a non-limiting example, a name that is registered by the user of the terminal 20 to use the application is stored as the username.

The application ID is information that is used to identify an account of the application, or the account itself.

The application ID is, for example, a value that is unique to the account. In a non-limiting example, a unique value (specific value) is set for each account by the server 10 and stored as the application ID.

The application ID is information associated with the terminal 20 or the user of the terminal 20, and is an example of information regarding the terminal or information regarding the user of the terminal.

The other registration information may include various types of information such as identification information for identifying each terminal 20, a telephone number (terminal telephone number) of the terminal 20, an email address (terminal email address), and authentication information such as a password (login password, authentication password etc.) used for various authentications on the application, in a non-limiting example.

Identification information for identifying each terminal 20 may be, in a non-limiting example, a terminal ID (in a non-limiting example, an IMEI (International Mobile Equipment Identity)).

Further, identification information for identifying the user of each terminal 20 may be, in a non-limiting example, an application ID for a general user or an application ID for an official user.

Note that the term “application ID” may optionally be replaceable with the term “user ID”.

If the application allows registration of only one account per terminal 20, identification information for identifying the terminal 20 may be equivalent to identification information for identifying the user of the terminal 20, and may also be equivalent to the application ID, in a non-limiting example.

In a non-limiting example, a plurality of terminal IDs may optionally be allocated to one application ID. In this case, the application may optionally be started on a plurality of terminals 20 for one application ID as an identification (login) target.

Instead of using various IDs such as the application ID, a technique of managing each account using information such as a terminal telephone number can also be applied.

In this case, instead of storing ID information such as the application ID in the account registration data 153, information such as the terminal telephone number can be stored in the account registration data 153. Note that, instead of replacing the ID information such as the application ID with the information such as the terminal telephone number, the ID information such as the application ID may optionally be stored in one-to-one correspondence with the information such as the terminal telephone number.

In the description of the following example embodiments, it is assumed that one account is registered per terminal 20 for the sake of simplicity.

In this case, since the identification information for identifying the terminal 20 is equivalent to the identification information for identifying the user of the terminal 20 and to the application ID, the term “a user of the account” used in the following description may be considered to be substantially synonymous with “a terminal of the account”.

The meeting management database 155 is a database in which data for managing an online meeting on the online meeting application is stored, and FIG. 1-5 shows a data configuration of a meeting management database 155A, which is an example of the meeting management database 155.

Meeting management data is stored as management data for each meeting in the meeting management database 155A.

A meeting ID, a meeting master ID, and meeting room management data are stored in each piece of meeting management data, in a non-limiting example.

The meeting ID is an ID for uniquely identifying each entire meeting (hereinafter referred to as an “entire meeting”). In anon-limiting example, an ID is set by the server 10 and stored each time an entire meeting is conducted. An entire meeting identified by the meeting ID can be considered as one meeting as a whole, which is organized by a meeting master or the like and includes individual meetings (hereinafter referred to as “individual meetings”) held by users in a plurality of separate meeting rooms.

In a non-limiting example, the meeting master may be any of the following users:
a user who made a request to the server 10 to hold an entire meeting (which may alternatively be a user who created an entire room);
a user who is registered in advance in the server 10 as a user who has the authority in the case of holding a meeting within an organization (the head or superior of the organization, a user decided through discussion or voting within the organization etc.);
a user who is registered in advance in the server 10 as a leader user in the case of holding a meeting among peers; and
a user decided after the start of the meeting (during the meeting) (in a non-limiting example, a user decided through discussion or voting among all or some of the users after the start of the meeting (including the aforementioned case of holding a meeting within an organization or among peers)).

Note that these are merely examples and are not limiting. The meeting master may alternatively be referred to as a meeting host, an organizer, or the like.

The meeting master ID is an application ID of the user who is the meeting master, and the application ID of the user who is the meeting master, among the application IDs stored in the account registration data 153, is identified and stored by the server 10.

The meeting room management data is, in a non-limiting example, data for managing a meeting room for holding an individual meeting in the entire meeting identified by the meeting ID. In a non-limiting example, room IDs, room names, room member IDs, and room topics are stored in association with each other in the meeting room management data, in a non-limiting example.

In the first to twelfth example embodiments, it is assumed that users are separated into a plurality of meeting rooms to conduct individual meetings within one entire meeting as mentioned above, and each piece of meeting management data stores information related to the plurality of meeting rooms.

The room ID refers to an ID for uniquely identifying a meeting room, and a unique ID is set for each meeting room and stored by the server 10, in a non-limiting example.

The room name refers to the name of the meeting room, and is stored by the server 10 based on information received from a terminal 20 of an account that wants to set the name of the meeting room, in a non-limiting example. The room name may be determined by the meeting master or any room member of each meeting room.

The room member ID refers to an application ID of a room member included in the meeting room, and application IDs of users who are room members of the meeting room, among the application IDs stored in the account registration data 153, are identified as the room member IDs and stored by the server 10.

The room topic refers to a topic in the meeting taking place in the meeting room. As the room topic, topics are identified and stored by the server 10 based on sound information, video information, or the like that is transmitted and received in the meeting room, in a non-limiting example.

Note that the meeting room management data may also store, as room information other than the above, the amount of speech of each room member (the amount of speech of each room member ID), a link shared within the meeting room, an image storage location, or the like, in a non-limiting example.

In the account registration data 153 shown in FIG. 1-4, the application ID of a user A.A is stored as “U001”, and the application ID of a user B.B is stored as “U0002”, in a non-limiting example.

In the meeting management data shown at the frontmost side of the meeting management database 155A in FIG. 1-5, the user A.A (application ID “U0001”) and the user B.B (application ID “U0002”) are stored as room members included in the meeting room of the room ID “R0001” and the room name “room A”. That is, one group includes a plurality of room members (or the terminals 20 thereof) including the users A.A and B.B, and this group holds a meeting in the room A.

Similarly, in the account registration data 153 shown in FIG. 1-4, the application ID of a user E.E is stored as “U0005”, and the application ID of a user F.F is stored as “U0006”, in a non-limiting example.

In the meeting management data shown at the frontmost side of the meeting management database 155A in FIG. 1-5, the user E.E (application ID “U0005”) and the user F.F (application ID “U0006”) are stored as room members included in the meeting room of the room ID “R0002” and the room name “room B”. That is, one group includes a plurality of room members (or the terminals 20 thereof) including the users E.E and F.F, and this group holds a meeting in the room B.

In the following description, the terminals 20 of room members included in the same room may be referred to as “room member terminals”, and a terminal included in the room member terminals that is not a target terminal 20 (including a terminal 20 not shown in flowcharts) may be referred to as “another room member terminal”, for convenience.

Note that the number of room member terminals need not necessarily be more than one, and may also be one. That is, the number of room members may be one, as mentioned above.

There may be a room that includes no user, in addition to the aforementioned meeting rooms and waiting room. In this case, that room may be a room “in a vacant state”, in a non-limiting example.

In the following description, a room that does not include the user of the terminal performing processing may be referred to as “another room/other rooms” for convenience. “Another room (other rooms)” may refer to any of the following rooms:
a meeting room(s) other than the meeting room that includes the user;
a meeting room(s) when the user is included in the waiting room; and
a meeting room(s) when the user is not included in any meeting room or the waiting room.

Note that the other rooms may optionally include the waiting room.

### (2) Functional Configuration of Terminal

FIG. 1-6 is a diagram showing an example of functions implemented by the controller 21 of the terminal 20 in the present example embodiment.

In anon-limiting example, the controller 21 includes, as a functional unit, an application processor 211 that performs application processing in accordance with an application processing program 281 stored in the storage 28.

FIG. 1-7 is a diagram showing an example of data and the like stored in the storage 28 of the terminal 20 in the present example embodiment.

In anon-limiting example, the storage 28 stores the application processing program 281 that is executed as application processing and an application ID 283 that corresponds to the terminal 20 or the account of the terminal 20.

Note that the meeting management data in the meeting management database 155 of the server 10 may be synchronously stored in the storage 28 of each terminal 20.

### Display Screen

The following describes anon-limiting example where the terminal 20 is a tablet terminal having a horizontally elongated display as the display 24.

In a non-limiting example, the tablet terminal includes a touch panel that serves as an input device and is arranged opposing the display, and the touch panel and the display constitute a touch screen. When an element such as an icon, a button, an item, or an entry field is displayed in the display and the user performs an operation on a region of the touch panel opposing the region in which the element is displayed, a program that is associated with the element or a subroutine of the program is executed.

Note that the following transitions of display screens are merely examples of transitions of display screens that realize the method of the present disclosure. In the following examples of transitions of display screens, some display screens may be omitted, or another display screen may be added.

FIG. 1-8 is a diagram showing an example of a screen displayed on the display 24 of the terminal 20 in the present example embodiment. The terminal 20 is running an application program (which may be hereinafter referred to simply as an “application”) that provides the meeting room to the user, and the text “Online Meeting App” is displayed as the name of the application at an uppermost part of the screen.

In this example, the terminal 20A of the user A.A is running the application, and the icon image and the username of the user A.A are displayed at the uppermost part of the screen.

FIG. 1-8 shows an example in which the user A.A is participating in a meeting taking place in the room A, and three other users, namely the users B.B, C.C, and D.D are also participating in the meeting.

In this example, regions for displaying information related to the room A are provided and include a meeting room region RRA, which displays a video related to the meeting taking place in the room A, and a room participant region PRA, which displays information related to the users participating in the meeting taking place in the room A.

The meeting room region RRA displays the name (room A) of the meeting room, and videos of the respective users (the users A.A, B.B, C.C, and D.D) (video information). In a non-limiting example, a video captured by the image capturing device 27 of the terminal 20 of each user is displayed in association with identification information regarding the user (the icon image and the username of the user).

The room participant region PRA displays the number (four) of users participating in the meeting taking place in the room A, and the icon images and the usernames of the other users (the users B.B, C.C, and D.D).

As shown in FIG. 1-8, the uppermost part of the screen is provided with a speaker button SBT for the user A.A to operate to set whether or not to output the user A.A's voice (in a non-limiting example, a voice input to the sound input device 25 of the terminal 20A) from the terminals 20 of the users in the room A (in a non-limiting example, the other three users: which may alternatively be four users including the user A.A themself), a video button VBT for the user A.A to operate to set whether or not to display a video of the user A.A (in a non-limiting example, a video captured by the image capturing device 27 of the terminal 20A) on the terminals 20 of the users in the room A (in a non-limiting example, the other three users or four users including the user A.A themself), a chat button CHBT for the user A.A to operate to transmit and receive contents (text, voice, image) between the user A.A and the other (three) users in the form of chat, and a share button SCBT for the user A.A to operate to set whether or not to cause the displays 24 of the terminals 20 of the other (three) users to display (e.g., whether or not to share the screen of) a part or all of information displayed on the display 24 of the terminal 20A of the user A.A.

Note that the room participant region PRA includes buttons for individual chat for the other respective users (users B.B, C.C. and D.D). When, in a non-limiting example, the user A.A wants to individually have a one-on-one chat with the user B.B, the user A.A can transmit and receive contents (text, voice, image) in the form of chat to and from the user B.B without letting the users C.C and D.D know by operating the button for chat provided in correspondence with the icon and the username of the user B.B. In this regard, these buttons for chat have a different function from that of the aforementioned chat button CHBT.

In the example shown in FIG. 1-8, information related to other meetings in which the user A.A is not participating (meetings taking place in meeting rooms different from the room A) is displayed in a room topic list region TR.

The text “Topics in other meeting rooms” is displayed at an uppermost part of the room topic list region TR, and each word displayed in the room topic list region TR is based on information transmitted and received between terminals of users participating in the other meetings (users different from the users in the room A), in a non-limiting example.

In a non-limiting example, the words displayed in the room topic list region TR may be words that appear frequently, words that have appeared recently, or the like, among words contained in text transmitted and received between users participating in the other meetings.

The words displayed in the room topic list region TR may also be words used frequently, words used recently, or the like, among words included in conversations (voice information) between users participating in the other meetings, in a non-limiting example.

As one example, since words “fishing” and “weekends” are displayed in the room topic list region TR, the user A.A can infer and ascertain that a topic of “going fishing on weekends” is being discussed in a meeting in a different room from the room A.

Note that in the example of the display screen in the present specification, words (which may be referred to as “room tag notification information”) such as “fishing”, “weekends”, and the like are displayed with a hashtag, which is a type of set identifier word (desired or predetermined identifier word), added. However, adding an identifier word is not essential. An identifier word other than a hashtag may alternatively be added. In a non-limiting example, each of the words is an example of a later-described room topic and room tag notification information.

An upper diagram of FIG. 1-9 shows an example of a screen displayed on the terminal 20A of the user A.A. Unlike the example shown in FIG. 1-8, a region displaying “other meeting rooms” is provided, where information related to the other rooms is displayed.

In this example, the icon images and the usernames (users E.E to H.H. users I.I to K.K. users L.L to O.O) of users participating in the meetings in the other respective rooms (rooms B, C, D) are displayed in association with the respective room names in corresponding other-room information display regions (MRB, MRC, MRD). Words (“fishing” and “weekends”, “nursery” and “likes and dislikes”, “patent” and “unearned income”) associated with topics in the respective rooms are displayed in sub-regions (SRB, SRC, SRD) included in the other-room information display regions.

Note that a voice saying “I've been into houseplants lately” of the user B.B participating in the same meeting as the user A.A (meeting in the room A) is output from the sound output device 26 of the terminal 20A of the user A.A.

A lower diagram of FIG. 1-9 shows an example of a screen displayed on the terminal 20E of the user E.E. Because the user E.E is participating in the meeting in the room B, videos of the users (users E.E to H.H) participating in the meeting in the room B are displayed in a meeting room region RRB.

Meanwhile, for the user E.E, the room A is another room in which a meeting in which the user E.E is not participating is taking place. Thus, the icon images and the usernames (users A.A to D.D) of the users participating in the meeting in the room A are displayed in a corresponding other-room information display region MRA, and words (“hobbies” and “houseplants”) associated with the topic in the room A are displayed in the sub-region SRA included in the other-room information display region.

Note that a voice saying “Let's go fishing for sea bream on a boat!” of the user F.F participating in the same meeting as the user E.E (meeting in the room B) is output from the sound output device 26 of the terminal 20E of the user E.E.

Note that the other-room information display region MRB includes icons for chatting with the users included in the room B, and contents can be transmitted and received to and from each user in the form of chat by tapping on a corresponding icon.

However, without limitation to this mode, it is also possible that the icons for chat are not provided such that contents cannot be transmitted and received to and from room members in the other rooms by means of chat.

In the case of displaying words (room topics, room tag notification information) in the sub-regions, video information regarding each room may be displayed transparently, unlike the above example of the display screen. That is, the user may be able to see the transparent video information regarding the room and check the words together.

### Processing

In the following processing, description is given of only processing executed by the terminals 20 of some of the room members in the same meeting room, such as processing executed by the terminals 20 of the users A.A and B.B in the room A or by the terminals 20 of the users E.E and F.F in the room B mentioned above. There are cases where processing executed by the terminals 20 of the other room members in the same meeting room is omitted.

FIG. 1-10 is a flowchart showing an example of a flow of processing executed in the communication system 1 according to the present example embodiment.

Note that the processing described below is merely an example of processing for implementing the method of the present disclosure, and the present disclosure is not limited to this processing.

Another step may be added to the following processing, or some steps may be omitted (deleted) from the following processing.

First, the controller 11 of the server 10 performs meeting initialization processing (W110). For example, if a meeting start request from the terminal 20 of a user who is a meeting master (hereinafter referred to as a “master terminal”) is received via the communication I/F 14, meeting management data is generated in which a meeting ID is associated with a meeting master ID. Based on an invitation request made by the master terminal, invitation information is transmitted to the terminal 20 of a member to whom the invitation request has been given. A request to create a meeting room is also received from the master terminal, and a request to participate in the meeting room is received from the terminal 20 of a member (member terminal). Then, the meeting room management data associated with a room ID, a room name, a room member ID, and a room topic is stored in the aforementioned meeting management data. Note that the room topic may be “NULL” at this point.

Next, the controller 11 of the server 10 performs in-room moving image distribution processing (W120).

FIG. 1-11 is a flowchart showing an example of a flow of the in-room moving image distribution processing according to the present example embodiment. The flowchart shows processing executed by the controller 21 of the terminal 20E of the user E.E, processing executed by the terminal 20F of the user F.F, and processing executed by the controller 11 of the server 10, in order from the left.

Note that, here, the processing executed by the controller 21 of the terminal 20E of the user E.E and the processing executed by the terminal 20F of the user F.F is shown as processing executed by the terminals 20 of the users included in the room B, but processing executed by the terminals 20 of the other users included in the room B may be the same.

Further, processing executed by the terminals 20 of room members of meeting rooms other than the room B may also be the same.

The controller 21 of the terminal 20E transmits moving image information that includes video information captured by the image capturing device 27 (in a non-limiting example, a front camera) of the terminal 20 and sound information input by the sound input device 25 to the server 10 by means of the communication I/F 22 (E110).

The same applies to the terminal 20F (F110) (and the other room member terminals).

Upon receiving the moving image information by means of the communication I/F 14, the controller 11 of the server 10 performs in-room moving image generation processing (S110). For example, in a non-limiting example, processing is performed to generate information regarding a moving image (=sound information+video information) to be transmitted to the terminals 20 of the users included in the room B as in-room moving image information (=in-room sound information+in-room video information) based on the moving image information received from the terminals 20E and 20F (and the other room member terminals).

Next, the controller 11 of the server 10 performs in-room voice analysis processing (S120). For example, in a non-limiting example, voice recognition processing or the like is performed on the sound information included in the moving image information received from the terminals 20E and 20F (and the other room member terminals), the voice of the group in the room is transcribed, and the content of conversation based on the transcribed voice is subjected to morphological analysis. Then, in a non-limiting example, the use frequency of each word is identified and stored in association with the corresponding room ID in the meeting room management data.

Thereafter, the controller 11 of the server 10 transmits the in-room moving image information generated in step in S110 to the terminals 20E and 20F (and the other room member terminals) by means of the communication I/F 14 (S130). The controller 11 of the server 10 then ends the processing.

Upon receiving the in-room moving image information by means of the communication I/F 22, the controller 21 of the terminal 20E outputs the received in-room moving image information from the output device (E120). For example, the controller 21 of the terminal 20E causes the display 24 to display the in-room video information, and causes the sound output device 26 to output the in-room sound information. The controller 21 of the terminal 20E then ends the processing.

The same applies to the terminal 20F (and the other room member terminals) (F120→end of processing).

Returning to FIG. 1-10, after performing the in-room moving image distribution processing, the controller 11 of the server 10 determines whether or not a set time (in a non-limiting example, one minute, three minutes, five minutes, 10 minutes etc.) has elapsed (W130).

Note that it may be determined whether or not a set regular period, instead of the set time, has elapsed. In a non-limiting example, it may be determined whether or not a set period determined by a timing, such as a certain minute every hour or a certain second every minute, has elapsed. The same applies below.

If it is determined that the set time has not elapsed (W130: NO), the controller 11 of the server 10 advances the processing to W160. On the other hand, if it is determined that the set time has elapsed (W130: YES), the controller 11 of the server 10 performs room topic acquisition processing (W140).

For example, in anon-limiting example, the controller 11 of the server 10 calculates the top N most frequent words based on the results of in-room voice analysis for each meeting room at a set time. The calculated most frequent words are stored in association with a room topic in the record of the corresponding room ID in the meeting room management data included in the meeting management data of the corresponding meeting ID.

Note that, without limitation to the method of simply calculating the most frequent words, related words or synonyms associated with words (or sentences) identified from the analyzed voice may alternatively be calculated based on the voice analysis results for each room at the set time, in a non-limiting example. Furthermore, words may be clustered from the analyzed voice, and representative words may be calculated from the clustered words. The thus-calculated words may be used as the room topics.

Next, the controller 11 of the server 10 performs room topic update processing (W150).

FIG. 1-12 is a flowchart showing an example of a flow of the room topic update processing. The flowchart shows processing executed by the controller 21 of the terminal 20A of the user A.A, processing executed by the controller 21 of the terminal 20B of the user B.B, and processing executed by the controller 11 of the server 10, in order from the left.

Note that, here, processing executed by the terminal 20A of the user A.A and by the terminal 20B of the user B.B is shown as processing executed by the terminals 20 of the users included in the room A, but processing executed by the other room member terminals in the room A may be the same.

Further, processing executed by the terminals 20 of room members in the rooms other than the room A may also be the same.

First, the controller 11 of the server 10 transmits room topic information that contains room topics acquired from each room through the room topic acquisition processing in W140 to the terminals 20A and 20B (and the other room member terminals) by means of the communication i/F 14 (S140). The controller 11 of the server 10 then ends the processing.

Note that the room topic information regarding each room need not necessarily be transmitted to the terminals 20 of the room members in that room. That is, the server 10 may be configured to not transmit, based on the room ID in the meeting room management data, room topic information regarding a room topic associated with this room ID to the terminals 20 of users identified by room member IDs associated with this room ID.

Upon receiving the room topic information from the server 10 by means of the communication I/F 22, the controller 21 of the terminal 20A performs room tag notification information generation processing (A110). For example, in a non-limiting example, the controller 21 of the terminal 20A generates, as the room tag notification information, information obtained by adding a set or predetermined identifier word (in a non-limiting example, a hashtag (#) etc.) to the room topic included in the room topic information regarding the corresponding room received from the server 10.

Next, the controller 21 of the terminal 20A causes the display 24 to display the room tag notification information generated in A110 (A120). In this case, in anon-limiting example, the room tag notification information may be displayed in a region where a list of topics in the other meeting rooms is displayed, as shown in FIG. 1-8. Further, in a non-limiting example, the room tag notification information regarding the other meeting rooms may be displayed in the regions where the topics in the respective rooms are displayed room by room, as shown in FIG. 1-9.

The controller 21 of the terminal 20A then ends the room topic update processing.

The controller 21 of the terminal 20B also performs the room tag notification information generation processing (B110) and displays the room tag notification information generation processing (B120), similarly to the controller 21 of the terminal 20A, and ends the room topic update processing.

In the case where the server 10 is configured to transmit the room topic information regarding the room A to the terminals 20A and 20B (and the other room member terminals), the controllers 21 of the terminals 20A and 20B (and the other room member terminals) may be configured to not generate room tag notification information regarding the room A in steps A110 and B110 and not display the room tag notification information regarding the room A in steps A120 and B120.

The same may apply to the cases where the server 10 does not transmit the room topic information regarding the room A to the terminals 20A and 20B (and the other room member terminals).

Returning to FIG. 1-10, the controller 11 of the server 10 determines, after W150, whether or not to end the meeting (W160), and returns the processing to W120 if it is determined that the meeting is not to be ended yet (W160: NO).

On the other hand, if it is determined that the meeting is to be ended (W160: YES), the controller 11 of the server 10 ends the processing.

According to the above processing, every time the set time elapses, the server 10 acquires and updates room topics. That is, room topics are updated over time, and the latest updated room topics are displayed on the terminals 20.

Note that, unlike the above processing, the server 10 may generate room tag notification information based on room topics and transmit the generated room tag notification information to the terminals 20.

In the above processing, each terminal 20 displays the room tag notification information on the display 24, but there is no limitation to this configuration. In some example embodiments, the display 24 may display room topics.

Further, each room topic need not necessarily be a word, and may be a sentence or a paragraph, in a non-limiting example.

Each terminal 20 may notify the user of the terminal 20 of room topics by, for example, outputting sound indicating the room topics from the sound output device 26. That is, notification is not limited to being realized by display but may also be realized by sound output.

In the above processing, the room topic information is information based on sound information transmitted and received in each meeting room, but there is no limitation to this configuration. As mentioned above, room topics may also be estimated based on text or the like transmitted and received in each meeting room.

In addition, in a non-limiting example, room topics may be estimated based on video information transmitted and received in each meeting room. In this case, the controller 11 of the server 10 may perform movement analysis on people included in videos and estimate room topics based on the results of the movement analysis during the room topic acquisition processing, in a non-limiting example. If, in a non-limiting example, a person is performing a dancing movement, “dancing” may be estimated as a room topic. Note that it may be difficult to estimate a room topic from a person's movement alone, and room topics may be estimated by using sound information in combination.

Instead of or in addition to room topics, the controller 11 of the server 10 may estimate information regarding the liveliness of the conversation, the amount of conversation, or the like in a discussion in each meeting room as room conversation state information based on various types of information transmitted and received in the meeting room as described above, and transmit the estimated information to each terminal 20. The terminal 20 may then give notification based on the received room conversation state information. Note that the notification may be realized by sound output, similarly to the room topics. Although the cases of applying notification based on room topics are mainly described, the same may apply to cases of applying notification based on the room conversation state information or the like.

Note that information transmitted and received in a meeting room may also be expressed as, for example, information transmitted and received in a group, information transmitted and received between room members of a meeting room, and information transmitted and received between terminals of room members of a meeting room.

### Effects of First Example Embodiment

In the present example embodiment, the terminal 20, which outputs moving image information (a non-limiting example of sound information and video information) transmitted and received in a first meeting room (a non-limiting example of a first group) by means of the sound output device 26 and the display 24, receives information (a non-limiting example of first information) such as room topic information based on information transmitted and received in a second meeting room (a non-limiting example of a second group) by means of the communication I/F 22. The terminal 20 is configured to give notification with display and/or sound output based on the received room topic information (a non-limiting example of first notification based on first information) by means of the controller 21.

As an example of an effect of the example embodiment achieved by the above configuration, the terminal can receive the first information based on the information transmitted and received in the second group different from the first group, and thereafter give the first notification based on the first information, thereby enabling the user of the terminal to infer the information transmitted and received in the second group. Accordingly, the user of the terminal could easily and immediately infer the information transmitted and received in the second group without executing some extra operations at the cost of computing and/or communication resources of the terminal (and/or the server). In other words, the user of the terminal could immediately ascertain topics of different meeting rooms other than the current meeting room in which the user is participating. Thus, the user can ascertain the topics of different meeting rooms more quickly without performing time and resources-consuming additional analysis for each of the different chatrooms. Thus, the topics of the different chatrooms can be ascertained more quickly (e.g., concurrently) while consuming less processing resources of the terminal or the server.

Note that the user of the terminal 20 that outputs the moving image information (a non-limiting example of sound information and video information) transmitted and received in a meeting room (group) by means of the sound output device 26 and the display 24 need not necessarily be included in this meeting room (group), and may not be a user who is not included in the meeting room (group).

In this case, in a non-limiting example, the room topic information (a non-limiting example of first information) may include information based on sound information transmitted and received in the second meeting room (a non-limiting example of a second group), and the aforementioned notification (a non-limiting example of first notification) may be information (a non-limiting example of first display based on first information such as the room topic information and the room tag notification information, etc.) displayed on the display 24 of the terminal 20.

As an example of an effect of the example embodiment achieved by the above configuration, the terminal can receive the first information including information based on sound information transmitted and received in the second group, and thereafter perform the first display based on the first information, thereby enabling the user of the terminal to infer the sound information transmitted and received in the second group.

In the present example embodiment, the server 10 relays moving image information (a non-limiting example of video information and sound information) transmitted and received in the first meeting room (a non-limiting example of a first group), and relays moving image information (a non-limiting example of video information and sound information) in the second meeting room (a non-limiting example of a second group). The server 10 includes the controller 11 that acquires information (a non-limiting example of first information associated with a second group) such as room topic information based on information transmitted and received in the second meeting room, and the communication I/F 14 that transmits the information such as room topic information to the first meeting room.

As an example of an effect of the example embodiment achieved by the above configuration, the server, which relays video information and sound information transmitted and received in the first group and relays video information and sound information transmitted and received in the second group different from the first group, can acquire the first information associated with the second group and thereafter transmit the acquired first information to the first group.

Here, the phrase “information transmitted and received in a group” is described.

In a non-limiting example, the “information transmitted and received in a group” may refer to a concept that includes, for example, information transmitted from a user included in the group (the terminal 20 of a user included in the group) being transmitted to the server 10 and the server 10 generating information such as the aforementioned in-room moving image information and transmitting the generated information to the group (the terminal 20 of the user included in the group), and that includes information transmitted from a first user (the terminal 20 of a first user) included in the group being transmitted to the terminal 20 of a user who is included in the same group and is not the first user. Further, the “information transmitted and received in a group” may include both the case of transmitting information via the server 10 and the case of transmitting information without going through the server 10.

In a non-limiting example, the phrase “sound information and video information transmitted and received in a group” may refer to a concept that includes the following modes. Although several patterns are listed as examples, there is no limitation thereto.
Video information and sound information transmitted by a target user included in the group (hereinafter referred to as a “target user”) as well as video information and sound information transmitted from a user who is included in the group and is not the target user (hereinafter referred to as a “user other than the target user”) both are output on the terminal 20 of the target user.
Video information transmitted from the user other than the target user is displayed on the terminal 20 of the target user, but video information transmitted by the target user is not displayed on the terminal 20 of the target user (e.g., the video information is not transmitted from the terminal (application) to the server, the video information is transmitted from the terminal to the server but is not transmitted from the server to the terminal, or the video information is transmitted from the terminal to the server and video information received from the server is not displayed).
Sound information transmitted from the user other than the target user is output on the terminal 20 of the target user, but sound information transmitted by the target user is not output on the terminal 20 of the target user (e.g., the sound information is not transmitted from the terminal (application) to the server, the sound information is transmitted from the terminal to the server but is not transmitted from the server to the terminal, or the sound information is transmitted from the terminal to the server and sound information received from the server is not output).
Video information transmitted by the target user, and sound information and video information transmitted from the user other than the target user is output on the terminal 20 of the target user, but sound information transmitted by the target user is not output on the terminal 20 of the target user (same as above for sound information).
Sound information transmitted by the target user, and sound information and video information transmitted from the user other than the target user is output on the terminal 20 of the target user, but video information transmitted by the target user is not displayed on the terminal 20 of the target user (same as above for video information).
Neither sound information nor video information transmitted by the target user is output on the terminal 20 of the target user (same as above for sound information and video information).
At least either sound information or video information transmitted by some user other than the target user is not output on the terminal 20 of the target user.
The terminal 20 of the target user can control the output of video information and sound information in accordance with output settings on the terminal 20 of the target user (e.g., turn ON or OFF moving image information, turn ON or OFF sound information, or turn ON or OFF video information).

### Modification (1)

The configurations and UIs of the display screens of the meeting application including the above and other example embodiments are merely examples, and there is no limitation thereto. Other configuration examples of display screens are described below.

FIG. 1-13 shows an example of a screen displayed on the terminal 20A of the user A.A. Unlike the example shown in FIG. 1-9, information regarding participants (users A.A to D.D) related to the room A in which the user A.A is participating is also displayed in the room member list region MLR at the right end of the screen in the same manner as information regarding participants related to the other rooms (rooms B, C, D) in which the user A.A is not participating.

In the room member list region MLR, information regarding the participants (users A.A to D.D) related to the room A in which the user A.A is participating, and information regarding participants (users E.E to H.H, users I.I to K.K, users L.L to O.O) related to the respective rooms (rooms B, C, D, . . . ) in which the user A.A is not participating are displayed vertically. The user A.A can scroll up and down to check the participants in the room A in which the user A.A is participating, as well as the participants in the respective rooms (rooms B, C, D, . . . ) in which the user A.A is not participating.

Room topic regions (TRB, TRC, TRD, . . . ) displaying words associated with topics in the respective rooms (rooms B, C, D, . . . ) in which the user A.A is not participating are provided near the meeting room region RRA. The user A.A can check what topics are being discussed at meetings in the respective meeting rooms in which the user A.A is not participating by checking the room topic regions.

In a non-limiting example, the words “nursery” and “likes and dislikes” are displayed in the room topic region TRC of the room C, whereby the user A.A can ascertain that a conversation about these topics is taking place in the room C.

Note that a room topic region TRA may also be provided that displays words (in a non-limiting example. “hobbies” and “houseplants”) associated with topics in the room A in which the user A.A is participating, in addition to the room topic regions (TRB, TRC, TRD, . . . ) corresponding to the respective rooms (B, C, D, . . . ) in which the user A.A is not participating.

By tapping a region corresponding to any of the meeting rooms in the room member list region MLR, the mode of the room topic region corresponding to that meeting room may change (in a non-limiting example, the color or the position may change, or that room topic region may be enlarged). This configuration makes clear the relationship between participants in each room and topics in the meeting being conducted by the participants.

### Modification (2)

In step S140 in the processing shown in FIG. 1-12 in the above example embodiment, the controller 11 of the server 10 may perform search processing to search for an image based on a room topic, include the image obtained as the search result in the room topic information and transmit this room topic information to each terminal 20, in a non-limiting example. The controller 21 of the terminal 20A or the room member terminals including the terminal 20A may cause the display 24 to display the image included in the received room topic information.

In a non-limiting example, in steps A110 and B110 in the processing shown in FIG. 1-12, the controllers 21 of the terminal 20A and the terminal 20B may perform search processing to search for an image based on a room topic in the room topic information, based on the room topic information received from the server 10, and cause the display 24 to display the image obtained as the search result.

In a non-limiting example, in step S140 in the processing shown in FIG. 1-12 in the above example embodiment, the controller 11 of the server 10 may include information shared at the meeting, such as information shared on the screen of the meeting room, in room topic information and transmit this room topic information to each terminal 20.

Specific examples of these will be described with reference to display screens in the next second example embodiments.

### Second Example Embodiment

The second example embodiment relates to a user exiting from all meetings or moving to another meeting room. Some users may want to exit from all meeting rooms or move to a different meeting room from the current one.

The content described in the second example embodiment can be applied to any other example embodiments and modifications.

Constituent elements that are the same as those already described are assigned the same reference numerals as those used for corresponding elements, and a redundant description thereof is omitted.

### Display Screen

An upper diagram of FIG. 2-1 shows an example of a screen displayed on the terminal 20A of the user A.A participating in the room A.

Note that a description is given here of cases where room topics are displayed in the form of words and where room topics are displayed in the form of information described in the first modification (2).

In this example, unlike the example shown in FIG. 1-9, the meeting room region RRA includes a leave button LBT, which is located at a position corresponding to the room name (A) in which the user is present. Participate buttons PBT for entering the other rooms (rooms B, C, D) in which the user is not currently present are also provided at positions corresponding to the other respective room names (room B, room C, room D).

In the present example embodiment, an operation of the leave button LBT may be an example of an operation performed by the user A.A to exit from the entire meeting, in a non-limiting example. In this case, the leave button may also be an “exit button (from the entire meeting)”

Note that an operation of the leave button LBT may be an example of an operation performed by the user A.A to exit the room A (exiting from (leaving) a room, as will be described in detail later), or may be an example of an operation to leave the meeting (individual meeting) taking place in the room A, in a non-limiting example.

An operation performed by the user A.A to enter the room B (an operation of the participate button PBT corresponding to the room B) may be an example of an operation performed by the user A.A to enter the room B, or an example of an operation to participate in the meeting taking place in the room B.

Here, (1) a configuration may be employed in which the user A.A is allowed to operate the participate button PBT corresponding to the room B without operating the leave button LBT, or (2) a configuration may be employed in which the user A.A is unable to operate the participate button PBT corresponding to the room B unless the user A.A operates the leave button LBT.

(1) In the former case, upon tapping the participate button PBT corresponding to the room B, the user A.A is removed from the participants in the room A (users A.A to D.D) and added to the participants in the room B (users E.E to H.H). That is, the user A.A is automatically removed from the group in the room A. In other words, a room change need not involve leaving a room.

As an example of an effect achieved by the above configuration, an operation and processing for removing a user who wants to participate in another group from the current group can be simplified.

(2) In the latter case, the user A.A first removes himself (or herself) from the participants (users A.A to D.D) in the room A by tapping the leave button LBT, thus making the user A.A not participate in any rooms. The user A.A then taps the participate button PBT corresponding to the room B and is thereby added to the participants in the room B (users E.E to H.H). That is, the user A.A cannot participate in the room B by tapping the participate button PBT of the room B before tapping the leave button LBT of the room A. In other words, a room change may involve leaving a room.

As an example of an effect achieved by the above configuration, it is possible to block or prevent a user from being unintentionally removed from the group in which the user is currently participating due to misunderstanding or the like of the user, and to suppress easy movement between groups.

A lower diagram of FIG. 2-1 differs from the upper diagram in that information other than words is displayed as information based on information transmitted and received between terminals of users participating in meetings in the other rooms (rooms B, C, D) in which the user A.A is not participating.

In the case of the room B, an image (in this example, an image of fish (sea bream)), which is associated with at least either a frequently used word or a most recently used word among words included in text transmitted and received between users (users E.E to H.H) participating in the meeting in the room B, is displayed in the corresponding sub-region SRB, in a non-limiting example.

Note that the thus-displayed image may be an image based on the results of the aforementioned in-room voice analysis processing, such as an image searched for based on a room topic estimated as a result of the in-room voice analysis processing, in a non-limiting example.

In the case of the room D, an image of a screen that is shared (shared on the screen) between users (users L.L to O.O) participating in the meeting in the room D is displayed in the corresponding sub-region SRB.

An upper diagram of FIG. 2-2 shows an example of a screen displayed on the terminal 20A of the user A.A participating in the room A. Unlike the example shown in FIG. 2-1, the sub-regions (SRB, SRC, SRD) corresponding to the other rooms (rooms B, C, D) in which the user A.A is not participating display videos of the meetings taking place in the respective rooms.

In the case of the room B, in a non-limiting example, videos (videos corresponding to the respective users E.E to H.H) of the meeting that are displayed in the meeting room region RRB on the terminals 20 of the users (users E.E to H.H) participating in the meeting in the room B are displayed in a reduced manner in the corresponding the sub-region SRB.

This allows the user A.A to check the video of the meeting taking place in the room B in which the user A.A is not participating.

A lower diagram of FIG. 2-2 shows an example of a screen displayed when the user A.A performs an operation of the sub-region SRB corresponding the room B.

In this example, while the user A.A is touching and holding the sub-region SRB, the display in the sub-region SRB is switched from the video of the meeting taking place in the room B (videos corresponding to the users E.E to H.H) to words (“fishing” and “weekends”) associated with the topic in the room B. Upon the user A.A detaching the finger from the screen, the display returns to the video of the meeting (videos corresponding to the users E.E to H.H).

Note that a configuration may alternatively be employed in which, upon the user A.A tapping the sub-region SRB (touching the sub-region SRB and then detaching the finger therefrom), display in the sub-region SRB switches from the video of the meeting taking place in the room B (videos corresponding to the respective users E.E to H.H) to the words (“fishing” and “weekends”) associated with the topic in the room B; and thereafter, upon the user kA tapping the sub-region SRB (touching the sub-region SRB and detaching the finger therefrom) again, the display in the sub-region SRB switches from the words (“fishing” and “weekends”) associated with the topic in the room B to the video of the meeting taking place in the room B (videos corresponding to the respective users E.E to H.H).

This allows the user A.A. to ascertain the topic in the meeting taking place in the room B in which the user A.A is not participating (the topic of the users E.E to H.H participating in the room B).

Note that the same may apply to the state where an image associated with the topic in the meeting is displayed in the sub-region SRB (see FIG. 2-1) and the state where the screen shared in the meeting is displayed in the sub-region SRD (see FIG. 2-1).

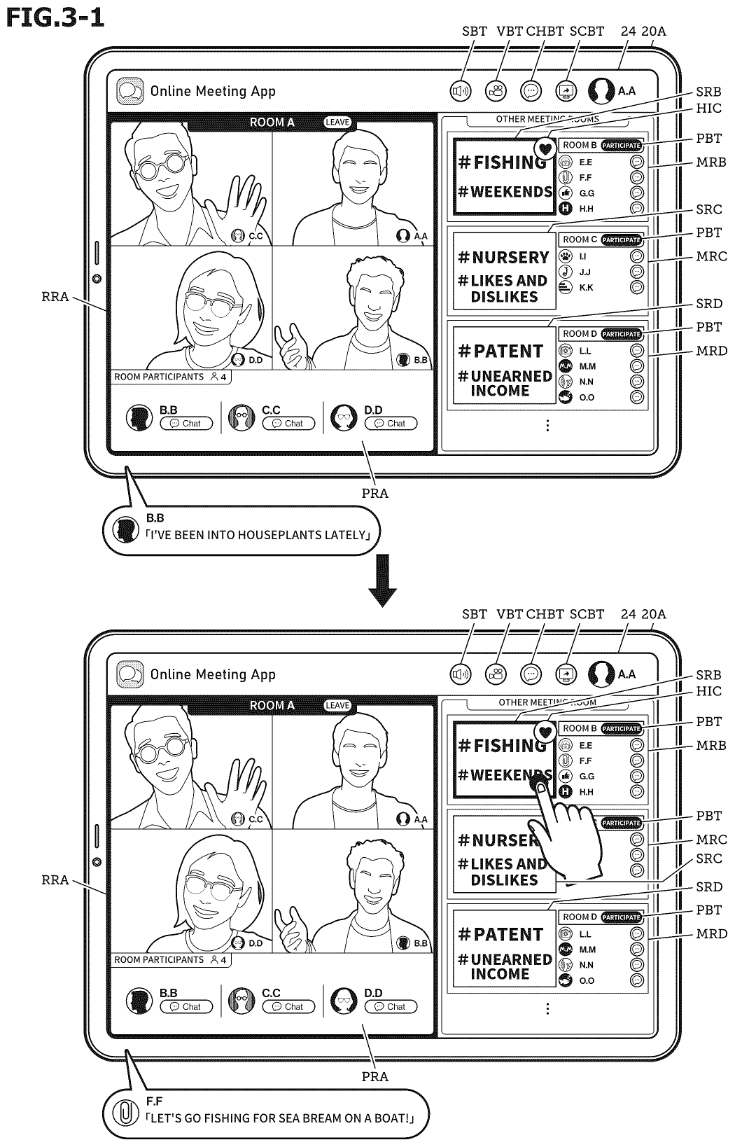

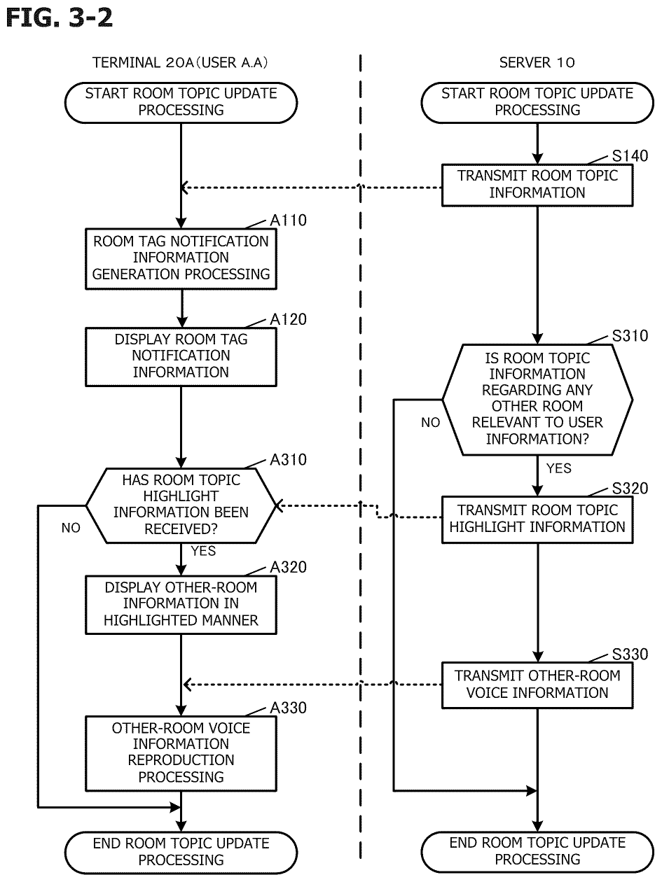

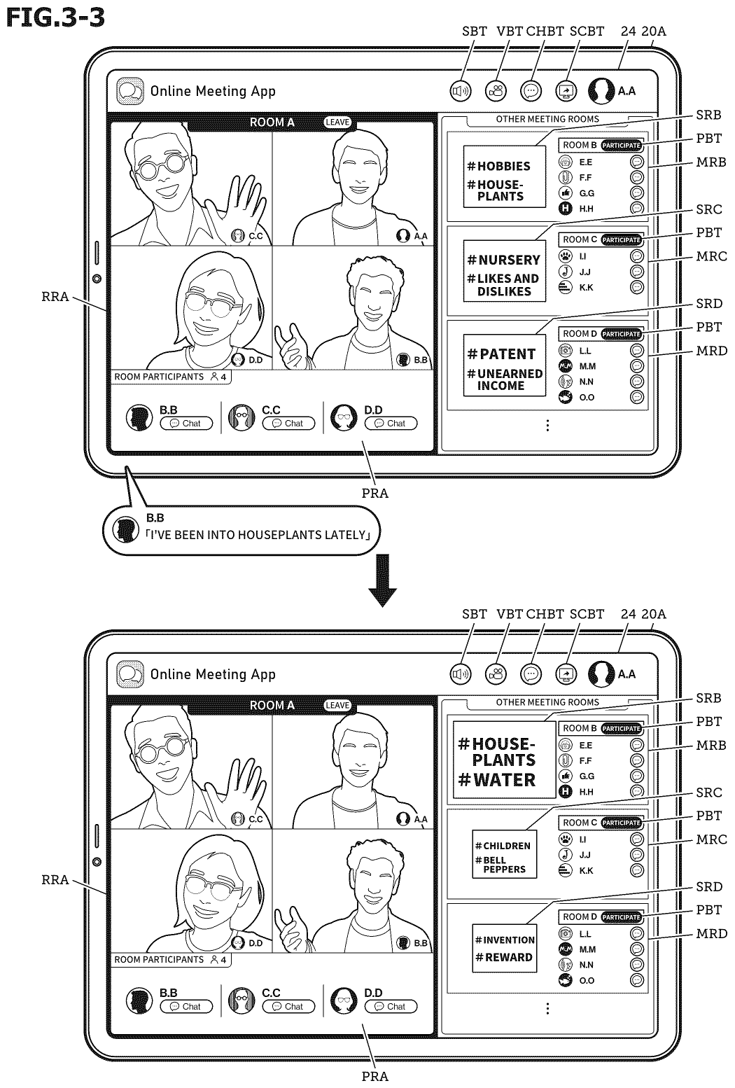

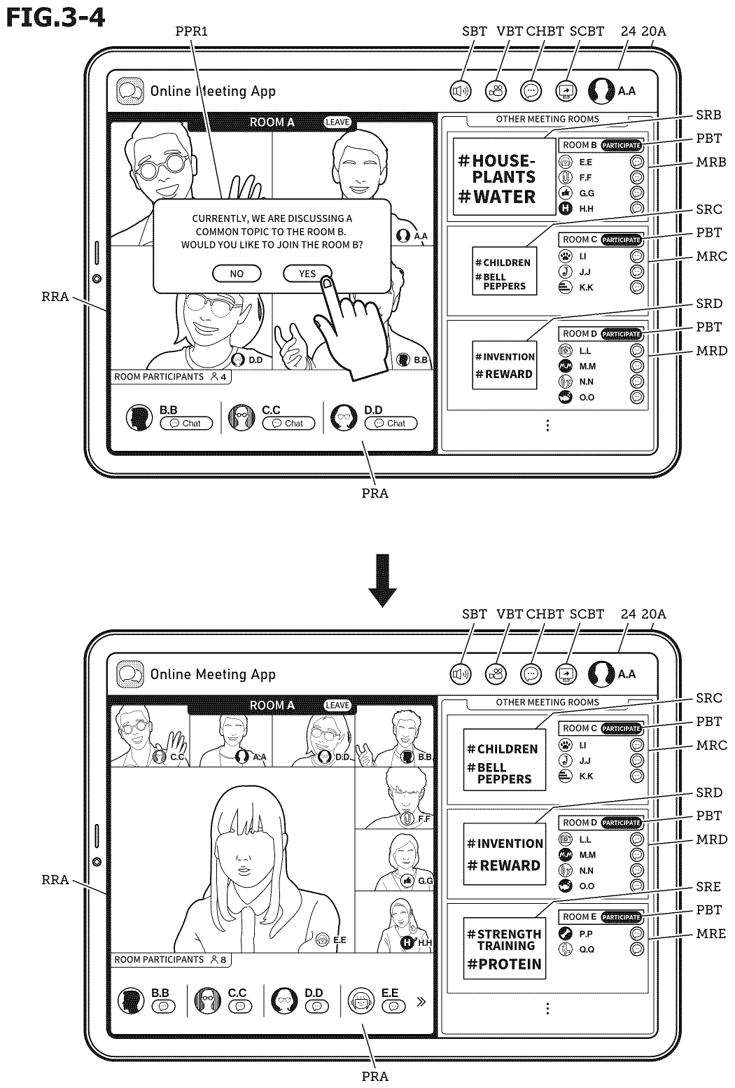

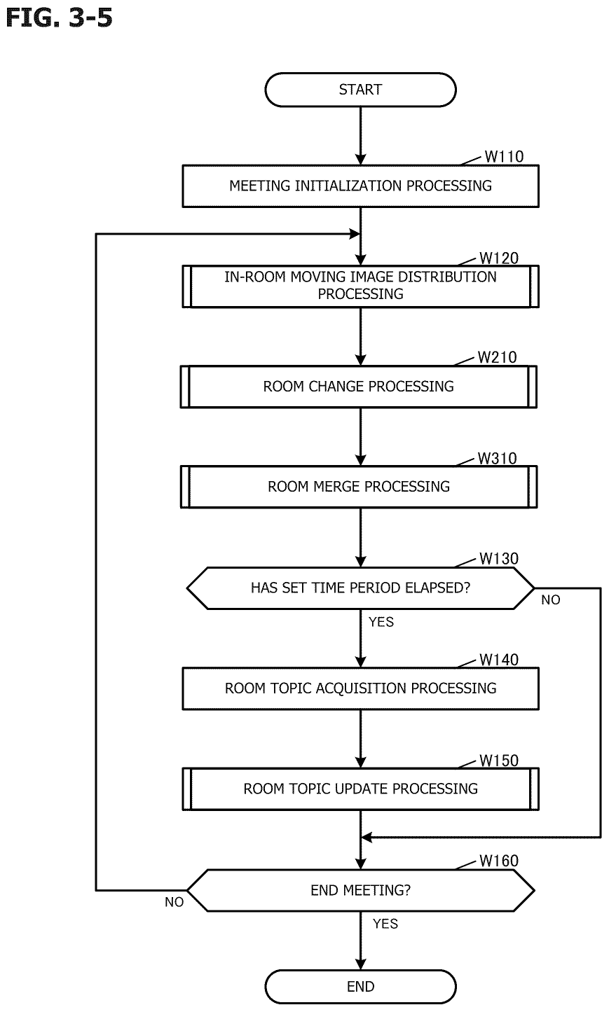

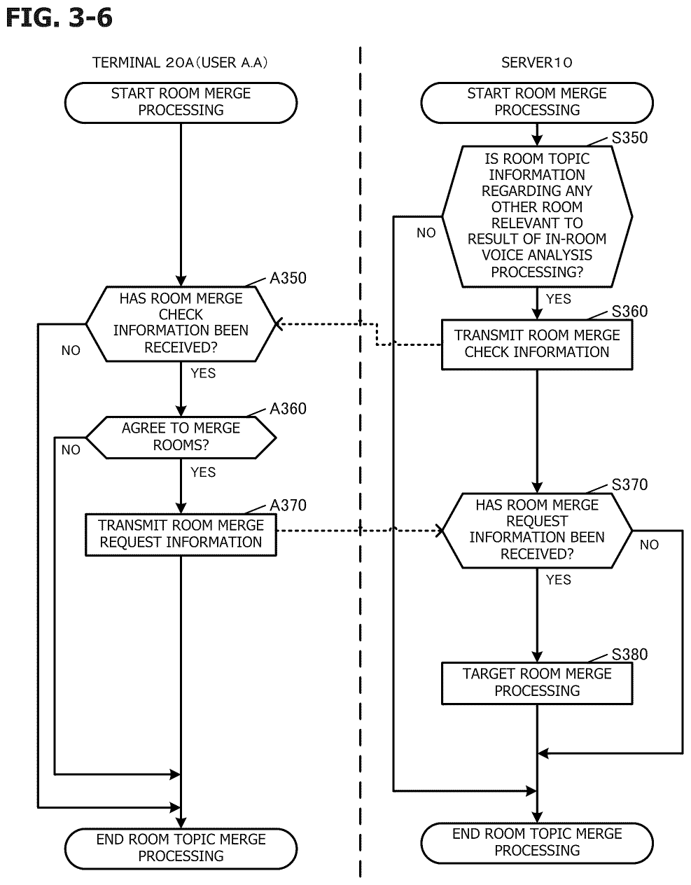

An upper diagram of FIG. 2-3 shows an example of a screen displayed on the terminal 20A of the user A.A participating in the room A.

When the user A.A taps the participate button PBT corresponding to the room B, the user A.A is removed from the participants in the room A (users A.A to D.D) and added to the participants in the room B (users E.E to H.H).

As shown in a lower diagram of FIG. 2-3, in response to the user A.A moving to another room, other-room information display region MRA corresponding to the room A, in which the user A.A is no longer participating, is displayed as information regarding “other meeting rooms”. The other-room information display region MRA displays the icon images and the usernames of the respective users B.B to D.D (a total of three users) participating in the room A even after the user A.A has stopped participating, but does not display the icon image and the username of the user A.A.

The other-room information display region MRB corresponding to the room B in which the user A.A is to participate now is not displayed as information regarding “other meeting rooms”.

The meeting room region RRB corresponding to the room B in which the user A.A is currently participating is displayed in place of the meeting room region RRA that has been displayed previously. The meeting room region RRB includes videos of the users B.B to H.H who have been participating since before the user A.A participated, as well as a video of the user A.A who is newly participating (a total of five users).

FIG. 2-4 is a diagram showing an example of a screen displayed when the user A.A in the room A taps the participate button PBT corresponding to the room B.

As shown in an upper diagram, the videos of the users A.A to D.D (a total of four users) are displayed in the meeting room region RRA corresponding to the room A in which the user A.A has been participating. However, as a result of the user A.A tapping the participate button PBT corresponding to the room B, an image UAI of the user A.A (a video of the user A.A or a still image (icon) generated based on the video) moves while being reduced in size from the meeting room region RRA to the other-room information display region MRB corresponding to the room B, as shown in a lower diagram.

In this example, as a result of the image UAI of the user A.A moving from the meeting room region RRA, the region where the image of the user A.A has been displayed becomes blank.

Note that the screen may transition to the screen shown in the lower diagram of FIG. 2-3 after the video of the user A.A has moved to the other-room information display region MRB.

### Processing

FIG. 2-5 is a flowchart showing an example of a flow of processing executed in the communication system 1 according to the present example embodiment. This flowchart is to be read in the same manner as FIG. 1-10.

After step W120, the controller 11 of the server 10 performs room change processing (W210).

FIG. 2-6 is a flowchart showing an example of a flow of the room change processing according to the present example embodiment. Processing executed by the controller 21 of the terminal 20A is shown on the left side of the flowchart, and processing executed by the controller 11 of the server 10 is shown on the right side.

The controller 11 of the server 10 performs the following processing for each meeting room. Note that the controllers 21 of all of the terminals 20 can execute the same processing, and here only the processing performed by the terminal 20A is shown in the flowchart.

The controller 21 of the terminal 20A determines whether or not to change the room by, for example, determining whether or not the user has made an input to change the meeting room via the input/output device 23 (A201).

Here, in a non-limiting example, the controller 21 of the terminal 20A displays other-room information (which may also be referred to as information indicating another meeting room or information indicating another group) on the display 24 via the input/output device 23. The terminal 20 can determine whether or not to change the meeting room (whether or not to participate in another meeting room) based on the input made by the user of the terminal 20 to the displayed other-room information.

Here, in a non-limiting example, the other-room information may include at least one of the following:
room topics, room tag notification information, and room conversation state information regarding each of the other meeting rooms;
the room name of the meeting room
Operation information (participate button etc.) for participating in the meeting room;
information related to room members of the meeting room; and
video information regarding the meeting room.

In the examples in FIGS. 2-3 and 2-4, the controller 21 of the terminal 20 determines whether or not to change the meeting room based on the operation of the participate button, but the controller 21 may alternatively determine whether or not to change the meeting room based on an operation of any of the above information. In some example embodiments, the controller 21 may determine whether or not to change the meeting room based on an input made by the user of the terminal 20 to a region displaying the other-room information (in a non-limiting example, any of the other-room information display regions and the sub-regions).

If it is determined that the room is not to be changed (A201: NO), the controller 21 of the terminal 20A ends the room change processing.

If it is determined that the room is to be changed, in a non-limiting example, the controller 21 of the terminal 20A transmits room change request information, which includes at least the application ID of the user of the terminal 20 and identification information identifying a destination room (in a non-limiting example, the room ID), to the server 10 by means of the communication I/F 22 (A203). The room change request information may be represented as information related to a request to participate in another room, for example.

Note that a change between meeting rooms is assumed here.

The controller 11 of the server 10 determines whether or not the room change request information has been received by means of the communication I/F 14 (S201). If it is determined that the room change request information has not been received (S201: NO), the controller 11 of the server 10 ends the room change processing.

If it is determined that the room change request information has been received (S201: YES), the controller 11 of the server 10 deletes the application ID of the user included in the received room change request information from the room member IDs associated with the room ID of the current meeting room in the meeting room management data, and adds the application ID of this user to the room member IDs associated with the room ID of the destination meeting room (S203). The controller 11 of the server 10 then ends the room change processing.

In a non-limiting example, upon a user input being made to information indicating the room B via the input/output device 23 on the screen displaying the room A, the terminal 20 of the user A.A can transmit the room change request information that includes, in a non-limiting example, the application ID of the user A.A and the room ID of the room B to the server 10 by means of the communication I/F 22 (A203).

In this case, the controller 11 of the server 10 can delete the application ID of the user A.A from the room member IDs associated with the room ID of the room A in the meeting room management data, and add the application ID of the user A.A to the room member IDs associated with the room ID of the room B (S203).

Here, when the user A.A is moved from the room A to the room B, the application ID of the user A.A is deleted from the room member IDs associated with the room ID of the room A. This may be considered as dissociating the user A.A from the room A.

However, there is no limitation thereto. In some example embodiments, when the user A.A is moved from the room A to the room B, the application ID of the user A.A may be left in the room member IDs associated with the room ID of the room A. This may be considered as not dissociating the user A.A from the room A. That is, the user A.A may be able to also participate in the room B while participating in the room A.

This may apply to the following processing.

Returning to FIG. 2-5, after performing the room change processing in step W210, the controller 11 of the server 10 advances the processing to step W130.

As a result of the controller 11 of the server 10 executing steps W120 to W160, in-room moving image information regarding the destination meeting room (in a non-limiting example, the room B) is output (i.e., in a non-limiting example, control is performed to switch to an output corresponding the room B) on the terminal 20A, and room tag notification information (or room topics) regarding the other meeting rooms, including the original meeting room (in a non-limiting example, the room A) is displayed. In this case, the room tag notification information (or room topics) regarding the room B need not be displayed on the terminal 20A.

Note that in the room topic update processing in step W150 (e.g. step S140 in the processing of FIG. 1-12) in a non-limiting example, the controller 11 of the server 10 may perform search processing to search for an image based on a room topic (in a non-limiting example, an image that match the room topic or an image closely related to the room topic), include the image in the room topic information and transmit this room topic information to the terminal 20, as described in the first modification (2). The controller 21 of the controller 20A or the controllers 21 of the room member terminals 20A, 20B, 20C, . . . including the terminal 20A may display the image included in the received room topic information on the display 24.

In a non-limiting example, in steps A110 and B110 in the processing shown in FIG. 1-12, the controllers 21 of the terminals 20A and 20B may perform search processing to search for an image based on a room topic (in a non-limiting example, an image that matches the room topic or an image closely related to the room topic) indicated by the room topic information, based on the room topic information received from the server 10, and cause the displays 24 to display the image obtained as the search result, in a non-limiting example.

In a non-limiting example, in step S140 in FIG. 1-12, the controller 11 of the server 10 may include information shared on the screen of the meeting room in the room topic information and transmit this room topic information to each terminal 20.

### Effects of Second Example Embodiment

The present example embodiment describes a configuration in which the room topic information (a non-limiting example of first information) includes image information based on sound information transmitted and received in a second meeting room (a non-limiting example of a second group), in a non-limiting example.

As an example of an effect of the example embodiment achieved by the above configuration, the terminal can receive the first information that includes the image information based on the sound information transmitted and received in the second group, and thereafter perform the first display based on the first information, thereby enabling the user of the terminal to infer the sound information transmitted and received in the second group more easily and appropriately.

Further, the present example embodiment describes a configuration in which, in a non-limiting example, the room topic information (a non-limiting example of first information) includes information shared in the second meeting room (a non-limiting example of a second group), such as information shared on the screen of the second meeting room.

As an example of an effect of the example embodiment achieved by the above configuration, the terminal can receive the first information that includes information shared in the second group, and thereafter perform the first display based on the first information, thereby enabling the user of the terminal to know the information shared in the second group.

In the present example embodiment, the terminal 20 displays video information transmitted and received in the first meeting room (a non-limiting example of a first group) and information indicating the second meeting room (a non-limiting example of information indicating a second group) on the display 24. Based on an input made by the user of the terminal 20 to the information indicating the second meeting room, the terminal 20 performs control to transmit room change request information to the second meeting room to the server 10 and control to switch to an output corresponding to the second meeting room (a non-limiting example of control for the user of the terminal to participate in the second group), by means of the controller 21.

As an example of an effect of the example embodiment achieved by the above configuration, control is performed, with video information transmitted and received in the first group and information indicating the second group being displayed, to allow the user of the terminal to participate in the second group based on the input made by the user to the information indicating the second group, thereby enabling the user of the terminal to participating in the second group and improving convenience.

### Third Example Embodiment

In the third example embodiment, the display mode of information related to another room can be changed based on information regarding room members included in a meeting room, in a non-limiting example.

In a non-limiting example, there are cases where a topic in which the user is interested is being discussed in another room. In such cases, the user may want to move to that room and join the discussion.

The content described in the third example embodiment can be applied to any other example embodiments and modifications.

Constituent elements that are the same as those already described are assigned the same reference numerals as those used for corresponding elements, and a redundant description thereof is omitted.

### Display Screen

An upper diagram of FIG. 3-1 shows an example of a screen displayed on the terminal 20A of the user A.A participating in the room A.

Based on user information regarding the user A.A (e.g., their hobby being “fishing”) in a non-limiting example, the word “fishing” displayed in the sub-region SRB corresponding to the room B is surrounded by a thick display frame, to which an icon HIC including a heart mark is added. Thus, the sub-region SRB displaying words associated with the topic in the room B is highlighted based on the user information regarding the user A.A participating in the room A being associated with the topic in the room B.

Upon the user A.A touching the sub-region SRB, a voice in the meeting in the room B (in a non-limiting example, the user F.F's voice saying “Let's go fishing for sea bream on a boat!”) is output from the sound output device 26 while the sub-region SRB is being touched. This voice is also the voice that is being output from the terminals 20 of the users E.E to H.H participating in the room B.

Thus, if a topic of interest comes up in the room B in which the user A.A is not participating, the user A.A can ascertain that the topic is being discussed and listen to the voice in the room B.

hat the example described here is merely one example.

Other-room information corresponding to a room discussing a topic relevant to a user can be displayed in a highlighted manner based on user information regarding a room member user (in a non-limiting example, attribute information regarding the user), for example.

In a non-limiting example, the user information may include at least one of the following types of information: gender, age, chronological age, place of residence, occupation, hobbies/preferences/interests, and the like of the user, and the relevance may be determined based on at least one of these types of information. The relevance may be determined based on a single type of information or a plurality of types of information.

In a non-limiting example, based on the user D.D in the room A being female and having a child (infant) as a family member, information regarding the room C whose room topics are “nursery school” and “likes and dislikes” may be displayed in a highlighted manner on the terminal 20D of the user D.D, for example.

In a non-limiting example, if the occupation of the user C.C in the room A relates to intellectual properties, information regarding the room D whose room topics are “patent” and “unearned income” may be displayed in a highlighted manner on the terminal 20C of the user C.C.

### Processing

FIG. 3-2 is a flowchart showing an example of a flow of room topic update processing according to the present example embodiment.

Note that, here, processing executed by the terminal 20A of the user A.A is shown as processing executed by the terminal 20 of a user included in the room A, but processing executed by the other room member terminals of the room A may be the same.

Further, processing executed by the terminals 20 of room members in rooms other than the room A may also be the same.

After step S140, the controller 11 of the server 10 determines whether or not room topic information regarding any other room different from the room of the group including the user A.A is relevant to the user information regarding the user A.A (S310). For example, in anon-limiting example, the controller 11 of the server 10 determines the relevance (similarity) between the user information regarding the user A.A registered as other registration information in the account registration data 153 and the room topic information regarding the other rooms, based on, in a non-limiting example, a method such as a relevance determination algorithm or a similarly determination algorithm. If it is determined that there is relevance, the determination result is positive (YES). If it is determined that there is no relevance, the determination result is negative (NO).

Note that in this case, the controller 11 of the server 10 may calculate an index value such as a relevance degree or a similarity degree based on a relevance determination algorithm or a similarity determination algorithm, and perform threshold determination on the index value to determine whether or not there is relevance, in a non-limiting example.

The determination for the room topic information regarding the other rooms may be performed for all of the meeting rooms other than the meeting room that includes the user A.A, or may be performed for some of the meeting rooms other than the meeting room that includes the user A.A.

If it is determined that there is relevance (S310: YES), the controller 11 of the server 10 transmits room topic highlight information for highlighting room topic information regarding a meeting room that has been determined to be relevant (in a non-limiting example, information including the room ID of the meeting room) to the terminal 20A by means of the communication I/F 14 (S320).

The controller 11 of the server 10 then ends the room topic update processing.

After A120, the controller 21 of the terminal 20A determines whether or not the room topic highlight information has been received from the server 10 by means of the communication I/F 22 (A310). If it is determined that the room topic highlight information has been received (A310: YES), the controller 21 causes highlighted other-room information to be displayed (A320). For example, the controller 21 of the terminal 20A performs control to change the display mode of other-room information (a non-limiting example of information indicating a group) regarding another room that has been determined to be relevant, for the room identified by the room ID included in the received room topic highlight information.

Here, the other-room information (a non-limiting example of information indicating a group) is as described in the second example embodiment. The controller 21 of the terminal 20A may perform control to change the display mode of at least one of the following types of information, in a non-limiting example, for the other meeting room that has been determined to be relevant:
room topics, room tag notification information, and room conversation state information regarding the meeting room;
the room name of the meeting room
operation information (participate button etc.) for participating in the meeting room;
information regarding room members of the meeting room; and
video information regarding the meeting room.

Note that the controller 21 may determine the display mode of a region displaying the other-room information (in a non-limiting example, the other-room information display region or the sub-region).

In this case, the display mode can be changed using at least one of the following methods, in a non-limiting example, for information whose display mode is to be changed:
changing the size (in a non-limiting example, increasing the size);
changing the color (in a non-limiting example, displaying the information in a conspicuous color, such as red);
displaying the information in a lit or flashing manner, and
adding an icon, a mark, or the like.

Note that there is no limitation thereto, and any other method may be applied.

After S320, the controller 11 of the server 10 transmits voice information regarding another room (hereinafter referred to as “other-room voice information”) that has been determined to be relevant, to the terminal 20A by means of the communication I/F 14 (S330).

After A320, the controller 21 of the terminal 20A performs control to output, from the sound output device 26, sound based on the other-room voice information received by means of the communication I/F 22 (A330).

The other-room voice information transmitted by the server 10 to the terminal 20A may be at least a part of the other-room voice information that has been determined to be relevant. In a non-limiting example, the other-room voice information transmitted by the server 10 to the terminal 20A may be voice information obtained in a period in which the user was performing an operation such as touching as shown in FIG. 3-1, or may be voice information obtained by trimming at least a part of other-room voice information that has been recorded by the server 10.

The controller 21 of the terminal 20A then ends the room topic update processing.

If the room topic highlight information is not received in A310 (A310: NO), the controller 21 of the terminal 20A does not perform steps A320 and A330 and ends the room topic update processing. That is, if it is determined that the room topic information regarding the other rooms is not relevant to the user information regarding the user A.A, the other-room information is not displayed in a highlighted manner, or the other-room voice is not reproduced either.

Note that in step S330, the controller 11 of the server 10 may transmit the other-room voice information based on a request from the terminal 20A, or may unconditionally transmit the other-room voice information.

Further, in step A330, the controller 21 of the terminal 20A may reproduce the other-room voice information based on a user input having been made via the input/output device 23, or may unconditionally reproduce the other-room voice information. The other-room voice information may be reproduced while being mixed with in-room voice information regarding the room A, or the other-room voice information may be solely reproduced without mixing.

In a non-limiting example, the controller 21 of the terminal 20A may control the sound volume of at least a part of the other-room voice information based on the user information regarding the user A.A. In anon-limiting example, control is performed to reproduce the other-room voice information at a first sound volume if the other-room voice information is determined to be relevant but the relevance is low, or if the number of pieces of information that are determined to be relevant among pieces of information regarding the user A.A is small. On the other hand, control may be performed to reproduce the other-room voice information at a second sound volume higher than the first volume if the other-room voice information is determined to be highly relevant, or if the number of pieces of information that are determined to be relevant among pieces of information regarding the user A.A is large.

In the above processing, the server 10 determines the relevance between the room topic information regarding the other rooms and the user information regarding the user A.A. However, the controller 21 of the terminal 20A may alternatively perform this determination. In this case, in a non-limiting example, the user information regarding the user A.A is stored in the storage 28 of the terminal 20A or retrieved from the server 10 in advance, and in a non-limiting example, the controller 21 of the terminal 20A may determine the relevance after step A120 in the above processing. The controller 21 of the terminal 20A may then proceed to step A310.

### Effects of Third Example Embodiment

The present example embodiment describes a configuration in which the controller 21 of the terminal 20 performs control such as displaying other-room information in a highlighted manner (a non-limiting example of control to cause a display to perform first display while changing a display mode) based on information regarding the user of the terminal 20.

As an example of an effect achieved by the above configuration, the display mode of the first display based on the first information can be varied based on the information regarding the user of the terminal. In a non-limiting example, the first display based on the first information in which the user of the terminal is interested can be displayed in a highlighted manner, thereby improving convenience.

The present example embodiment describes a configuration in which the terminal 20 receives at least a part of sound information transmitted and received in the second meeting room by means of the communication I/F 22.

As an example of an effect of the example embodiment achieved by the above configuration, at least a part of the sound information transmitted and received in the second group can be received. In a non-limiting example, the user of the terminal can be informed of at least a part of the sound information transmitted and received in the second group by outputting the sound based on the sound information from the sound output device.

In this case, the terminal 20 may control the sound volume of at least a part of the received sound information transmitted and received in the second meeting room based on the information regarding the user of the terminal 20, by means of the controller 21.

As an example of an effect of the example embodiment achieved by the above configuration, the sound volume of at least a part of the sound information transmitted and received in the second group can be controlled based on the information regarding the user of the terminal. In a non-limiting example, sound information in which the user of the terminal is interested can be output in the form of sound at a higher sound volume, thereby improving convenience.

### Modification (1)

In step S310 in the processing shown in FIG. 3-2, the controller 11 of the server 10 may determine relevance between information associated with the room A (the group in the room A) and room topic information regarding another room, in a non-limiting example.

For example, in a non-limiting example, information associated with the room A may be used as the result of the in-room voice analysis processing for the room A, and the controller 11 of the server 10 may determine the relevance between the result of the in-room voice analysis processing for the room A and the room topic information regarding another room. The controller 21 of the terminal 20A may then perform steps A310 to A330 based on the result of this determination.

In a non-limiting example, information associated with the room A may be information such as the room name (group name) of the room A and a meeting title or the like registered when an online meeting is held in the room A, and the controller 11 of the server 10 may determine relevance between these pieces of information and the room topic information regarding another room. The controller 21 of the terminal 20A may then perform steps A310 to A330 based on the result of this determination.

An upper diagram of FIG. 3-3 shows an example of a screen displayed on the terminal 20A of the user A.A participating in the room A. The voice in the meeting in the room A (in a non-limiting example, the user B.B's voice saying “I've been into houseplants lately”) is being output from the sound output device 26.

Here, the sub-region SRB of the room B is displayed in an enlarged manner compared to the sub-regions (SRC, SRD) for the other rooms (C. D), as shown in a lower diagram of FIG. 3-3, based on the word “houseplants” contained in the voice in the meeting in the room A being relevant to the word “houseplants” displayed in the sub-region SRB of the room B.

The sub-region SRB of the room B is thus highlighted based on the word associated with the topic in the room A in which the user A.A (users B.B to D.D) is participating being relevant to the word associated with the topic in the room B in which the user A.A (users B.B to D.D) is not participating, thereby enabling the users (A.A to D.D) participating in the room A to ascertain that topics relevant to the room A have come up in the room B.

In the present modification, the terminal 20 displays video information transmitted and received in a first meeting room and information indicating a second meeting room on the display 24. The terminal 20 then controls the display mode of the information indicating the second meeting room displayed on the display 24, based on the information associated with the first meeting room, by means of the controller 21.

As an example of an effect of the example embodiment achieved by the above configuration, the display mode of displayed information indicating a second group can be controlled based on information associated with a first group.

In this case, the information associated with the first meeting room may include in-room voice information regarding the first meeting room (in anon-limiting example, information based on sound information transmitted and received in a first group).

As an example of an effect of the example embodiment achieved by the above configuration, in combination with the above effect, the display mode of the information indicating the second group can be controlled based on the information based on the sound information transmitted and received in the first group. In a non-limiting example, the information indicating the second group can be displayed in a highlighted manner when, for example, content related to content discussed in the first group is discussed in the second group.

### Modification (2)

In a modification of the third example embodiment, a room member may be enabled to move to another room, or meeting rooms may be merged (integrated).

Although a description is given here of a case of merging meeting rooms in which relevant topics are being discussed, it may also be possible to merge meeting rooms (groups) based on mutual agreement therebetween regardless of whether or not their topics are relevant.

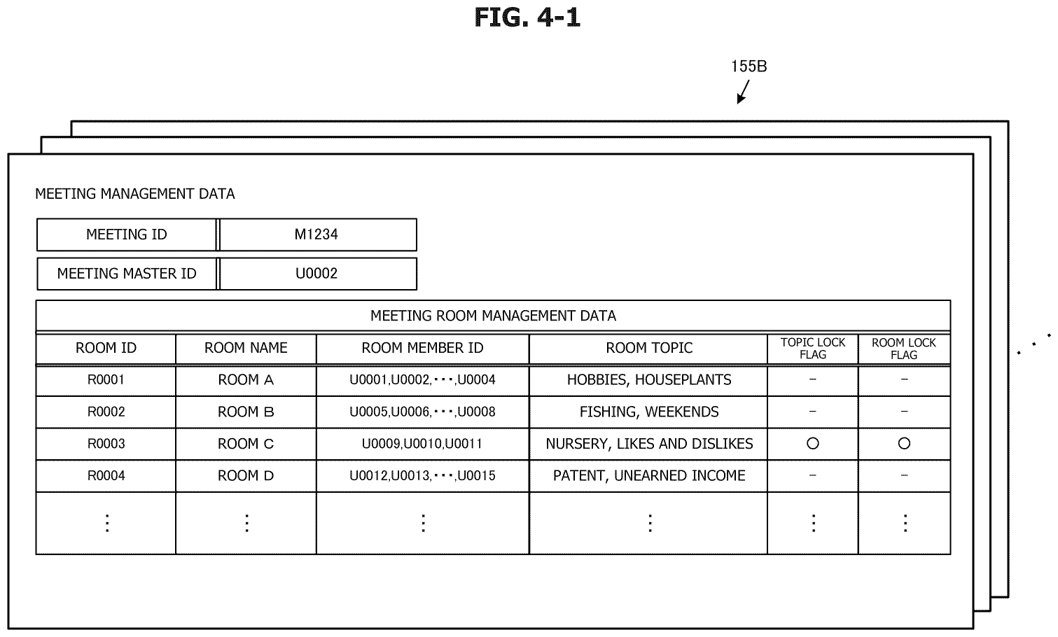

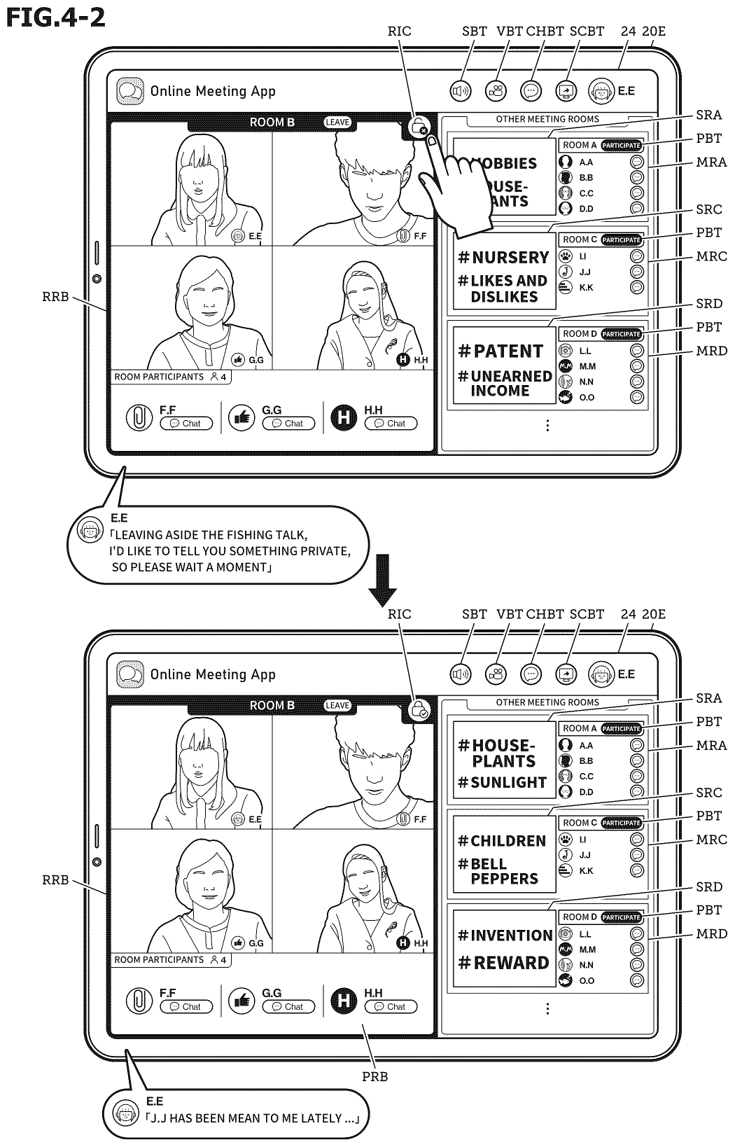

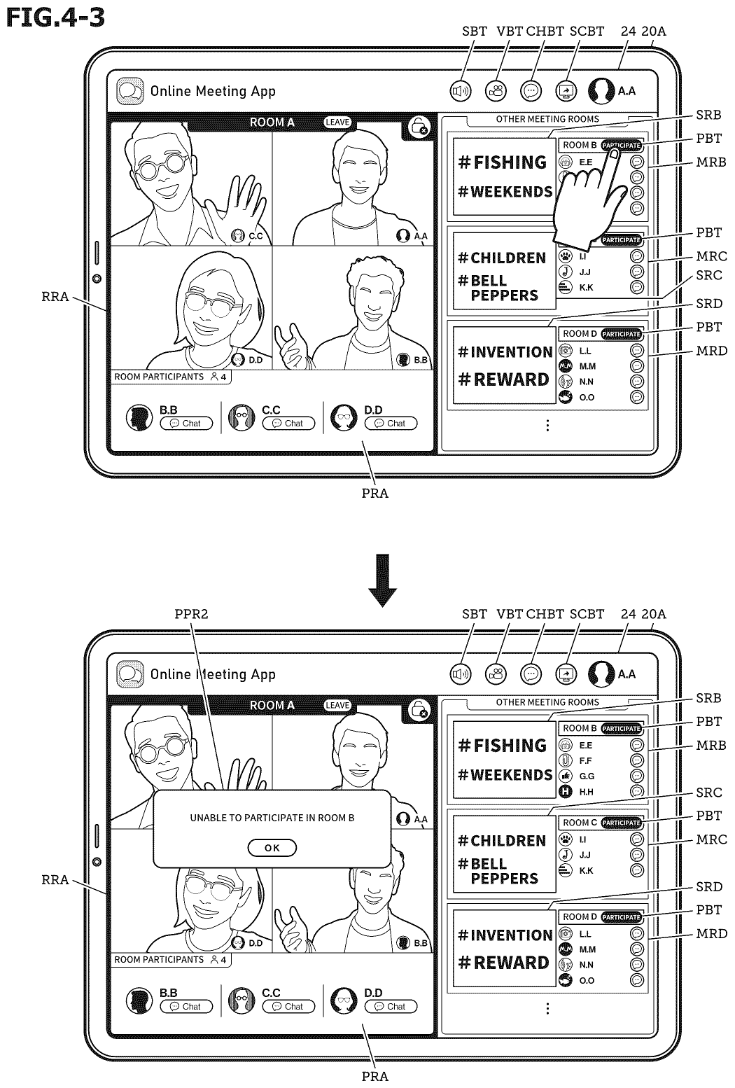

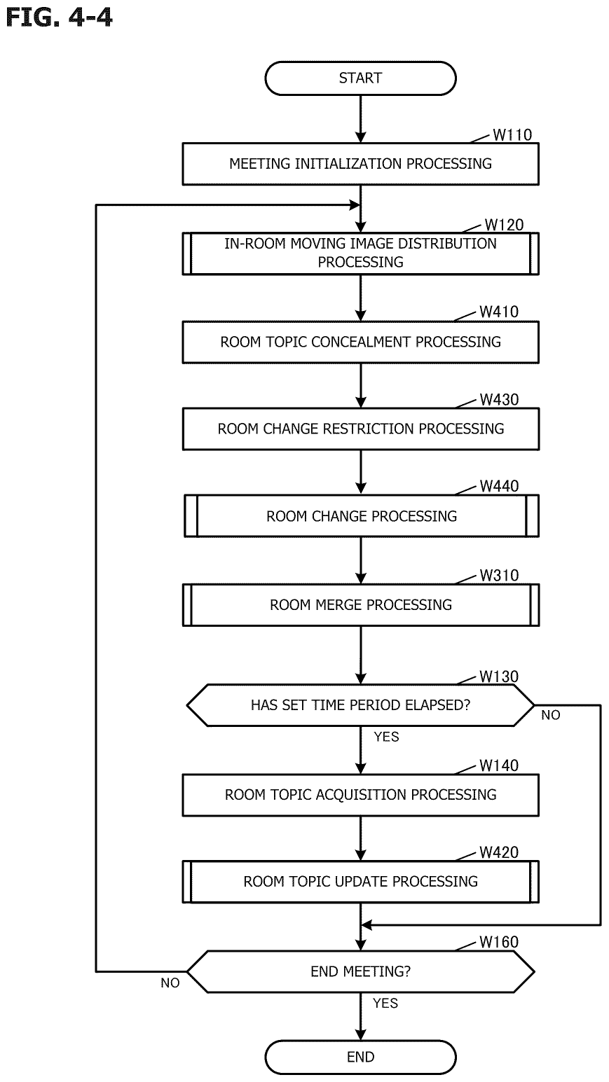

An upper diagram of FIG. 3-4 shows an example of a screen displayed on the terminal 20A of the user A.A participating in the room A.

A region PPR1 prompting the user to perform an operation is superimposed on the meeting room region RRA based on the topics in the room A and the room B being relevant to each other A message stating “Currently, we are discussing a common topic to the room B. Would you like to join the room B?”, and “No” and “Yes” buttons are displayed in the region PPR1.

If the user A.A taps the “Yes” button, the participants (E.E to H.H) in the room B are included in the participants in the room A, as shown in a lower diagram of FIG. 3-4. As a result, videos of the users A.A to H.H (a total of eight users) are displayed in the meeting room region RRA of the room A, and the icon images and the usernames of the users (B.B to H.H) other than the user A.A in the room A (as well as buttons for chat corresponding to the respective users) are displayed in the room participant region PRA.

The other-room information display region MRB corresponding to the room B is no longer displayed as information regarding “other meeting rooms”.

Note that in the example shown in FIG. 3-4, if the user A.A, who is a participant of the room A, performs an operation to merge the rooms A and B, the room B (the group including the users E.E to H.H) is merged into the room A (the group including the users A.A to D.D). However, there is no limitation to this configuration, and this operation may alternatively cause the room A to be merged into the room B, and the meeting room region RRB of the room B may be displayed, instead of the meeting room region RRA of the room A, on the terminal 20A of the user A.A.

In the example shown in FIG. 3-4, the rooms A and B are merged by an operation performed by any one of the participants (in this example, the user A.A) in the room A. However, there is no limitation to this mode, and the room A may alternatively be merged with another room as a result of more than one member (two to all of the members) out of the participants in the room A performing an operation to permit merging. Further, the room A may be merged with another room by an operation performed by a user who is set in advance as a room administrator among the participants in the room A.

Furthermore, in a non-limiting example, the rooms may also be merged if all room members in both the room A and the room B permit merging, if a majority of the room members in both the room A and the room B permits merging, if both the room administrator of the room A and the room administrator of the room B permit merging, or if a meeting master permit merging.

In a non-limiting example, a configuration may be employed in which if the user A.A is set as the room administrator of the room A, the region PPR1 for the merging operation is displayed only on the terminal 20A of the user A.A. and the region PPR1 is not displayed (or not operable even if displayed) on the terminals 20 of the other users (B.B to D.D).

FIG. 3-5 is a flowchart showing an example of a flow of processing executed in the communication system 1 according to the present modification of the third example embodiment.

After step W210, the communication system 1 performs room merge processing (W310).

FIG. 3-6 is a flowchart showing an example of a flow of the room merge processing according to the present modification of the third example embodiment.

Processing executed by the controller 21 of the terminal 20A is shown on the left side of the flowchart, and processing executed by the controller 11 of the server 10 is shown on the right side.

Note that, here, processing executed by the terminal 20A of the user A.A is shown as processing executed by the terminals 20 of a user included in the room A, but processing executed by the other room member terminals of the room A may be the same.

Further, processing executed by the terminals 20 of room members in the rooms other than the room A may also be the same.

The controller 11 of the server 10 determines whether room topic information regarding the rooms other than the room A that includes the user A.A is relevant to the result of the in-room voice analysis processing for the room A that includes the user A.A (S350).

Note that in the processing in FIG. 3-5, no room topic exists until first room topic acquisition processing is performed. In this case, the above step S350 is skipped.

If it is determined that there is relevance (S350: YES), the controller 11 of the server 10 transmits room merge check information for checking with the user whether or not to merge the meeting rooms, to the terminal 20A by means of the communication I/F 14 (S360).

The controller 21 of the terminal 20A determines whether or not the room merge check information has been received from the server 10 by means of the communication I/F 22 (A350). If it is determined that the room merge check information has been received (A350: YES), the controller 21 of the terminal 20A determines whether or not to agree to merge the rooms (A360). For example, in a non-limiting example, the received room merge check information is displayed on the display 24, and, in a non-limiting example, it is determined whether or not the user A.A has made an input to agree to merge the rooms via the input/output device 23.

If it is determined that the user A.A agrees to merge the rooms (A360: YES), the controller 21 of the terminal 20A transmits room merge request information to the server 10 by means of the communication I/F 22 (A370).

After S360, the controller 11 of the server 10 determines whether or not the room merge request information has been received from the terminal 20A by means of the communication I/F 22 (S370). If it is determined that the room merge request information has been received (S370: YES), the controller 11 determines whether or not to merge the rooms. In this processing, it may be determined, in a non-limiting example, that the rooms are to be merged based on any of the following conditions having been met:
the room merge request information has been received from the terminals 20 of a majority of the users included in the target room;
the room merge request information has been received from the terminals 20 of all of the users included in the target room; and
the room merge request information has been received from the terminal 20 of a representative included in the target room.

If it is determined that the rooms are to be merged, the controller 11 of the server 10 performs target room merge processing (S380). Here, the meeting room that is to be merged with is referred to as a “merged room”, and the meeting room that is to merge with the merged room is referred to as a “merging room”. In this case, the controller 11 of the server 10 performs any of the following processing, in a non-limiting example:
deleting a data record (data row) of the merged room in the meeting room management data deleting the merged room; and
emptying room member IDs in the data record (data row) of the merged room in the meeting room management data: making the merged room an empty room.

In this case, as an example, the rooms can be merged with the room A that includes the user A.A as the merged room and the other room as the merging room.

However, there is no limitation to the above, and the controller 11 of the server 10 may determine the merging room using any of the following rules:
determining a meeting room with a longer room topic as the merging room;
determining a meeting room with a younger room ID as the merging room; and
determining a meeting room in which room members have been staying for a longer time as the merging room.

The controller 11 of the server 10 thereafter ends the room merge processing.

In some example embodiments, after A370, the controller 21 of the terminal 20A ends the room merge processing.

### Fourth Example Embodiment

In the fourth example embodiment, it is possible to conceal (hide) room topics in a meeting room and to restrict moving to another meeting room.

Some users may talk about a room member in another room or about another room and not want others to hear the talk.

The content described in the fourth example embodiment can be applied to any other example embodiments and modifications.

Constituent elements that are the same as those already described are assigned the same reference numerals as those used for corresponding elements, and a redundant description thereof is omitted.

### Data Configuration

FIG. 4-1 is a diagram showing an example of a data configuration of a meeting management database 155B, which is an example of the meeting management database 155 according to the present example embodiment.

The meeting management database 155B is different from the above-described meeting management database 155A in the data configuration of meeting room management data in the meeting management data.

For example, in a non-limiting example, a topic lock flag and room lock flag are stored, in addition to the room IDs, the room names, the room member IDs, and the room topics, in association with each other in the meeting room management data.

The topic lock flag is a flag that is used to stop the room topics from being updated by the aforementioned room topic update processing for the room of the associated room ID, or to block or prevent the room topics in the room of the associated room ID from being displayed in the other rooms (e.g., hide the room topics). In this example, an “o” mark is stored in a data field where the flag is ON, and a “-” mark is stored in a data field where the flag is OFF.

The room lock flag is a flag that is used to prohibit entry to and exit from the room of the associated room ID. In this example, a “o” mark is stored in a data field where the flag is ON, and a “-” is stored in a data field where the flag is OFF.

Note that an additional restriction (condition) may be set for at least either the topic lock or the room lock. In anon-limiting example, any of the following may beset as a lock target(s):
all of the rooms are set as targets (here, the room of the user may optionally be included);
a set specific room is set as a target; and
a set specific user is set as a target.

The room lock flag may automatically be turned ON if the topic lock flag is turned ON.

Conversely, the topic lock flag may automatically be turned ON if the room lock flag is turned ON.

Note that the meeting room management data may also store, as room information other than the above, the amount of speech of each room member (the amount of speech of each room member ID), a link shared within the room, and an image storage location, in a non-limiting example.

### Display Screen

An upper diagram of FIG. 4-2 shows an example of a screen displayed on the terminal 20E of the user E.E participating in the room B.

The user E.E's voice saying “Leaving aside the fishing talk, I'd like to tell you something private, so please wait a moment” is being output from the sound output device 26 of the terminal 20E of the user E.E.

A lock icon RIC for restricting users in the other rooms from participating in the room B is displayed at an upper right corner of the meeting room region RRB of the room B (participants E.E to H.H).

Upon the user E.E tapping the lock icon RIC, the status of the lock icon RIC changes from a disabled state (unchecked state) to an enabled state (checked state), as shown in a lower diagram of FIG. 4-2. Users in the other rooms are prohibited from participating in the room B while the lock icon RIC is in the enabled state.

In this example, the user J.J participating in the room C, is prohibited from participating in the room B, and the user E.E can thus talk in the room B about content that the user E.E does not want the user J.J to hear (“J.J has been mean to me lately . . . ”).

Note that in the example shown in FIG. 4-2, users in the other rooms are prohibited from participating in the room B by an operation performed by one of the participants (in this example, the user E.E) in the room B. However, there is no limitation to this configuration, and participation of users in the other rooms may be prohibited by two or more (two to all) participants in the room B operating the lock icon RIC. Participation of users in the other rooms may be prohibited by an operation performed by a user who is set in advance as a room administrator among the participants in the room B.

In a non-limiting example, a configuration may be employed in which if the user E.E is set as a room administrator of the room B, the lock icon RIC is displayed only on the terminal 20E of the user E.E, and the lock icon RIC is not displayed (or not operable even if displayed) on the terminals 20 of the other users (F.F to H.H).

Targets for which participation is to be prohibited are not limited to all of the other groups, and it may be able to set whether or not participation is permitted for each group. In a non-limiting example, a configuration may be employed in which lock icons RIC corresponding to the respective rooms other than the room B are provided in the example shown in FIG. 4-2, and if only the lock icon RIC corresponding to room C is set to the enabled state, users (I.I to K.K) participating in the room C cannot participate in the room B, whereas users (A.A to D.D) participating in the room A can participate in the room B.

Whether or not each user can participate may also be settable. In a non-limiting example, a configuration may be employed in which lock icons RIC corresponding to the respective users who are not participating in the room B are provided in the example shown in FIG. 4-2, and if only the lock icon RIC corresponding to the user J.J is set to the enabled state among the users (I.I to K.K) participating in the room C, the user J.J cannot participate in the room B, whereas the users I.I and K.K can participate in the room B.

An upper diagram of FIG. 4-3 shows an example of a screen displayed on the terminal 20A of the user A.A participating in the room A.

If the user A.A wants to participate in the room B and taps the participate button PBT in the other-room information display region MRB corresponding to the room B, the user A.A cannot participate in the room B based on users in the other rooms being prohibited from participating in the room B as shown in FIG. 4-2. In this case, a message stating “Unable to participate in room B” is displayed as shown in a lower diagram of FIG. 4-3.

### Processing

FIG. 4-4 is a flowchart showing an example of a flow of processing executed in the communication system 1 according to the present example embodiment.

After step W120, the controller 11 of the server 10 performs room topic concealment processing (W410). For example, based on room topic concealment request information for making a request to conceal room topics transmitted from the terminal 20 having been received by means of the communication I/F 14, the controller 11 of the server 10 stores the “o” mark as the topic lock flag associated with the room ID of the group (meeting room) that includes the user of the terminal 20 and updates the meeting room management data, in a non-limiting example.

The controller 11 of the server 10 thereafter performs room change restriction processing (W430). For example, based on room entry/exit restriction request information transmitted from the terminal 20 for making a request to restrict entry to/exit from the meeting room having been received, the controller 11 of the server 10 stores the “o” mark as the room lock flag associated with the room ID of the group (meeting room) that includes the user of the terminal 20 and updates the meeting room management data, in a non-limiting example.

Next, the controller 11 of the server 10 performs room change processing (W440). In the room change processing, the controller 11 of the server 10 determines, for each meeting room, whether or not room change request information for making a request to move to the meeting room has been received from any terminal 20 (S201), based on the processing shown in FIG. 2-6, in a non-limiting example. If it is determined that the room change request information has been received (S201: YES), the controller 11 references the room lock flag stored in the meeting room management data corresponding to the meeting room. If the “o” mark is not stored as the room lock flag, the controller 11 updates the meeting room management data by adding, based on the received room change request information, the application ID of the terminal 20 that has made the room change request (or the user of this terminal 20) to the room member IDs in the meeting room management data corresponding to the meeting room (S203).

The controller 11 of the server 10 then advances the processing to W310.

After step W140, the controller 11 of the server 10 performs room topic update processing (W420). In the room topic update processing, the controller 11 of the server 10 references the topic lock flag stored in the meeting room management data corresponding to each meeting room in step S140 in FIG. 1-12, in anon-limiting example. If the “o” mark is not stored as the topic lock flag, the controller 11 transmits the room topic information regarding the meeting room to the terminal 20 (in the example shown in FIG. 1-12, the terminals 20A and 20B) by means of the communication I/F 14.

Note that in the room topic update processing (W420), the controller 11 of the server 10 may transmit information (in a non-limiting example, room topic flag “ON”) indicating that the room topic is locked, to a target terminal 20 for which the room topic is to be locked, before step S140 (or in step S140) in FIG. 1-12, in a non-limiting example. In a non-limiting example, a configuration may be employed in which, upon receiving the room topic information from the server 10 by means of the communication I/F 22 in FIG. 1-12, the target terminal 20 determines whether or not the information indicating that the room topic is locked has been received from the server 10, and if it is determined that the information has been received, the target terminal 20 does not perform room tag notification information generation processing (step A110/step B110 in FIG. 1-12) in order to not generate room tag notification information. As a result, the room tag notification information is not displayed on the terminal 20 (step A120/step B120 in FIG. 1-12 is not performed).

In the room merge processing (W310), the controller 11 of the server 10 may be configured to not merge a meeting room for which the room lock flag is set to “ON” (i.e. exclude this meeting room from merging target rooms).

### Effects of Fourth Example Embodiment

The present example embodiment describes a configuration in which the room topic information (a non-limiting example of first information) is not transmitted to the terminal 20 if a room member of a second meeting room has made a setting (anon-limiting example of a setting for a second group) such as turning ON the topic lock flag for the second meeting room, in a non-limiting example.

As an example of an effect of the example embodiment achieved by the above configuration, the first information can be stopped from being transmitted to the terminal if a user included in the second group has made the setting for the second group. In a non-limiting example, when a conversation that is to be concealed from a user included in a first group or from the entire first group is held within the second group, the content of the conversation can be prevented from being known to the users included in the first group or to the first group.

Further, the present example embodiment describes a configuration in which the terminal 20 performs control to set the room lock flag or the like (a non-limiting example of a setting of a user participating in a first group) based on an input made by the user of the terminal 20, such as setting the room lock flag, by means of the controller 21, in a non-limiting example.

As an example of an effect of the example embodiment achieved by the above configuration, the terminal can easily and appropriately set a user participating in the first group based on an input made to the terminal by the user of the terminal.

### Fifth Example Embodiment

In the fifth example embodiment, a user can invite a room member of another meeting room to the meeting room of the user, and the meeting rooms can be changed accordingly.

Some users may want to invite some or all of the room members in another room to the meeting room of the user to talk together.

The content described in the fifth example embodiment can be applied to any other example embodiments and modifications.

Constituent elements that are the same as those already described are assigned the same reference numerals as those used for corresponding elements, and a redundant description thereof is omitted.

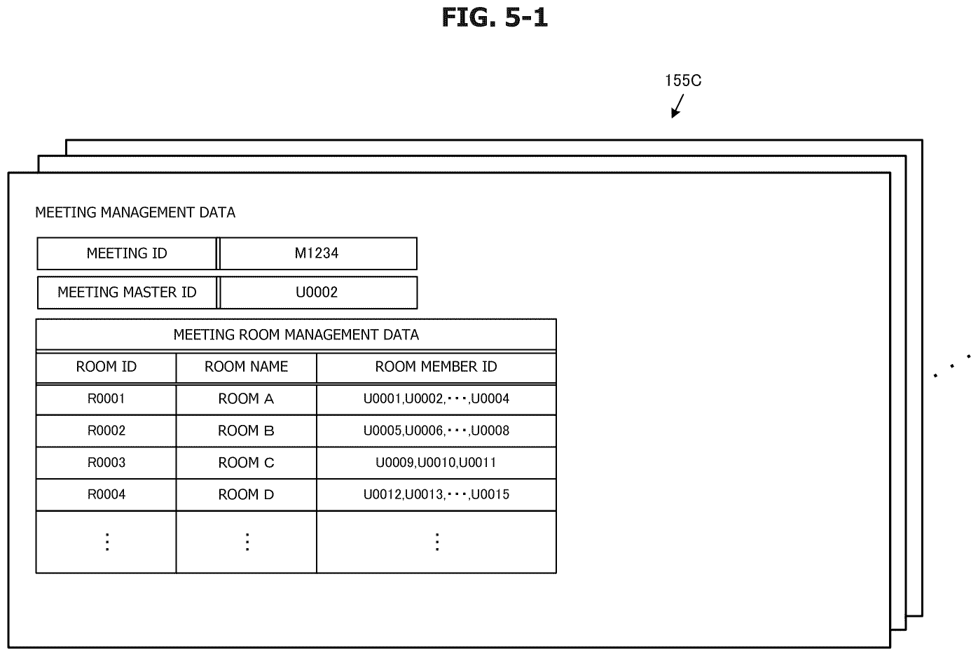

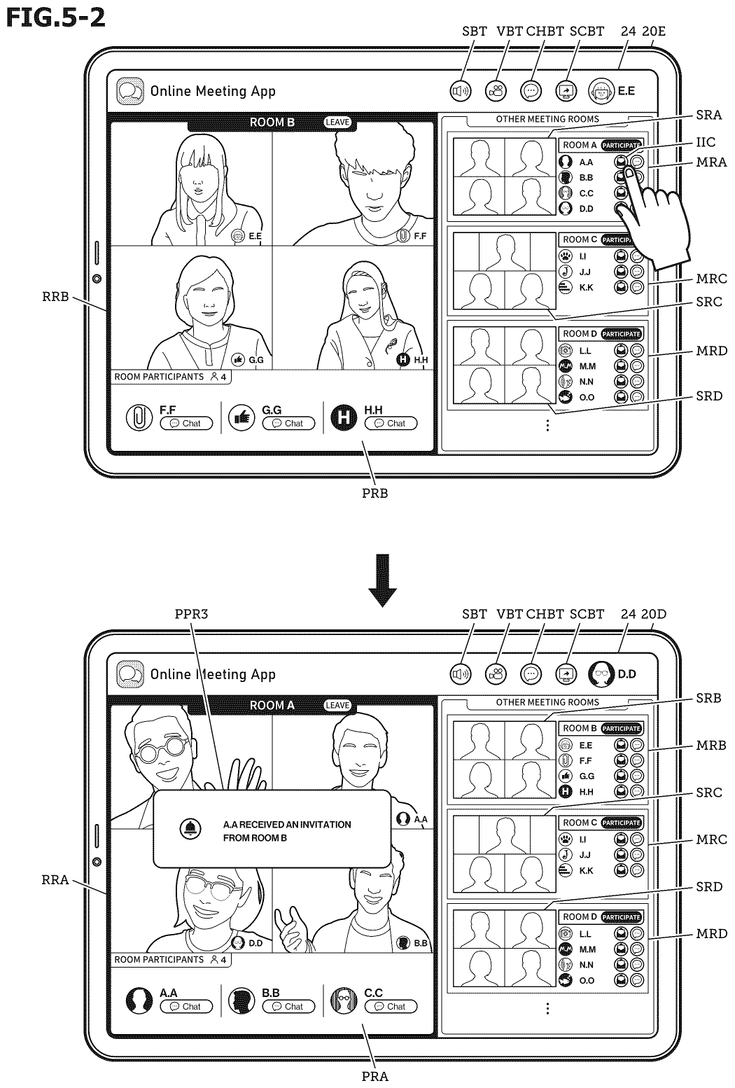

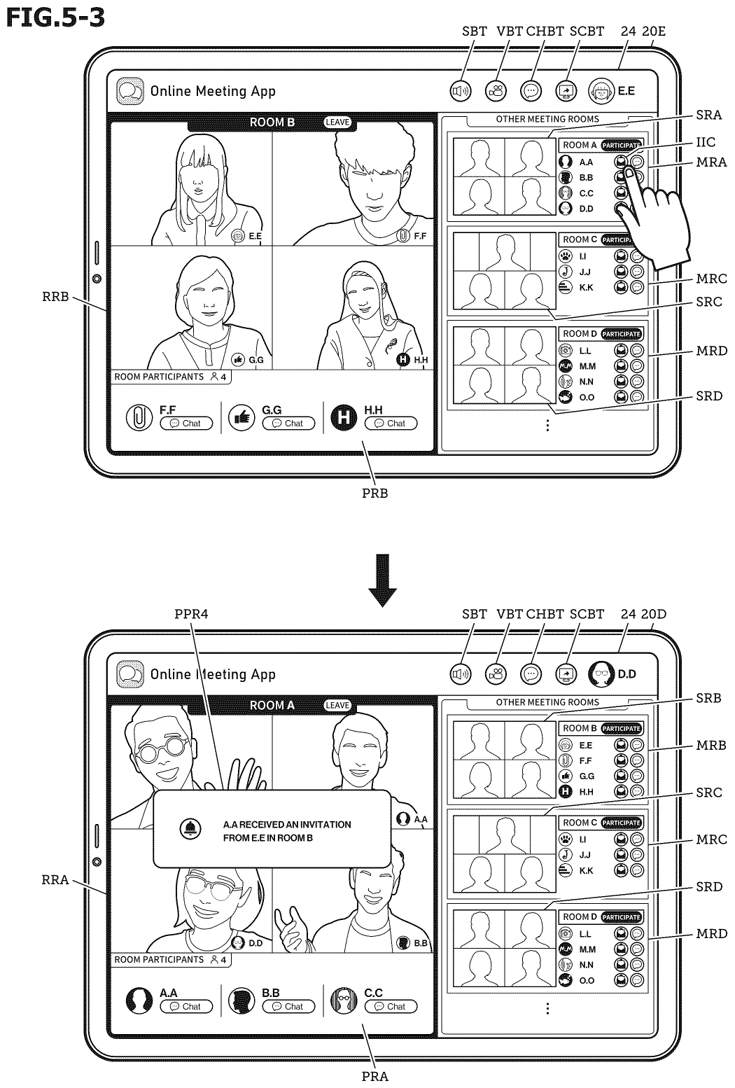

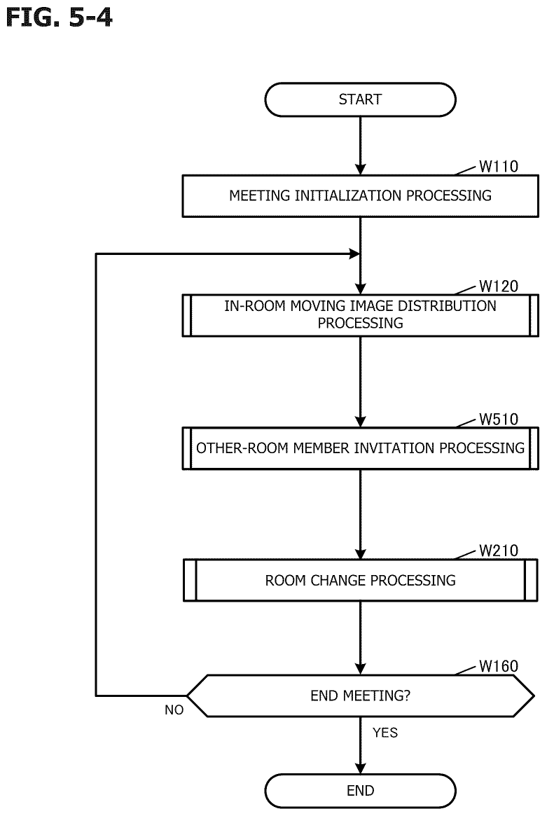

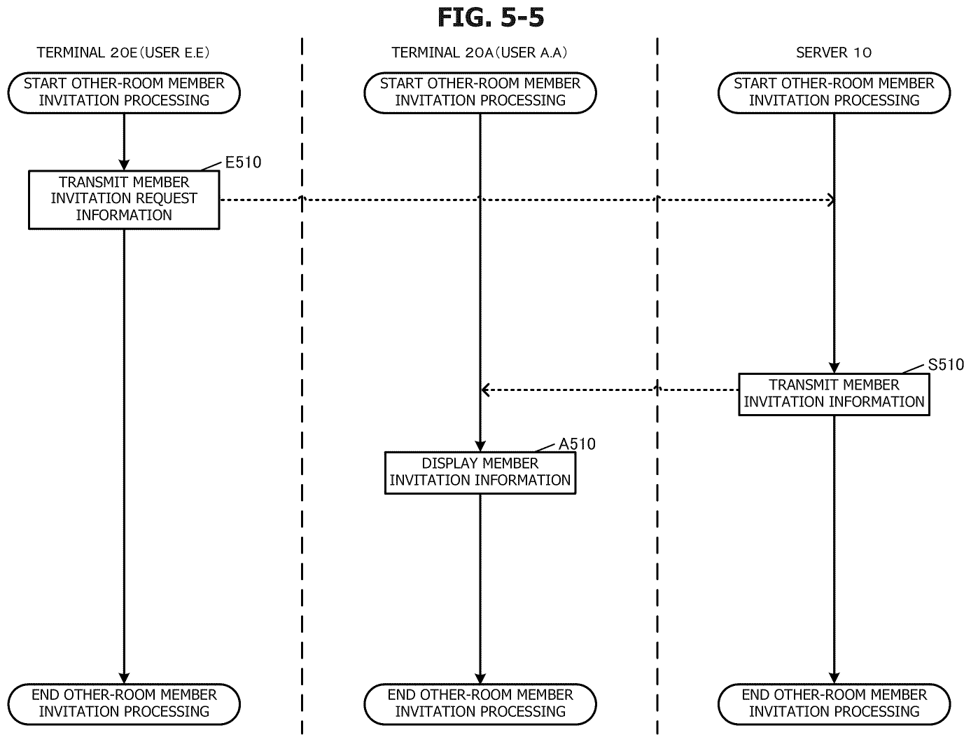

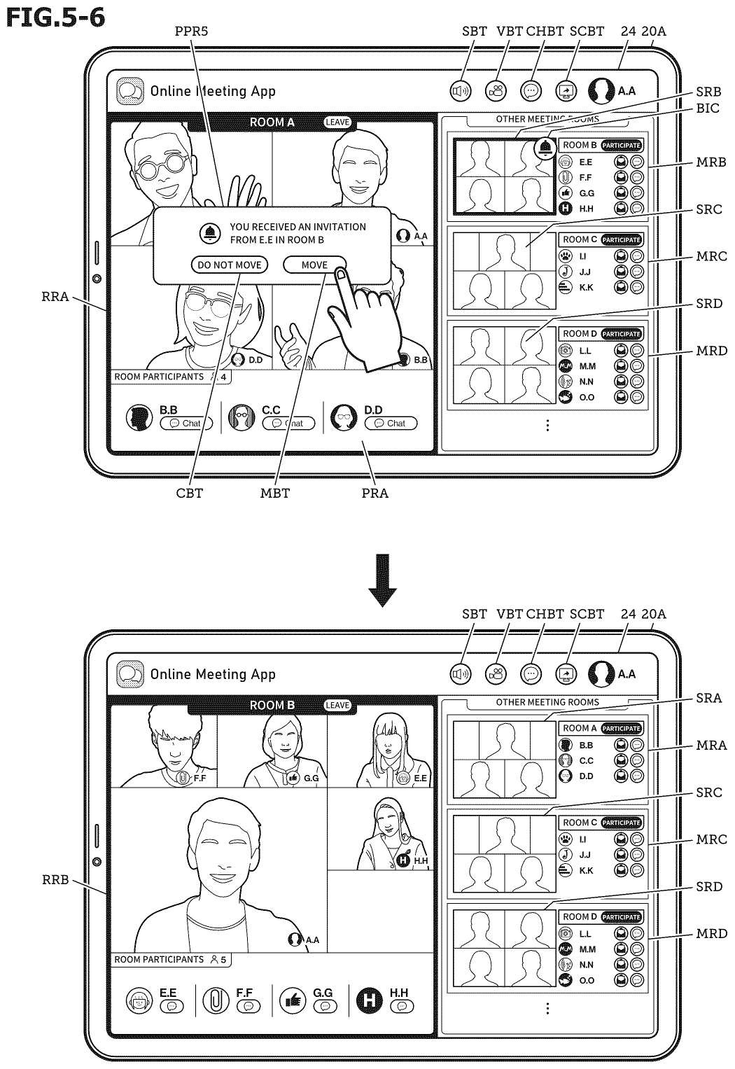

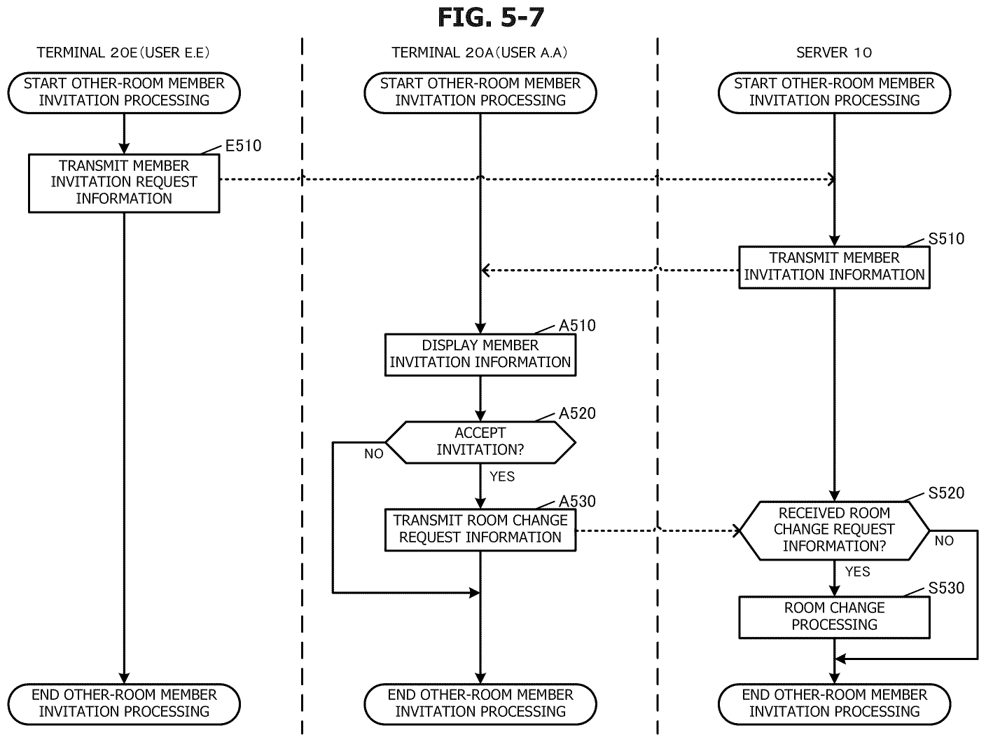

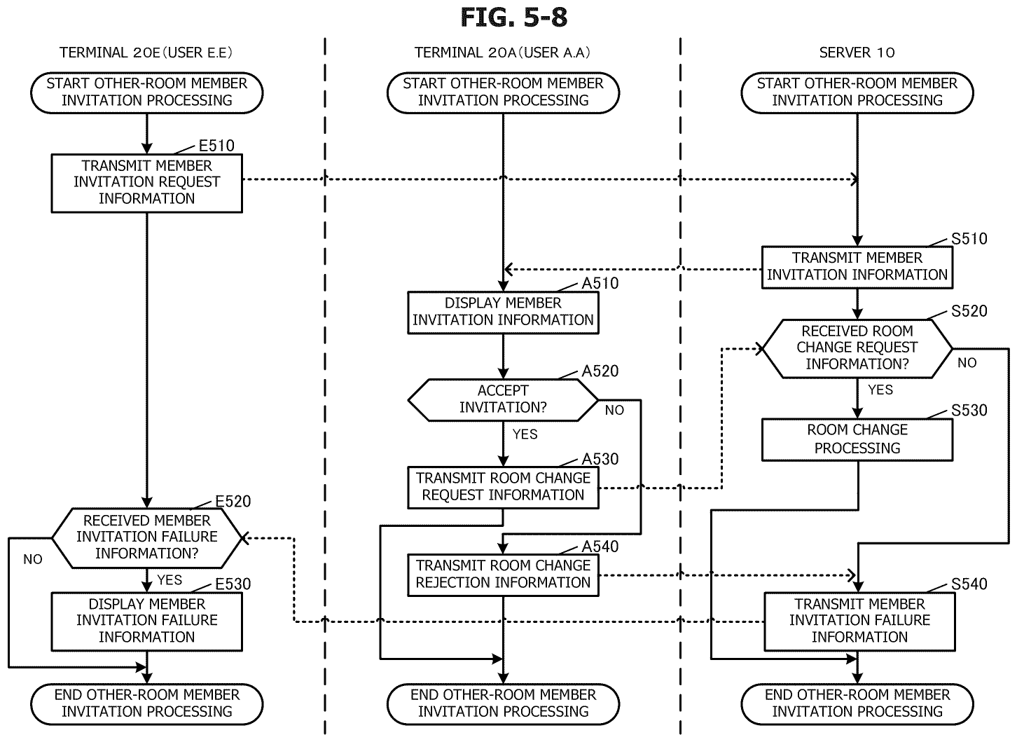

FIG. 5-1 is a diagram showing an example of a data configuration of a meeting management database 155C, which is an example of the meeting management database 155 according to the present example embodiment.

The meeting management database 155C is different from the above-described meeting management databases 155A and 155B in the data configuration of the meeting room management data in each meeting management data.

For example, the room IDs, the room names, and the room member IDs are stored in association with each other in the meeting room management data.

Note that the meeting room management data may also store, as room information other than the above, the amount of speech of each room member (the amount of speech of each room member ID), a link shared within the room, and an image storage location, in a non-limiting example. Further, the aforementioned room topics or the like may also be stored.

### Display Screen

An upper diagram of FIG. 5-2 shows an example of a screen displayed on the terminal 20E of the user E.E participating in the room B.

Information related to the room A is displayed as information regarding “other meeting rooms”, and invitation icons IIC for inviting users to the room in which the user E.E is participating are displayed in correspondence with the icons and the usernames of the respective users (A.A to D.D) participating in the room A, in the other-room information display region MRA corresponding to the room A.

Upon the user E.E tapping the invitation icon IIC corresponding to the user A.A, a message notifying that the user A.A has been invited by the room B is displayed on the terminals 20 of the users (A.A to D.D) participating in the room A, as shown in a lower diagram of FIG. 5-2.

In this example, a message stating “A.A received an invitation from room B” is displayed in a region PPR3 superimposed on the meeting room region RRA on the terminal 20D of the user D.D.

Thus, if any of the users participating in the room B invites any of the users participating in the room A, the username (user A.A) of the user who received the invitation and the room name (room B) of the room in which the inviting user (user E.E) is participating are displayed on the terminals 20 of both the invited and uninvited users, of the users participating in the room A.

In this example, the username of the inviting user is not displayed in the region PPR3, and the users (A.A to D.D) participating in the room A cannot know who in the room B invited the user A.A.

An upper diagram of FIG. 5-3 shows an example of a screen displayed on the terminal 20E of the user E.E participating in the room B. Upon the user E.E tapping the invitation icon IIC corresponding to the user A.A, a message notifying that the user A.A has been invited by the user E.E in the room B is displayed on the terminals 20 of the users (A.A to D.D) participating in the room A, as shown in a lower diagram of FIG. 5-2.

In this example, a message stating “A.A received an invitation from E.E in room B” is displayed in a region PPR4 superimposed on the meeting room region RRA on the terminal 20D of the user D.D.

In this example, the username of the inviting user (E.E) is displayed in the region PPR4, and the users (kA to D.D) participating in the room A can know who in the room B invited the user A.A.

### Processing

FIG. 5-4 is a flowchart showing an example of a flow of processing executed in the communication system 1 according to the present example embodiment.

After step W120, the communication system 1 performs other-room member invitation processing (W510).

FIG. 5-5 is a flowchart showing an example of a flow of the other-room member invitation processing. The flowchart shows processing executed by the controller 21 of the terminal 20E, processing executed by the controller 21 of the terminal 20A, and processing executed by the controller 11 of the server 10, in order from the left.

In the following, a user who invites another user is referred to as an “inviting user”, and a user who is invited is referred to an “invited user” for convenience. Here, the user E.E (a non-limiting example of a first user) included in the room B is the inviting user, and the user A.A included in the room A is the invited user, in a non-limiting example. This example describes processing in which the terminal 20E of the user E.E transmits member invitation information (a non-limiting example of information related to an invitation) to the group in the room A (all of the room member terminals in the room A).

Note that, here, only the processing executed by the terminal 20A of the user A.A is shown as processing executed by the terminal 20 of a user included in the room A, but processing executed by the terminals of the other room member terminals in the room A may be the same.

Similarly, here, processing executed by the terminal 20E of the user E.E is shown as processing executed by the terminal 20 of a user included in the room B, but processing executed by the terminals of the other room member terminals in the room B may be the same.

First, based on an input made by the user E.E via the input/output device 23, the controller 21 of the terminal 20E transmits member invitation request information, which includes the application ID of the user E.E and the application ID of the invited user (in this example, the user A.A), to the server 10 by means of the communication I/F 22 (E510). The controller 21 of the terminal 20E then ends the other-room member invitation processing.

Upon receiving the member invitation request information from the terminal 20E by means of the communication I/F 14, the controller 11 of the server 10 transmits member invitation information indicating that the invited user (in this example, the user A.A) has been invited to the room B, to the terminal 20A and the other room member terminals by means of the communication I/F 14 (S510), in a non-limiting example. The controller 11 of the server 10 then ends the other-room member invitation processing.

Upon receiving the member invitation information from the server 10 by means of the communication I/F 22, the controller 21 of the terminal 20A causes the display 24 to display the received member invitation information (A510). The controller 21 of the terminal 20A then ends the other-room member invitation processing.

Each of the other room member terminals in the room A also displays the received member invitation information on the display 24.

Note that in step A510, the controller 21 of the terminal 20A may display information regarding the inviting room (in a non-limiting example, the room name) in a highlighted manner.

The aforementioned member invitation information may also include information regarding the inviting user (in a non-limiting example, information such as the username). In this processing, information such as the username regarding the inviting user E.E may be included in the member invitation information, and the server 10 may transmit the member invitation information to the terminals 20 of the users included in the room A.

Here, processing has been described in which the user E.E (inviting user) included in the room B invites the user A.A (invited user) included in the room A, but there is no limitation to this configuration.

In a non-limiting example, the room B (the group in the room B) may invite the user A.A (invited user) included in the room A. In this case, in a non-limiting example, the terminal 20 of each user included in the room B may transmit the member invitation request information (member invitation information), or the terminal 20 of a representative user in the room B may transmit the member invitation request information (member invitation information). That is, the invitation may be requested by a user or a room (group).

The controller 11 of the server 10 may transmit the member invitation information as invitation information from the server 10 (system). In this case, the controller 11 of the server 10 may transmit the member invitation information for inviting to a room with a small number of room members or a room with a small amount of conversation (a room in which conversation is not lively), in a non-limiting example.

Member invitation information with different content may be transmitted to the terminal 20 of the invited user included in the room A and the other room member terminals in the room A.

In a non-limiting example, a configuration may be employed in which member invitation information including information regarding the inviting user is transmitted to the terminal 20 of the invited user, while member invitation information that does not include the information regarding the inviting user is transmitted to the other room member terminals.

Returning to FIG. 5-4, after step W510, the controller 11 of the server 10 advances the processing to step W210.

Note that in the above processing, the terminal 20 that receives the member invitation information notifies the user that the user has been invited by display the member invitation information on the display 24, but there is no limitation to this configuration. The terminal 20 that has received the member invitation information may notify the user by outputting the member invitation information in the form of sound from the sound output device 26, for example. That is, the notification is not limited to being realized by display but may also be realized by sound output.

In a non-limiting example, the storage 28 of the terminal 20 may store information regarding each room (group) (in a non-limiting example, information regarding a group configuration of each group (including information regarding room members etc.)). The terminals 20 may directly transmit and receive the member invitation information therebetween, not via the server 10. This may apply to the following example embodiments and modifications.

### Effects of Fifth Example Embodiment

In the present example embodiment, the terminal 20A, which outputs the moving image information (a non-limiting example of sound information and video information) transmitted and received in a first meeting room, receives information (a non-limiting example of information related to an invitation to a second group that is given to a user of a terminal) such as member invitation information for the user A.A that is transmitted to the first meeting room, by means of the communication I/F 22. The terminal 20A is configured to perform control to give notification of the member invitation information (or control to give notification based on member invitation information), by means of the controller 21.

As an example of an effect of the example embodiment achieved by the above configuration, the terminal can notify the user of the terminal that the user has been invited to the second group by notifying the user of the information related to the invitation transmitted to the first group. Because the information related to the invitation is transmitted to the first group, it is possible to notify the other users included in the first group that the user of the terminal has been invited to the second group.

In this case, the member invitation information may be transmitted from a room member in a second meeting room (a non-limiting example of a first user) to the first meeting room, or from the second meeting room to the first meeting room.

As an example of an effect of the example embodiment achieved by the above configuration, the information related to the invitation can be transmitted from the first user included in the second group to the first group, or from the second group to the first group.

In this case, in a non-limiting example, the member invitation information may be notified by being displayed on the display 24 of the terminal 20A.

As an example of an effect of the example embodiment achieved by the above configuration, the information related to the invitation being displayed on the display of the terminal makes it possible to notify the user of the terminal that the user has been invited to the second group.

In the present example embodiment, the server 10, which relays moving image information (a non-limiting example of video information and sound information) transmitted and received in a first meeting room and relays moving image information (a non-limiting example of video information and sound information) transmitted and received in a second meeting room different from the first meeting room, includes a communication I/F 14, which receives information (a non-limiting example of information related to an invitation) transmitted by a terminal 20 (a non-limiting example of a second terminal) of a room member (a non-limiting example of a second user) of the second meeting room, such as member invitation information for inviting a room member (a non-limiting example of a first user) of the first meeting room to the second meeting room, and a controller 11 that performs control to transmit information such as received member invitation information to terminals 20 in the first meeting room by means of the communication I/F 14.

As an example of an effect of the example embodiment achieved by the above configuration, the server can invite the first user to the second group by receiving information related to an invitation to the second group given to the first user included in the first group that has been transmitted by the second terminal of the second user included in the second group and thereafter performing control to transmit the received information related to the invitation to the terminals included in the first group. Transmitting the information related to the invitation to the terminals included in the first group makes it possible to notify the other users included in the first group that the first user has been invited to the second group.

### Modification (1)

The above example embodiment may have a configuration in which it is checked whether the invited user accepts the invitation, and if it is checked that the invited user accepts the invitation, the invited user can be moved to the inviting room.

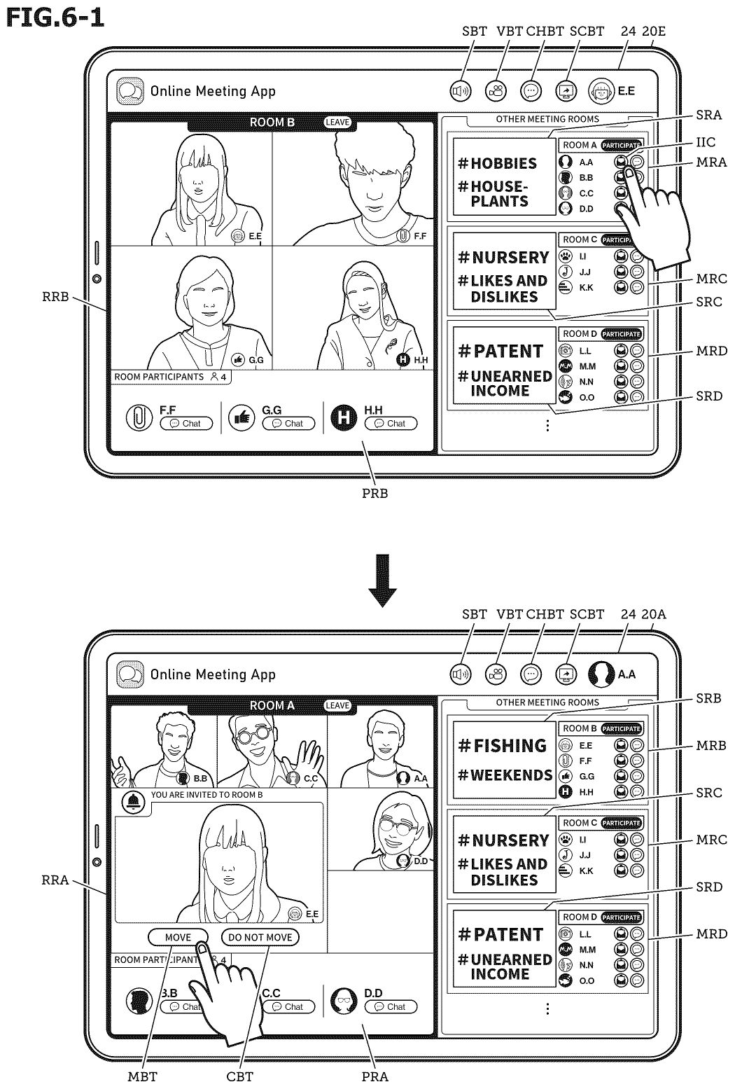

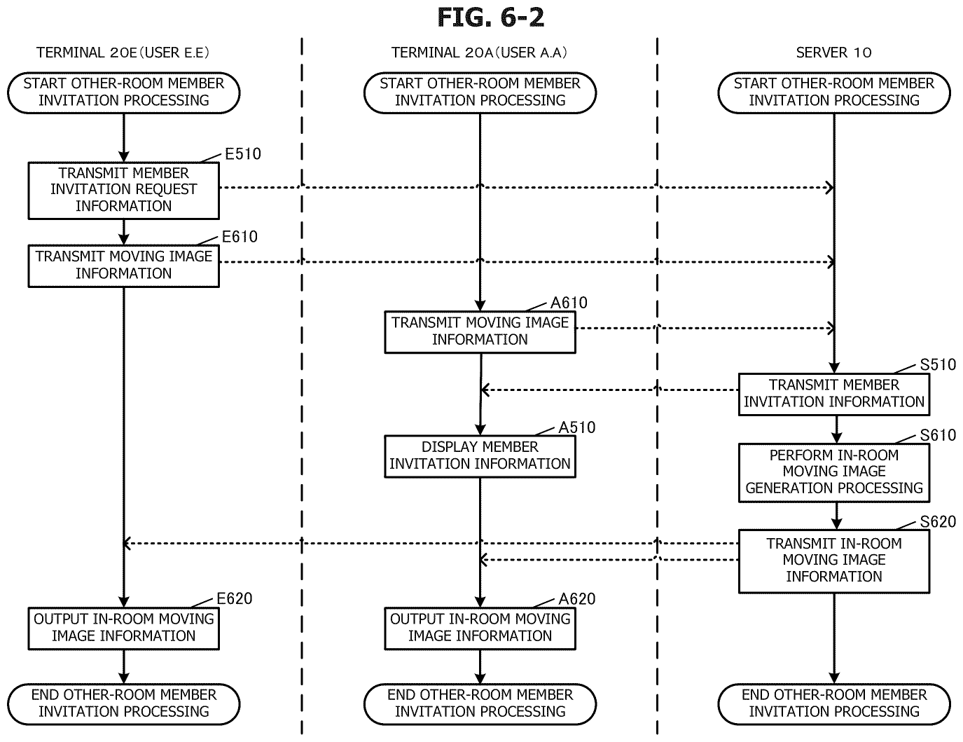

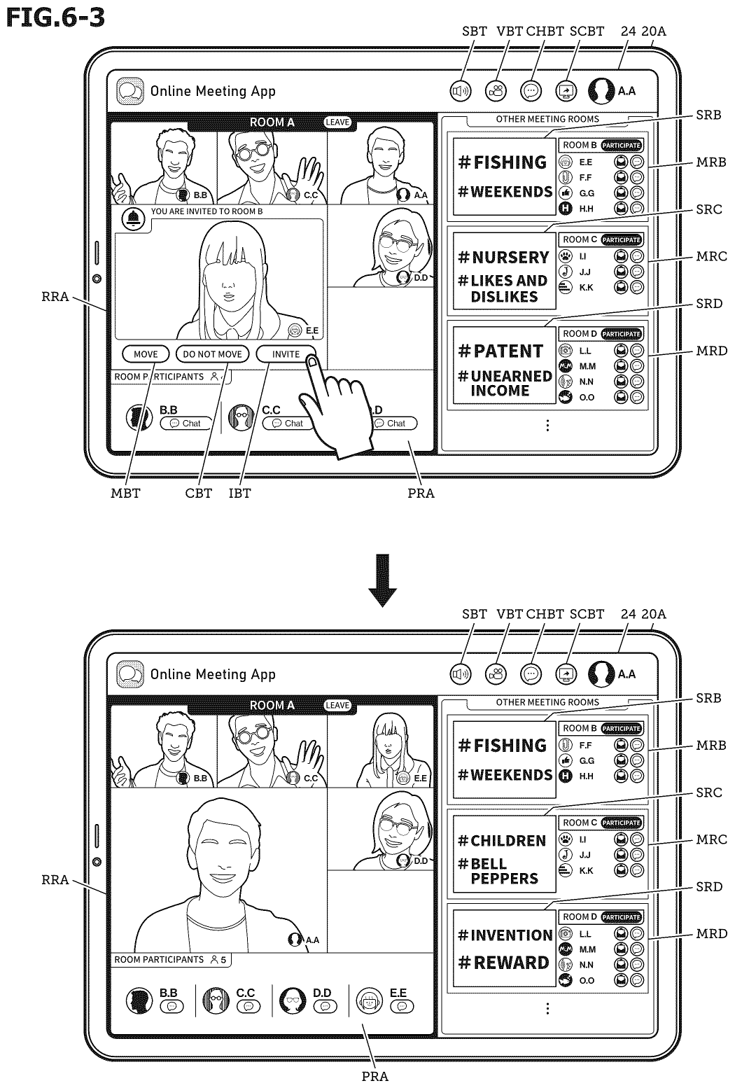

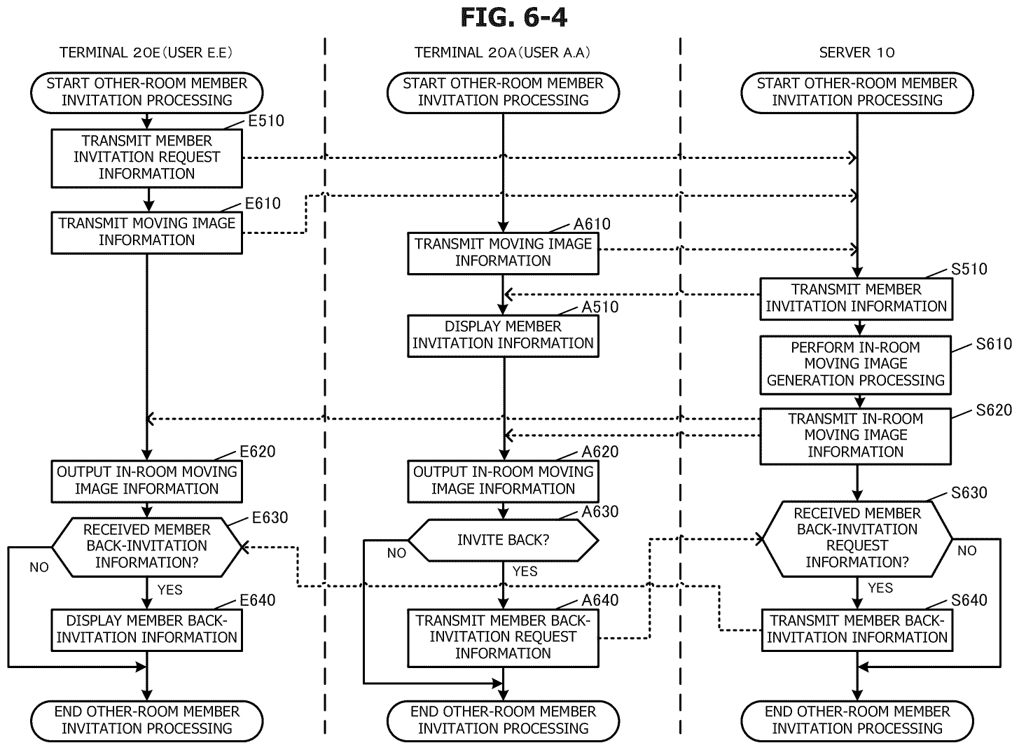

An upper diagram of FIG. 5-6 shows an example of a screen displayed on the terminal 20A of the user A.A participating in the room A. Based on the user A.A having been invited by the user E.E in the room B (see FIG. 5-3), a cancel button CBT including text “Do not move” and a move button MBT including text “Move” are displayed together with a message stating “Received an invitation from E.E in room B” in a region PPR5 superimposed on the meeting room region RRA.

The cancel button CBT is a button to be operated to reject participation in the inviting room, and the move button MBT is a button to be operated to accept participation in the inviting room.

A display frame of the sub-region SRB displaying videos of the participants (E.E to H.H) in the room B is highlighted, thereby allowing the invited user A.A to ascertain the users participating in the inviting room.

Note that even if the terminals 20 of the uninvited users (B.B to D.D) in the room A are configured to not display the username (E.E) of the inviting user as shown in FIG. 5-2, the terminal 20A of the invited user (A.A) may be configured to display the username (E.E) of the inviting user as shown in FIG. 5-6.

If the terminals 20 of the uninvited users (B.B to D.D) in the room A are configured to not display the username (E.E) of the inviting user as shown in FIG. 5-2, the terminal 20A of the invited user (A.A) may also be configured to not display the username (E.E) of the inviting user.

If the user A.A taps the move button MBT, the user A.A moves from the room A to the room B as shown in a lower diagram of FIG. 5-6.

On the terminal 20A of the user A.A, the meeting room region RRB of the room B where the number of participants is now five (A.A and E.E to H.H) is displayed instead of the meeting room region RRA of the room A. and information regarding the room A where the user A.A is no longer participating and the number of participants is now three (B.B to D.D) is displayed as information regarding “other meeting rooms”.

Note that the user A.A does not move to the room B if the user A.A taps the cancel button CBT rather than the move button MBT in the region PPR5 in the upper diagram of FIG. 5-6. In this case, the region PPR5 displayed in a pop-up window disappears as a result of tapping the cancel button CBT.

Note that a field for inputting a message to be transmitted to the inviting room (room B) may be provided in the region PPR5 such that the invited user (A.A) can transmit a message indicating that the user A.A will participate or not participate to the participants (E.E to H.H) in the inviting room (room B).

Further, a field for inputting a message to be transmitted to the room (room A) in which the user A.A is currently participating may be provided in the region PPR5 such that the invited user (A.A) can transmit a message indicating that the user A.A will participate or not participate in another room to the participants (B.B to D.D) in the current room (room A).

When the user A.A in the example shown in FIG. 5-6 has moved to the room B, the terminals 20 of the users (users B.B to D.D) remaining in the room A may be configured to display a message indicating that the user A.A has moved to the room B. This message may be displayed after a set time period (in a non-limiting example, 10 minutes) has elapsed since the user A.A moved to the room B.

FIG. 5-7 is a flowchart showing an example of a flow of the other-room member invitation processing according to the present modification. This flowchart is to be read in the same manner as FIG. 1-11.

After step A510, the controller 21 of the terminal 20A determines whether or not to accept the invitation (A520) by, for example, determining whether or not a user input for accepting the invitation has been made via the input/output device 23, based on the member invitation information displayed on the display 24 in A510. If it is determined that the invitation is not to be accepted (A520: NO), the controller 21 of the terminal 20A ends the other-room member invitation processing. Note that in this case, in step S510, the controller 11 of the server 10 can transmit member invitation information including a message and a move button (information for displaying a move button) that are used to participate in the inviting meeting room such as those shown in FIG. 5-6, in a non-limiting example. The controller 21 of the terminal 20A can then determine that the invitation is to be accepted based on, for example, a message received by the user A.A or an operation of the move button performed by the user A.A.

If it is determined that the invitation is to be accepted (A520: YES), the controller 21 of the terminal 20A transmits room change request information to the server 10 by means of the communication I/F 22 (A530), the controller 21 of the terminal 20A then ends the other-room member invitation processing.

After S510, the controller 11 of the server 10 determines whether or not the room change request information has been received by means of the communication I/F 14 (S520). If it is determined that the room change request information has not been received (S520: NO), the controller 11 ends the other-room member invitation processing.

If it is determined that the room change request information has been received (S520: YES), the controller 11 of the server 10 performs room change processing (S530). The room change processing is as described above. The controller 11 of the server 10 then ends the other-room member invitation processing.

Note that in step A510, when the controller 21 of the terminal 20A displays the member invitation information, the controller 21 may perform control such that information indicating a second group that includes the inviting user (in a non-limiting example, information such as the room name of the second group) is displayed in a display mode different from that of information indicating the other groups (in a non-limiting example, information such as the room name of the other rooms).

In the above processing, if a set time period has elapsed since the controller 21 of the terminal 20A received the member invitation information or displayed the member invitation information in step A510, the controller 21 may perform step A530 without performing step A520, in a non-limiting example.

In some example embodiments, in the above processing, if a set time has arrived after the controller 21 of the terminal 20A received the member invitation information or displayed the member invitation information in step A510, the controller 21 may perform step A530 without performing step A520, in a non-limiting example.

In the above processing, if a set time period has elapsed since the controller 11 of the server 10 received the member invitation request information from the terminal 20E or transmitted the member invitation information in step S510, the controller 11 may perform step S530 without performing step S520, in a non-limiting example.

In some example embodiments, in the above processing, if a set time has arrived after the controller 11 of the server 10 received the member invitation request information from the terminal 20E or transmitted the member invitation information in step S510, the controller 11 may perform step S530 without performing step S520, in a non-limiting example.

In the present modification, in a non-limiting example, the member invitation information (a non-limiting example of information related to an invitation) includes information for accepting the invitation (a non-limiting example of first information for participating in a second group). The terminal 20 of the invited user performs, by means of the controller 21, processing such as transmitting room change request information (a non-limiting example of processing related to participating in a second group) based on an input to the information for accepting the invitation made by the invited user.

As an example of an effect of the example embodiment achieved by the above configuration, the user of the terminal can be allowed to participate in the second group based on an input to the first information for participating in the second group made by the user of the terminal.

In this case, the terminal 20 of the invited user displays information indicating a second meeting room and information indicating a third meeting room on the display 24. The terminal 20 of the invited user may then perform control to change the display mode of the information indicating the second meeting room based on the reception of the member invitation information, by means of the controller 21.

As an example of an effect of the example embodiment achieved by the above configuration, the invited group (second group) can be displayed while being distinguished from the other groups (third group) by performing control to change the display mode of the information indicating the second group based on the reception of the information related to the invitation, thus making it easier for the user to recognize the inviting group.

In this case, the member invitation information (a non-limiting example of information related to an invitation) may be transmitted to a first meeting room from one inviting user (a non-limiting example of a first user) included in a second meeting room, and the terminal 20 of the invited user may display the information regarding the inviting user included in the member invitation information on the display 24, in a non-limiting example.

As an example of an effect of the example embodiment achieved by the above configuration, the terminal of the user can be notified of information regarding the first user included in the second group who has transmitted the information related to the invitation to the first group.

In this case, if a set time period has elapsed since, or a set time has arrived after the member invitation information was notified to the terminal 20, the terminal 20 of the invited user may perform, by means of the controller 21, control such as transmitting room change request information (a non-limiting example of control related to participating in a second group).

As an example of an effect of the example embodiment achieved by the above configuration, the user of the terminal can be automatically made to participate in the second group if a certain time period has elapsed since, or a specific time has arrived after the information related to the invitation was notified.

### Modification (2)

If the invitation is not accepted, information indicating that the invitation was not accepted may be transmitted to the terminal 20 that has made the invitation request to notify the user that the invitation was not accepted.

FIG. 5-8 is a flowchart showing an example of a flow of the other-room member invitation processing according to the present modification. This flowchart is to be read in the same manner as FIG. 5-7.

If it is determined in A520 that the invitation is not to be accepted (A520: NO), the controller 21 of the terminal 20A transmits room change rejection information indicating that the user rejects room change to the server 10 by means of the communication I/F 22 (A540). The controller 21 of the terminal 20A then ends the other-room member invitation processing.

Note that the room change rejection information may include a message input by the user A.A (in a non-limiting example, a message etc. indicating a reason for rejection).

If the room change request information is not received in S520 (S520: NO), the controller 11 of the server 10 transmits member invitation failure information indicating that the member invitation has failed to the terminal 20E by means of the communication I/F 14 (S540). The controller 11 of the server 10 then ends the other-room member invitation processing.

After E510, the controller 21 of the terminal 20E determines whether or not the member invitation failure information has been received from the server 10 by means of the communication I/F 22 (E520). If it is determined that the member invitation failure information has not been received (E520: NO), the controller 21 ends the other-room member invitation processing.

If it is determined that the member invitation failure information has been received (E520: YES), the controller 21 of the terminal 20E causes the display 24 to display the received member invitation failure information (E530). The controller 21 of the terminal 20E then ends the other-room member invitation processing.

In the present modification, the member invitation information (a non-limiting example of information related to an invitation) is notified by being displayed on the display 24 of the invited user, in a non-limiting example. The terminal 20 of the invited user then performs, by means of the controller 21, control to transmit the room change rejection information/member invitation failure information (a non-limiting example of information related to declining an invitation) to the inviting user who transmitted the member invitation information, based on an input to the member invitation information.

As an example of an effect of the example embodiment achieved by the above configuration, the inviting user who has transmitted the information related to an invitation can be notified that the invitation is to be declined based on the input to the information related to the invitation.

### Modification (3)

The fifth modifications (1) and (2) are examples in which a user who has been invited from another meeting room can choose whether or not to participate in the other meeting room. However, there is no limitation to this configuration.

In a non-limiting example, a configuration may be employed in which the user A.A in FIG. 5-6 who has been invited from another room, namely the room B, cannot choose whether or not to participate in the room B, and is forced to participate in the room B. In this case, the region PPR5 in FIG. 5-6 may only display a message indicating that the invited user A.A will participate in the room B, and the screen may transition to the lower diagram of FIG. 5-6 after a set time period (in a non-limiting example, five seconds), in a non-limiting example.

In this case, when the user A.A in the example shown in FIG. 5-6 has moved to the room B, the terminals 20 of the users (users B.B to D.D) remaining in the room A may be configured to display a message indicating that the user A.A has moved to the room B. This message may be displayed after a set time period (in a non-limiting example, 10 minutes) has elapsed since the user A.A moved to the room B.

### Modification (4)

In the above example embodiment, the member invitation information (a non-limiting example of information related to an invitation) is transmitted to a first meeting room such that the users who are included in the first meeting room and is not the invited user are informed that the invited user has been invited to a second meeting room, in a non-limiting example. However, there is no limitation to this configuration.

For example, the member invitation information may be transmitted only to the terminal 20 of the invited user who is included in the first meeting room.

More For example, in the processing example described in the above example embodiment, the member invitation information may be transmitted only to the terminal 20A of the user A.A, who is the invited user, in a non-limiting example.

That is, in the above example embodiment, the terminal 20A, which outputs moving image information (a non-limiting example of sound information and video information) transmitted and received in a first meeting room, receives information transmitted to the user A (a non-limiting example of information related to an invitation to a second group given to a user of a terminal) such as member invitation information for the user A.A, by means of the communication I/F 22. The terminal 20A may then perform, by means of the controller 21, control to give notification of the member invitation information (or control to give notification based on the member invitation information).

As an example of an effect of the example embodiment achieved by the above configuration, the user of the terminal can be notified that the user has been invited to the second group by notifying the user of the terminal of the information related to the invitation transmitted to the user. Further, in anon-limiting example, it is possible to conceal the user of the terminal being invited to the second group from the other users included in the first group by transmitting the information related to the invitation only to the user of the terminal and giving notification only on the terminal.

In the above example embodiment, server 10, which relays moving image information (a non-limiting example of video information and sound information) transmitted and received in a first meeting room and relays moving image information (a non-limiting example of video information and sound information) transmitted in a second meeting room, may include: a communication I/F 14, which receives information (a non-limiting example of information related to an invitation) transmitted by a terminal 20 (a non-limiting example of a second terminal) of a user (a non-limiting example of a second user) included in the second group, such as member invitation information for inviting a user (a non-limiting example of a first user) included in the first group to the second group; and a controller 11 that performs control to transmit information such as received member invitation information to the terminal 20 of the first user by means of the communication I/F 14.

As an example of an effect of the example embodiment achieved by the above configuration, the server can invite the first user to the second group by receiving the information related to the invitation to the second group given to the first user included in the first group that has been transmitted by the second terminal of the second user included in the second group and thereafter performing control to transmit the received information related to the invitation to the first user. Further, in a non-limiting example, transmitting the information related to the invitation only to the terminal of the first user makes it possible to conceal the first user being invited to the second group from the other users included in the first group.

### Sixth Example Embodiment

In the sixth example embodiment, in a non-limiting example, moving image information transmitted by an inviting user (the terminal 20 of the inviting user) can be output on the terminal 20 of an invited user in the fifth example embodiment and the fifth modifications.

The content described in the sixth example embodiment can be applied to any other example embodiments and modifications.

Constituent elements that are the same as those already described are assigned the same reference numerals as those used for corresponding elements, and a redundant description thereof is omitted.

### Display Screen

An upper diagram of FIG. 6-1 shows an example of a screen displayed on the terminal 20E of the user E.E participating in the room B. Upon the user E.E tapping the invitation icon IIC corresponding to the user A.A participating in the room A, a video, the icon image, and the username of the user E.E who has invited the user A.A are displayed in a part of the meeting room region RRA on the terminal 20A of the invited user A.A, among the users (the users A.A to D.D) participating in the room A, as shown in a lower diagram of FIG. 6-1.

Further, a message (“You are invited to room B”) notifying the user A.A that the user A.A has been invited to the room B, as well as the cancel button CBT and the move button MBT related to participation in the room B are displayed in correspondence with the video of the user E.E. In this example, the videos of the users (users A.A to D.D) participating in the room A are reduced in size as a result of the video and the like of the user E.E being added to the meeting room region RRA.

The video of the user E.E displayed in the meeting room region RRA may be the video of the user E.E displayed in the meeting room region RRB on the terminals 20 of the users (users E.E to H.H) participating in the room B.

Note that in this example, the displayed video of the user E.E is larger than the video of each of the users (users A.A to D.D) participating in the room A, but there is no limitation to this configuration.

Conversely, the displayed video of the user E.E may be smaller than the video of each of the users (users A.A to D.D) participating in the room A.

Thus, it is possible to provide the user A.A with a UI that makes the user A.A feel as if the user E.E came out of the room B to invite the user A.A by displaying, in the meeting room region RRA of the room A, the video of the user E.E who is participating in the room B and inviting the user A.A.

Note that in this case, either of the following methods may be applied:
(A) the meeting room in which the user E.E is participating temporarily switches to the room A in order for the user E.E to invite the user A.A; or
(B) the user E.E does not move from the room B to invite the user A.A, but only video information regarding the user E.E is displayed in the room A.

In the case of (A), in a non-limiting example, the controller 11 of the server 10 may, through the aforementioned room change processing, temporarily delete the application ID of the user E.E from the room B and store this application ID in the room A, and then delete the application ID of the user E.E from the room A and store this application ID in the room B based on the user A.A tapping the move button MBT or the cancel button CBT.

Note that in this case, the application ID of the user E.E is stored in the room A, but need not be deleted from the room B. The user E.E may thus be enabled to temporarily change the room by performing such processing.

In the case of (B), in a non-limiting example, the controller 11 of the server 10 may be configured to not delete the application ID of the user E.E from the room B or store the application ID of the user E.E in the room A, but to transmit video information regarding the user E.E to the room A.

Note that the video and the like of the user E.E (excluding the cancel button CBT and the move button MBT) may also be added to the meeting room region RRA on the terminals 20 of uninvited users (users B.B to D.D) among the users in the room A in the same manner as the invited user A.A.

Further, a configuration may also be employed in which, during a time period when the video and the like of the user E.E are added to the meeting room region RRA, i.e. during a time period when the user E.E in the room B is inviting the user A.A in the room A, the video of the user E.E is not displayed in the meeting room region RRB on the terminals 20 of the users (users E.E to H.H) participating in the room B. and the icon image and the username of the E.E are not displayed in the other-room information display region MRB corresponding to the room B on the terminals 20 of the users (users A.A to D.D) participating in the room A.

This configuration ensures the uniqueness of each user on the application.

Upon the user A.A tapping the move button MBT corresponding to the video of the user E.E, the user A.A participates in the room B, and the screen displayed on the terminal 20A of the user A.A switches to a screen shown in a lower diagram of FIG. 5-6. Meanwhile, the video of the user A.A and the video and the like of the user E.E are no longer displayed in the meeting room region RRA on the terminals 20 of the users (users B.B to D.D) remaining in the room A.

### Processing

FIG. 6-2 is a flowchart showing an example of a flow of the other-room member invitation processing according to the present example embodiment.

After E510, the controller 21 of the terminal 20E transmits moving image information to the server 10 by means of the communication I/F 22, in a non-limiting example (E610). In a non-limiting example, the moving image information may be information regarding a moving image of the user E.E.

Similarly, the controller 21 of the terminal 20A transmits moving image information to the server 10 by means of the communication I/F 22 (A610). The moving image information may be information regarding a moving image of the meeting room of the room A.

Upon receiving the moving image information from the aforementioned terminals 20, the controller 11 of the server 10 performs step S510. The controller 11 of the server 10 then performs in-room moving image generation processing (S610). For example, in this processing example, moving image information obtained by including the moving image information received from the terminal 20E in the moving image information received from the terminal 20A is generated as in-room moving image information.

Next, the controller 11 of the server 10 transmits the generated in-room moving image information to the terminals 20E and 20A by means of the communication I/F 14 (S620). The controller 11 of the server 10 then ends the other-room member invitation processing.

Upon receiving the in-room moving image information from the server 10 by means of the communication I/F 22, the controller 21 of the terminal 20E causes the display 24 to display the received in-room moving image information (E620). The controller 21 of the terminal 20E then ends the other-room member invitation processing.

Similarly, upon receiving the in-room moving image information from the server 10 by means of the communication I/F 22, the controller 21 of the terminal 20A causes the display 24 to display the in-room moving image information (A620). The controller 21 of the terminal 20A then ends the other-room member invitation processing.

Note that in the above processing, in-room sound information and in-room video information is output as the in-room moving image information on the terminal 20 of the invited user. However, there is no limitation to this configuration.

In some example embodiments, only in-room sound information may be output in the form of sound, or only in-room video information may be displayed.

### Effects of Sixth Example Embodiment

In the present example embodiment, member invitation information (a non-limiting example of information related to an invitation) is transmitted to a first meeting room from an inviting user (a non-limiting example of a first user) included in a second meeting room, in a non-limiting example. The terminal 20 of the invited user displays information (a non-limiting example of information regarding a first user) regarding the inviting user included in the member invitation information on the display 24.

As an example of an effect of the example embodiment achieved by the above configuration, the user of the terminal can be notified of the information regarding the inviting user, namely the first user, by displaying the information regarding the first user included in the information related to the invitation.

Further, it is possible that displaying the information regarding the inviting first user makes it easy for the inviting user to give an invitation and for the invited user to receive the invitation.

In this case, information regarding the inviting user (a non-limiting example of information regarding a first user) may include video information transmitted from the terminal 20 of the inviting user (a non-limiting example of a first terminal of a first user).

As an example of an effect of the example embodiment achieved by the above configuration, the information regarding the inviting first user can be notified to the user of the terminal while showing the user of the terminal the video information transmitted from the first terminal of the inviting first user by displaying the video information transmitted from the first terminal of the first user included in the information related to the invitation.

Further, it is possible that displaying video information regarding the inviting first user makes it easier for the inviting user to give invitation and for the invited user to receive the invitation.

### Modification

The above example embodiment describes a case where an inviting user invites an invited user and makes the invited user change the room. In this case, the invited user may be able to invite the inviting user back to the meeting room of the invited user.

An upper diagram of FIG. 6-3 shows an example of a screen displayed on the terminal 20A of the user A.A in the room A who has been invited by the user E.E in the room B.

Unlike the example shown in FIG. 6-1, an invite button IBT for inviting the user E.E to the room A in which the user A.A is participating is displayed in correspondence with the user E.E, together with the cancel button CBT and the move button MBT related to moving to the room B.

Upon the user A.A tapping the invite button IBT, the terminal 20E of the user E.E displays a region PPR5 (see FIG. 5-6 as a non-limiting example) that includes a message indicating that the user A.A in the room A is inviting the user E.E, as well as the cancel button CBT and the move button MBT related to moving to the room A. As a result of tapping the move button MBT related to moving to the room A, the user E.E moves to the room A as shown in a lower diagram of FIG. 6-3.

As a result, the video of the newly participating user E.E is displayed in addition to the videos of the already-existing participants (A.A to D.D) in the meeting room region RRA of the room A on the terminal 20A of the user A.A. Further, information regarding the room B, in which the user E.E is not participating and the number of participants is now three (F.F to H.H) is displayed as information regarding “other meeting rooms”.

Thus, the user A.A in the room A can invite back the user E.E in the room B, who has invited the user A.A to the room B, to the room A in which the user A.A is participating.

Note that not only the user A.A in the room A but also the other room members (users B.B to D.D) in the room A may also be allowed to invite the user E.E to the room A. That is, the user who can invite back the inviting user may be only the invited user or may be any of the room members in the same room as the room that includes the invited user. In other words, users who can invite back the inviting user may include not only the invited user but also the other room members in the same room.

FIG. 6-4 is a flowchart showing an example of a flow of the other-room member invitation processing according to the present modification. This flowchart is to be read in the same manner as FIG. 6-2.

After step A620, the controller 21 of the terminal 20A determines whether or not to invite back the user E.E by, for example, determining whether or not an input has been made to invite back the user E.E, who is the inviting user, via the input/output device 23 (A630). If it is determined that the user E.E is not to be invited back (A630: NO), the controller 21 of the terminal 20A ends the other-room member invitation processing.

If it is determined that the user E.E is to be invited back (A630: YES), the controller 21 of the terminal 20A transmits member back-invitation request information for inviting back the user E.E to the meeting room of the terminal 20A, to the server 10 by means of the communication I/F 22 (A640). The controller 21 of the terminal 20A then ends the other-room member invitation processing.

After step S620, the controller 11 of the server 10 determines whether or not the member back-invitation request information has been received from the terminal 20A by means of the communication IF 22 (S630). If it is determined that the member back-invitation request information has not been received (S630: NO), the controller 11 of the server 10 ends the other-room member invitation processing.

If it is determined that the member back-invitation request information has been received (S630: YES), the controller 11 of the server 10 transmits the member back-invitation information indicating that the user E.E has been invited back, to the terminal 20E by means of the communication I/F 14 (S640).

Note that in this case, the controller 11 of the server 10 may also transmit the member back-invitation information to the other room member terminals in the second group.

After step E620, the controller 21 of the terminal 20E determines whether or not the member back-invitation information has been received from the server 10 by means of the communication I/F 22 (E630). If it is determined that the member back-invitation information has not been received (E630: NO), the controller 21 of the terminal 20E ends the other-room member invitation processing.

If it is determined that the member back-invitation information has been received (E630: YES), the controller 21 of the terminal 20E causes the display 24 to display the received member back-invitation information (E640). The controller 21 of the terminal 20E then ends the other-room member invitation processing.

Note that processing when the user E.E accepts or does not accept the back invitation can be configured in the same manner as FIGS. 5-7 or 5-8 described above, and is therefore not shown or described here.

In the present modification, the terminal 20 of an invited user performs, by means of the controller 21, processing (a non-limiting example of processing forgiving an invitation to a first group) such as transmitting member back-invitation request information (member back-invitation information) to an inviting user included in a second meeting room, based on an input to information regarding the inviting user (a non-limiting example of information regarding a first user) displayed on the display 24 made by the invited user.

As an example of an effect of the example embodiment achieved by the above configuration, the terminal can invite back the first user included in the second group to the first group by performing processing to invite the first user to the first group based on an input made by the user of the terminal to the information regarding the first user displayed on the display. This makes it possible for one user to invite, to their group, another user in another group, only to end up being invited to the other group, which can be described as the hunter becoming the hunted.

### Seventh Example Embodiment

In the seventh example embodiment, an invitation to a meeting room can be given from room members of a plurality of meeting rooms or from a plurality of meeting rooms to a room member in another room.

The content described in the seventh example embodiment can be applied to any other example embodiments and modifications.

Constituent elements that are the same as those already described are assigned the same reference numerals as those used for corresponding elements, and a redundant description thereof is omitted.

### Display Screen

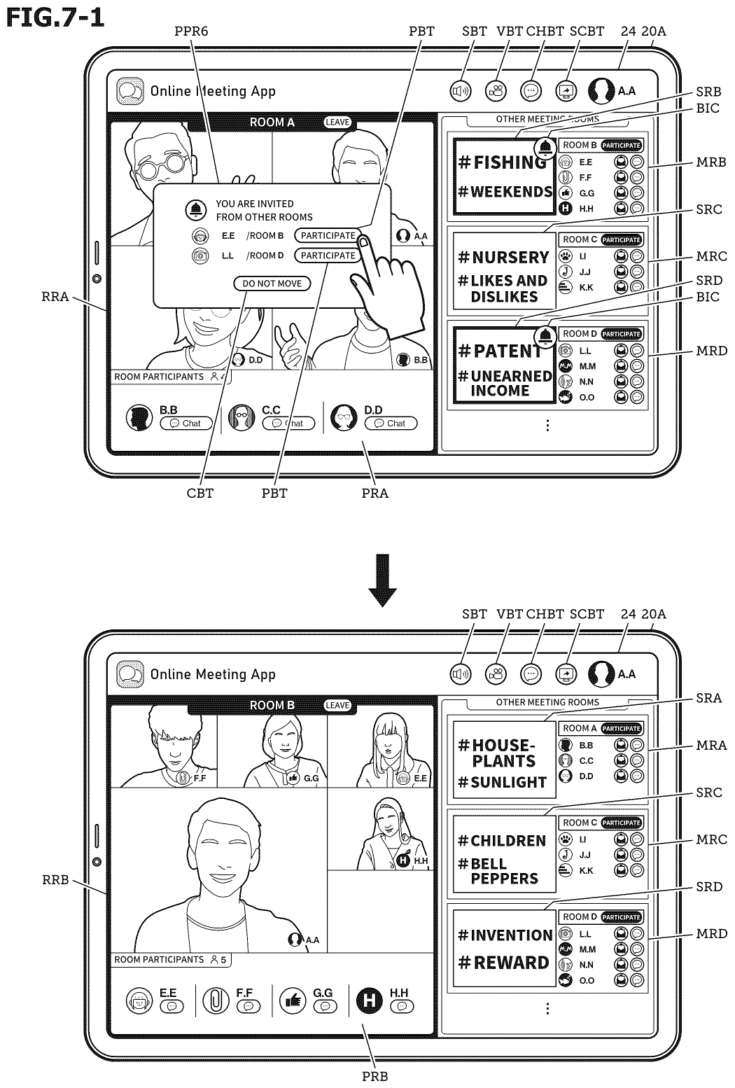

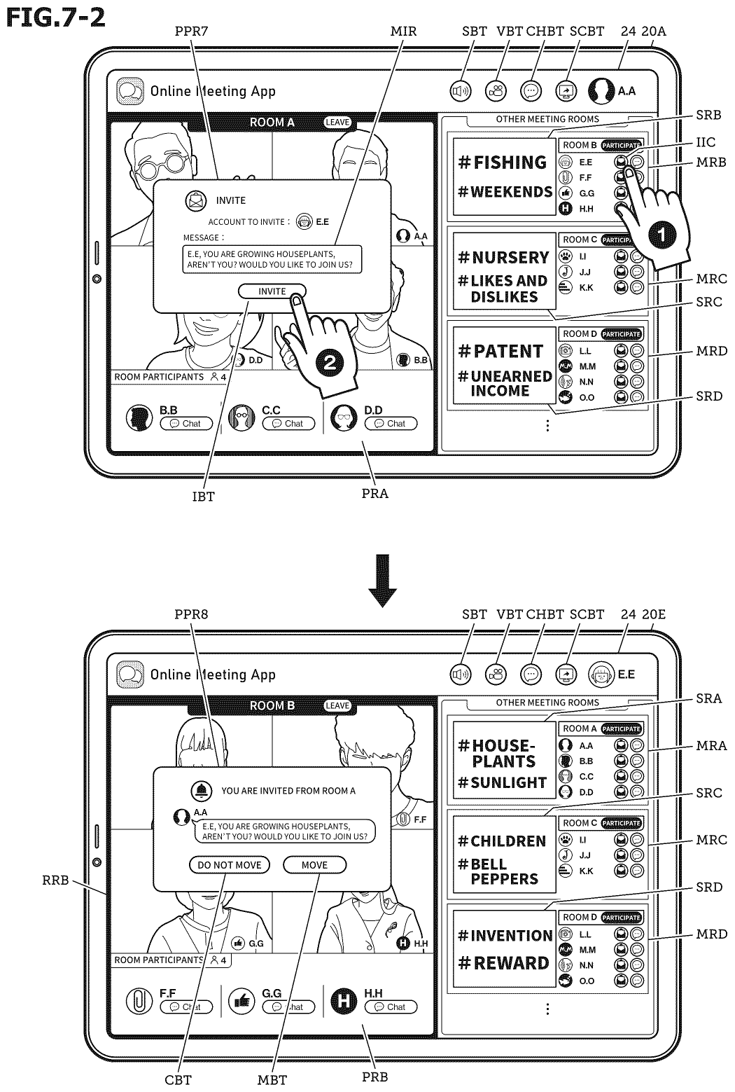

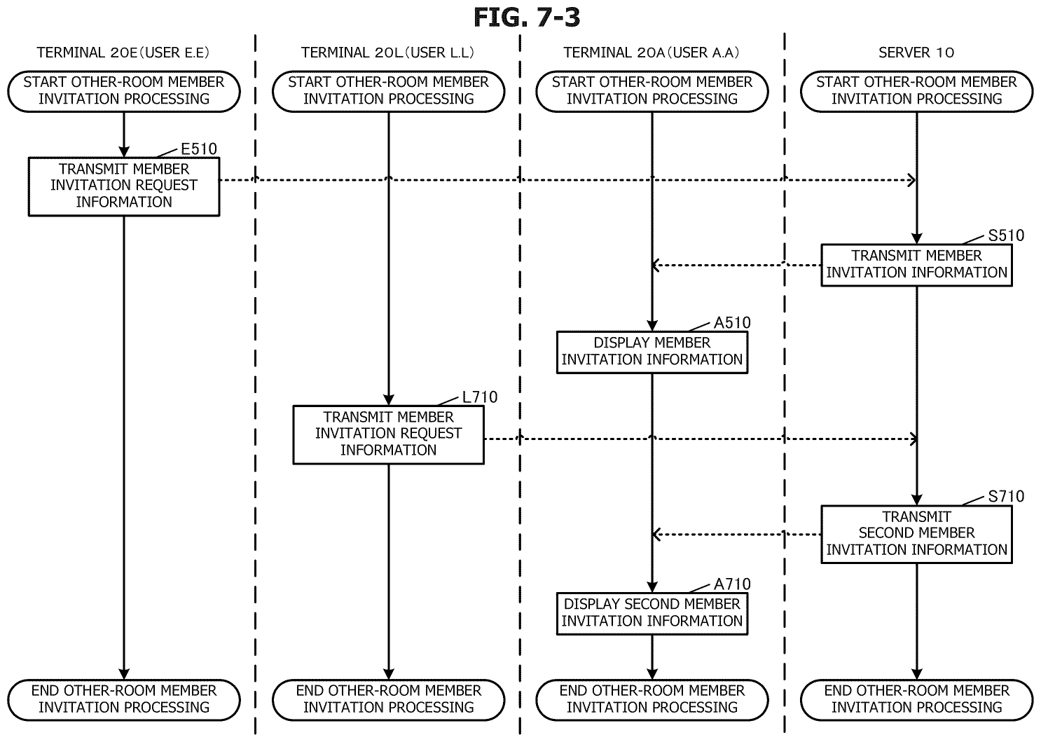

An upper diagram of FIG. 7-1 shows an example of a screen displayed on the terminal 20A of the user A.A participating in the room A. Based on the user A.A having been invited by the user E.E in the room B and the user L.L in the room D, the icon image and the username of the user E.E and a participate button PBT corresponding to the room name (room B), the icon image and the username of the user L. L and a participate button PBT corresponding to the room name (room D), as well as a cancel button CBT related to moving to another room (that is to be operated in the case of not moving to either the room B or the room D) are displayed together with a message stating “You are invited from other rooms” in a region PPR6 overlapping the meeting room region RRA.

Further, a display frame of a sub-region SRB displaying words (“fishing” and “weekends”) associated with the topic in the room B is displayed in a highlighted manner, and a display frame of a sub-region SRD displaying words (“patent” and “unearned income”) associated with the topic in the room D is displayed in a highlighted manner. Based on this, the user A.A can ascertain the words associated with the topics in the respective rooms for each of the plurality of inviting rooms and determine whether or not to participant in either room.

If the user A.A taps the participate button PBT corresponding to the user E.E (room B), the user A.A moves from the room A to the room B as shown in a lower diagram of FIG. 7-1. On the other hand, if the user A.A taps the participate button PBT corresponding to the user L.L (room D), the user A.A moves from the room A to the room D.

An upper diagram of FIG. 7-2 shows an example of a screen displayed on the terminal 20A of the user A.A participating in the room A.

If the user A.A wants to invite the user E.E participating in the room B to the room A, the user A.A taps an invitation icon IIC corresponding to the user E.E in the other-room information display region MRB corresponding to the room B (1). Then, the icon image and the username of the user E.E, a message input region MIR, and an invite button IBT are displayed in a region PPR7 overlapping the meeting room region RRA.

If the user A.A inputs, in the message input region MIR, a message (in a non-limiting example, “E.E, you are growing houseplants, aren't you? Would you like to join us?” for the user E.E that the user A.A is inviting, and taps the invite button IBT (2), the icon image and the username of the user A.A, the message input to the message input region MIR, and a cancel button CBT and a move button MBT related to participating in the room A are displayed together with a message (“You are invited from the room A”) notifying the user E.E that the user E.E is invited from the room A in a region PPR8 overlapping the meeting room region RRB on the terminal 20E of the user E.E, as shown in a lower diagram of FIG. 7-2.

If the user E.E taps the move button MBT in the region PPR8, the user E.E moves from the room B to the room A.

### Processing

FIG. 7-3 is a flowchart showing an example of a flow of the other-room member invitation processing according to the present example embodiment. Here, processing executed by the controller 21 of the terminal 20E of the user E.E included in the room B, processing executed by the terminal 20L of the user L.L included in the room D, processing executed by the controller 21 of the terminal 20A of the user A.A included in the room A, and processing executed by the controller 11 of the server 10 are shown in order from the left.

The controller 21 of the terminal 20E executes the aforementioned step E510. The controller 21 of the terminal 20E then ends the other-room member invitation processing.

Similarly, the controller 21 of the terminal 20L transmits member invitation request information for making a request to invite the user A.A to the server 10 by means of the communication I/F 22. The controller 21 of the terminal 20L then ends the other-room member invitation processing.

In step S510, the controller 11 of the server 10 transmits member invitation information with the user E.E as an inviting user to the terminal 20A of the user A.A and the other room member terminals in the room A, and thereafter transmits second member invitation information with the user L.L as an inviting user to the terminal 20A of the user A.A and the other room member terminals in the room A (S710). The controller 11 of the server 10 then ends the other-room member invitation processing.

The controller 21 of the terminal 20A causes the display 24 to display, in step A510, the member invitation information with the user E.E as an inviting user, and thereafter display the second member invitation information received from the server 10 (A710). For example, in a non-limiting example, the controller 21 causes the display 24 to display information combining the member invitation information received from the server 10 and the second member invitation information that has also been received from the server 10.

Note that, alternatively, the member invitation information and the second member invitation information may be displayed separately. Further, these two pieces of member invitation information may be displayed at the same timing or at different timings, and may optionally be displayed together. These two pieces of member invitation information may be displayed in different display modes.

Further, in step S710, the controller 11 of the server 10 may transmit one piece of member invitation information including information with the user E.E as an inviting user and information with the user L.L as an inviting user to the terminal 20A.

After step A710, the controller 21 of the terminal 20A ends the other-room member invitation processing.

The same applies to the other room member terminals in the room A.

Note that in this case, the user A.A of the terminal 20A can also invite back an inviting user. In this case, if, in a non-limiting example, the user A.A wants to invite the user E.E included in the room B, the processing executed by the controller 21 of the terminal 20A may be replaced with the processing executed by the controller 21 of the terminal 20E in the processing described in FIG. 5-7, in a non-limiting example.

For example, the controller 21 of the terminal 20A transmits, to the room B, member invitation request information for inviting the user E.E included in the room B to the room A (equivalent to step E510 in FIG. 5-7). Based on the member invitation request information received from the terminal 20A, the controller 11 of the server 10 may transmit, in step S510 of FIG. 5-7, member invitation information with the user A.A as an inviting user to the terminal 20E of the user E.E and other the room member terminals in the room B.

The same applies to a case where the user A.A invites the user L.L included in the room D.

In this case, the member invitation request information (member invitation information) may also include information indicating a message for the room that includes the invited user, as mentioned above.

### Effects of Seventh Example Embodiment

In the present example embodiment, the member invitation information (a non-limiting example of information related to an invitation) is first member invitation information (a non-limiting example of first invitation information), in a non-limiting example. The terminal 20 of an invited user receives second member invitation information (a non-limiting example of second invitation information), which is another member invitation information different from the first member invitation information, by means of the communication I/F 22, and thereafter displays, on the display 24, information (a non-limiting example of information regarding an inviter in first invitation information) regarding the invited user corresponding to the first member invitation information, and information (a non-limiting example of information regarding an inviter in second invitation information) regarding the invited user corresponding to the second member invitation information.

As an example of an effect of the example embodiment achieved by the above configuration, if the second invitation information different from the first invitation information is received by means of the communication device, the information regarding the inviter in the first invitation information and the information regarding the inviter in the second invitation information can be displayed on the display of the terminal, thereby notifying the user of the terminal of the information regarding the inviters of the two invitations.

In this case, the terminal 20 of the user invited to a second meeting room may transmit, to the second meeting room, member invitation information for inviting a first user (a non-limiting example of a second user) included in the second meeting room to the first meeting room, by means of the communication I/F 22.

As an example of an effect of the example embodiment achieved by the above configuration, the terminal 20 of the user invited to the second group can invite back the second user included in the second group to the first group and make this invitation know % n to the second group.

Note that since the number of room members may be one as mentioned above, the aforementioned second user included in the second group above may be the only user included in the second group. That is, the second user may be expressed as a first user included in the second group.

In this case, the aforementioned member invitation information may include information indicating a message for the second meeting room.

As an example of an effect of the example embodiment achieved by the above configuration, including information indicating a message for the second group in the information related to the invitation to the first group enables the second group to more easily understand the invitation given to the second user.

### Eighth Example Embodiment

In the eighth example embodiment, a user can inform room members of another meeting room that the user is interested in the other meeting room.

The content described in the eighth example embodiment can be applied to any other example embodiments and modifications.

Constituent elements that are the same as those already described are assigned the same reference numerals as those used for corresponding elements, and a redundant description thereof is omitted.

### Display Screen

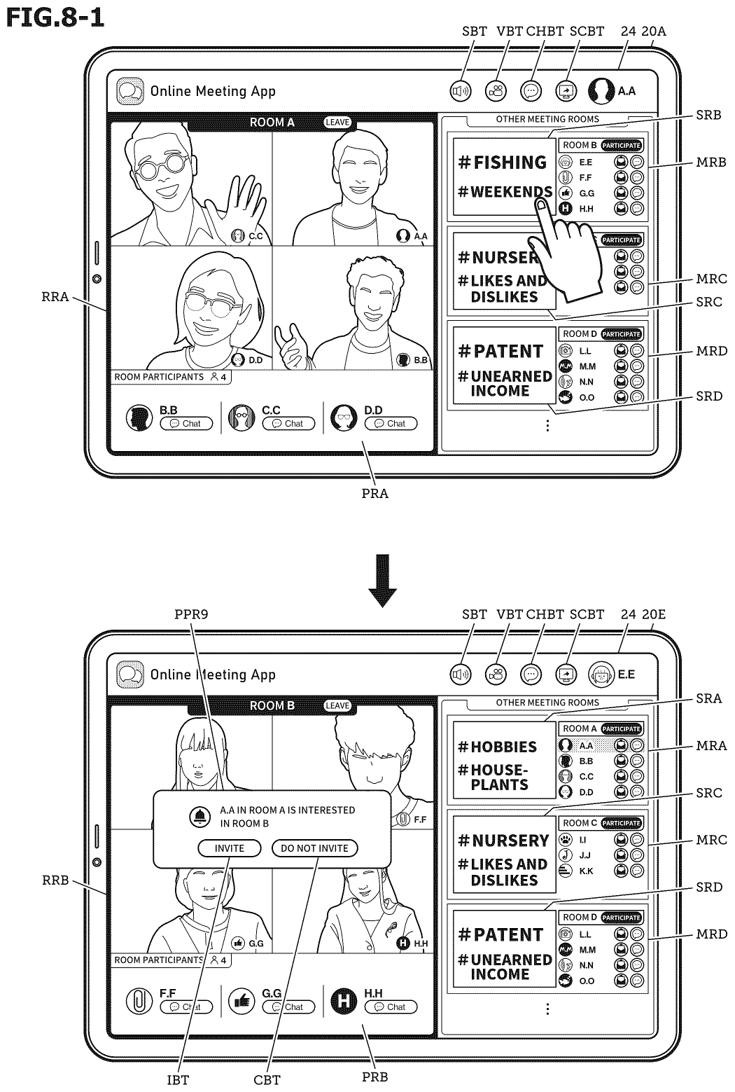

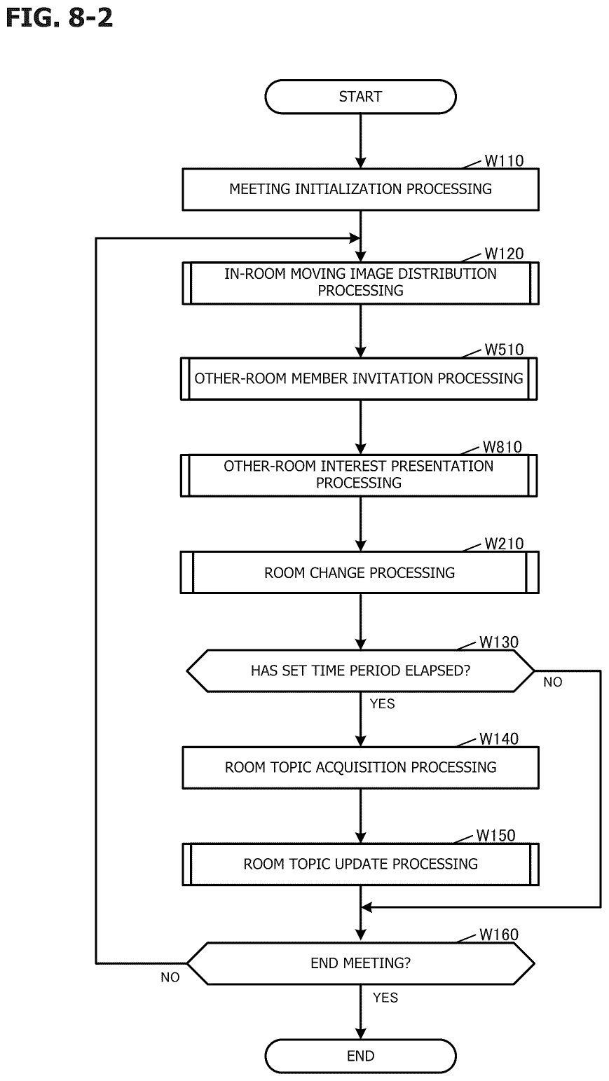

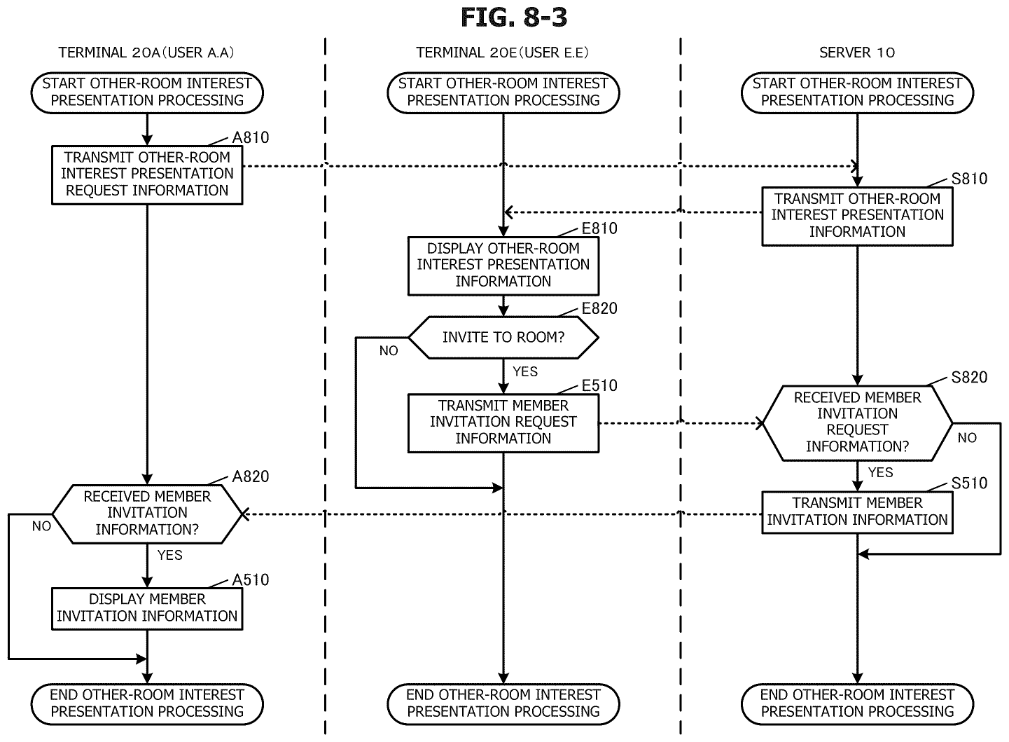

An upper diagram of FIG. 8-1 shows an example of a screen displayed on the terminal 20A of the user A.A participating in the room A.

Upon the user A.A tapping a sub-region SRB displaying words (“fishing” and “weekends”) associated with the topic in the room B (or videos of participants in the room B), a message (“A.A in room A is interested in room B”) giving notification that the user A.A in the room A is interested in the room B, an invite button IBT to be operated to invite the user A.A to the user B, and a cancel button CBT to be operated in the case of not inviting the user A.A are displayed in a region PPR9 overlapping the meeting room region RRB on the terminal 20E of the user E.E in the room B, as shown in a lower diagram of FIG. 8-1.

Further, the mode of the region corresponding to the user A.A changes in the other-room information display region MRA corresponding to the room A, thus enabling the user E.E to know which user in which group is interested in the group B in which the user E.E is participating.

Upon the user E.E tapping the invite button IBT in the region PPR9, the move button MBT for moving from the room A to the room B is displayed in the region PPR5 overlapping the meeting room region RRA on the terminal 20A of the user A.A (see FIG. 5-6).

On the other hand, if the user E.E taps the cancel button CBT in the region PPR9, the move button MBT (region PPR5) is not displayed on the terminal 20A of the user A.A, and the user A.A cannot move from the room A to the room B.

Thus, the user A.A can tap the sub-region SRB in which information of interest is displayed to notify the users (E.E to H.H) in the room B corresponding to the tapped sub-region SRB that the user A.A is interested in the room B (there is a possibility that the user A.A will participate in the room B). Further, the users (E.E to H.H) in the room B can ascertain that the user A.A is interested in the room B, and can optionally invite the user A.A to the room B.

Note that the invite button IBT and the cancel button CBT in the region PPR9 may also be operable on the terminals 20 of the users (E.E to H.H) participating in the room B. In some example embodiment, the invite button IBT and the cancel button CBT in the region PPR9 may be operable only on the terminal 20 of a desired (or alternatively, predetermined) user (in a non-limiting example, a user set as a room administrator) among the users in the room B. Whether or not to invite the user A.A who is interested in the room B to the room B may be decided by majority vote among the users in the room B.

Note that a notification that the user A.A in the room A is interested in the room B may be given to the terminals 20 of the users (E.E to H.H) participating in the room B, or the notification may be given only to the terminal 20 of a desired (or alternatively, predetermined user (in a non-limiting example, a user set as a room administrator) among the users in the room B.

### Processing

FIG. 8-2 is a flowchart showing an example of a flow of processing executed in the communication system 1 according to the present example embodiment.

After step W510, the communication system 1 performs other-room interest presentation processing (W810).

FIG. 8-3 is a flowchart showing an example of a flow of the other-room interest presentation processing. The flowchart shows processing executed by the controller 21 of the terminal 20A of the user A.A included in the room A, processing executed by the controller 21 of the terminal 20E of the user E.E included in the room B, and processing executed by the controller 11 of the server 10, in order from the left.

In a non-limiting example, the controller 21 of the terminal 20A transmits other-room interest presentation request information for making a request to present, to another room, the fact that the user A.A is interested in the other room, to the server 10 by means of the communication I/F 22, based on an input made via the input/output device 23 to a room topic, room tag notification information, or the like that is displayed regarding the other room (A810).

Note that the controller 21 of the terminal 20A may transmit the other-room interest presentation request information to the server 10 based on an input to video information or the like regarding the other room displayed for this room.

In a non-limiting example, the other-room interest presentation request information may include information for making a request to the server 10 to transmit the other-room interest presentation information indicating that the user is interested in the room, to the room in which the user is interested or to the room members in this room.

The other-room interest presentation request information may include, in a non-limiting example, information equivalent to a “like” used on social networking services or information on a message input by the user indicating that the user has an interest.

The other-room interest presentation request information may also include information for prompting users of a room (in this example, the room B that includes the user E.E) to invite the user of the terminal (the user A.A in this example) to the room (or may including information for prompting the users of the room B to invite the user A.A more actively): in a non-limiting example, the other-room interest presentation request information may include information for making a request to transmit member invitation request information.

Upon receiving the other-room interest presentation request information from the terminal 20A by means of the communication I/F 14, the controller 11 of the server 10 transmits corresponding other-room interest presentation information to the terminal 20E (and the other room member terminals) in the second group by means of the communication I/F 14 (S810).

Note that in this example, the server 10 may transmit the other-room interest presentation information only to the terminal 20E.

In regard to the above, the controller 11 of the server 10 may also transmit the aforementioned other-room interest presentation information including information related to making a request to transmit the member invitation request information so as to invite the user A.A to the meeting room of the second group that includes the user E.E, in a non-limiting example.

Upon receiving the other-room interest presentation information from the server 10 by means of the communication I/F 22, the controller 21 of the terminal 20E causes the display 24 to display the received other-room interest presentation information (E810).

Thereafter, the controller 21 of the terminal 20E determines whether or not to invite the user A.A to the meeting room of the terminal 20E based on whether or not an input has been made to invite the user A.A to the meeting room of the terminal 20E (the meeting room of the second group) via the input/output device 23 (E820), in a non-limiting example. If it is determined that the user A.A is not to be invited (E820. NO), the controller 21 of the terminal 20E ends the other-room interest presentation processing.

If it is determined that the user A.A is to be invited (E820: YES), the controller 21 of the terminal 20E transmits member invitation request information for making a request to invite the user A.A to the server 10 by means of the communication I/F 22 (E520).

After S810, the controller 11 of the server 10 determines whether or not the member invitation request information has been received by means of the communication I/F 14 (S820). If it is determined that the member invitation request information has not been received (S820: NO), the controller 11 ends the other-room interest presentation processing.

If it is determined that the member invitation request information has been received (S820: YES), the controller 11 of the server 10 transmits the aforementioned member invitation information to the terminal 20A (and the other room member terminals) in the room A by means of the communication I/F 22 (S510). The controller 11 of the server 10 then ends the other-room interest presentation processing.

Note that the member invitation information may be transmitted only to the terminal 20A.

The member invitation information transmitted to terminal 20A may be different from the member invitation information transmitted to the other room member terminals (information with different content).

After step A810, the controller 21 of the terminal 20A determines whether or not the member invitation information has been received from the server 10 by means of the communication I/F 22 (A820). If it is determined that the member invitation information has not been received (A820: NO), the controller 21 of the terminal 20A ends the other-room interest presentation processing.

If it is determined that the member invitation information has been received (A820: YES), the controller 21 of the terminal 20A causes the display 24 to display the received member invitation information (A510). The controller 21 of the terminal 20A then ends the other-room interest presentation processing.

Returning to FIG. 8-2, after performing the other-room interest presentation processing (W810), the controller 11 of the server 10 advances the processing to step W210.

### Effects of Eighth Example Embodiment

The present example embodiment describes a configuration in which the terminal 20 transmits information (a non-limiting example of second information indicating interest in a second group), such as the other-room interest presentation information, to a second group, or to a user (a non-limiting example of a second user) included in the second group, by means of the communication I/F 22, based on an input made to the terminal 20 by the user of this terminal 20.

As an example of an effect of the example embodiment achieved by the above configuration, the terminal can inform the second group or the second user included in the second group that the user of the terminal is interested in the second group, based on the input made to the terminal by the user of the terminal.

In this case, the other-room interest presentation information in a non-limiting example may also include information related to making a request to transmit the member invitation information (a non-limiting example of information related to an invitation), in a non-limiting example.

As an example of an effect of the example embodiment achieved by the above configuration, including the information related to making a request to transmit information related to an invitation in the second information indicating interest in the second group enables the user of the terminal to make a request to invite the user to the second group in which the user is interested.

In this case, the terminal 20 displays, on the display 24, video information transmitted and received in the other room and information (a non-limiting example of third information based on information transmitted and received in a second group) such as room topic information and room tag notification information based on information transmitted and received in the other room. The terminal 20 may then transmit other-room interest presentation information (a non-limiting example of second information) based on an input to that information, by means of the communication I/F 22.

As an example of an effect of the example embodiment achieved by the above configuration, it is possible to display the third information based on the information transmitted and received in the second group on the display of the terminal, and transmit the second information indicating interest in the second group based on the input to the third information, thereby informing the second group or the second user included in the second group that the user of the terminal is interested in the second group.

### Ninth Example Embodiment

The ninth example embodiment relates to an exit of a user from a room.

In the second and other example embodiments, a user is allowed to exit from the entire meeting. However, depending on the user, some user may not want to exit from all meetings but want to leave the current room. In this case, there may be cases where a user who has exited from the current room does not wish to return to his/her original room but wants to move to another room.

In the following example embodiments, exiting from the current room is referred to as “leaving a room”. Leaving a room may also be referred to as “leaving a room before the meeting is over”. In a non-limiting example, leaving a room, or leaving a room before the meeting is over, may mean a state where the user can stop communication in the current room and move to another room and a state where the user does not exit from all meetings but is not included in any room (meeting room/waiting room). Note that the user may leave their seat.

The content described in the ninth example embodiment can be applied to any other example embodiments and modifications.

Constituent elements that are the same as those already described are assigned the same reference numerals as those used for corresponding elements, and a redundant description thereof is omitted.

### Display Screen

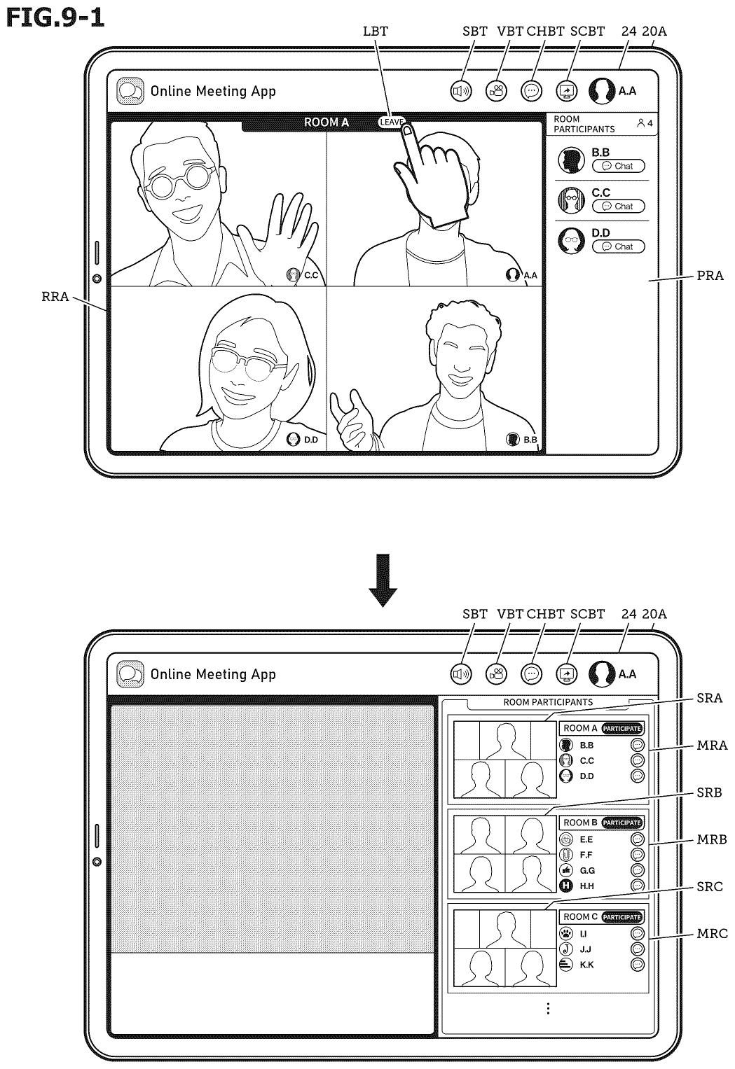

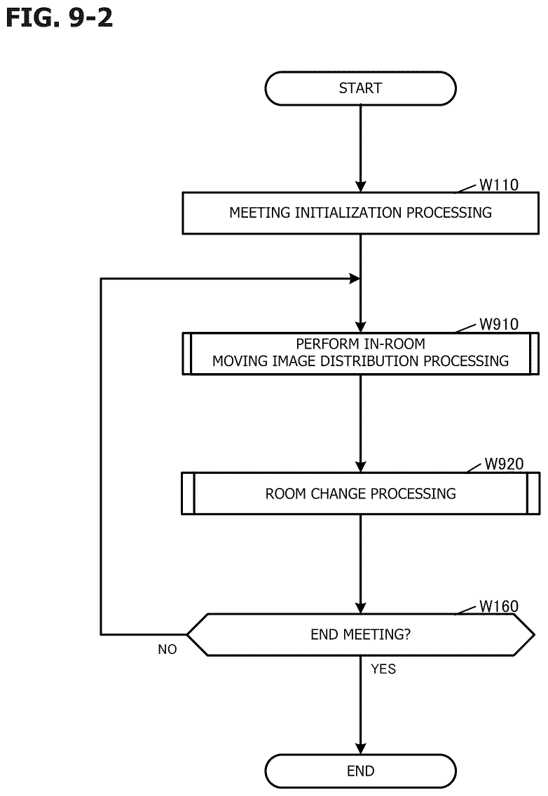

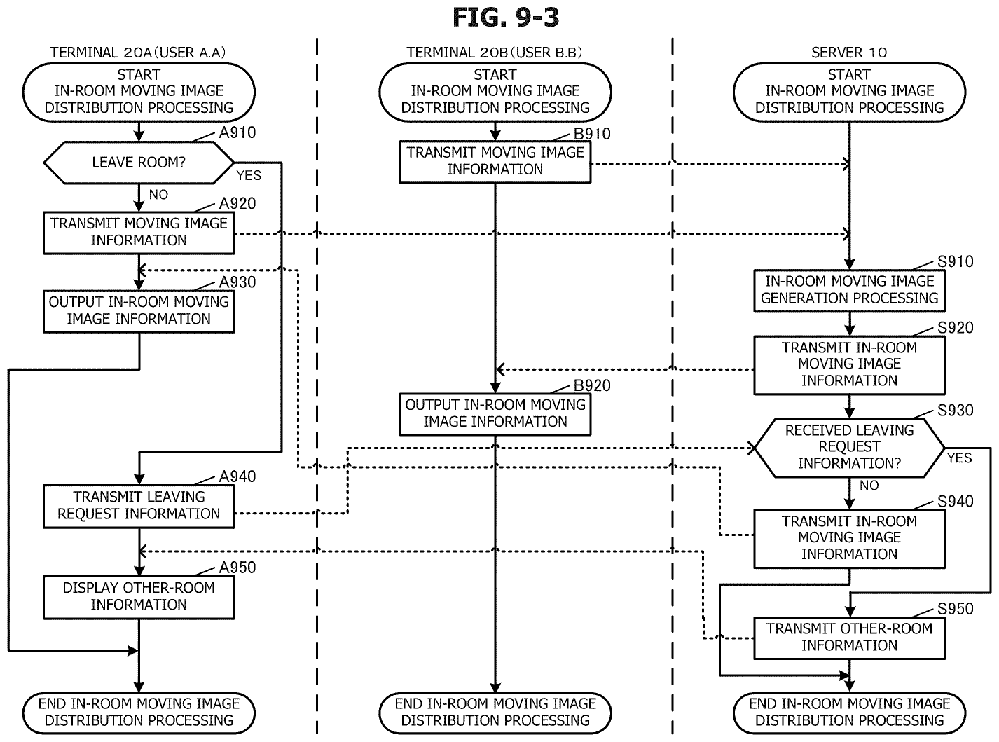

An upper diagram of FIG. 9-1 shows an example of a screen displayed on the terminal 20A of the user A.A participating in the room A.

In this diagram, a room participant region PRA in which information related to users participating in a meeting taking place in the room A is displayed is provided on the right side of the meeting room region RRA.

A lower diagram of FIG. 9-1 shows an example of a screen displayed on the terminal 20A when the leave button LBT is tapped in the upper diagram of FIG. 9-1.

In the present example embodiment, based on the user A.A tapping the leave button LBT, the user A.A leaves the room A, and the screen that has become blank due to the user A.A leaving the room A is displayed on in a left part of the display 24 of the terminal 20A.

Other-room information display regions MRA, MRB, MRC, . . . corresponding to the other respective rooms, including the room A that the user has left are provided in on the right side of the blank screen. The other-room information display regions MRA, MRB, MRC, . . . include sub-region SRA, SRB, SRC, . . . , respectively, which display video information regarding the respective rooms. That is, in this example, when the user A.A has left the room A, the user A.A can check video information and participant information regarding the other rooms, including the room A that the user A.A has left. The user A.A can participate in any of the other rooms by operating a participate button displayed in the corresponding other-room information display region. Note that the user A.A may be able to participate in a room by operating information other than the participate button among the various types of the aforementioned other-room information.

### Processing

FIG. 9-2 is a flowchart showing an example of a flow of processing executed in the communication system 1 according to the present example embodiment.

After step W110, the communication system 1 performs in-room moving image distribution processing (W910).

FIG. 9-3 is a flowchart showing an example of a flow of the in-room moving image distribution processing according to the present example embodiment. The flowchart shows processing executed by the controller 21 of the terminal 20A, processing executed by the controller 21 of the terminal 20B, and processing executed by the controller 11 of the server 10, in order from the left.

In a non-limiting example, the controller 21 of the terminal 20A determines whether or not to leave the room by determining whether or not a user input (in a non-limiting example, an operation of a leave button) has been made to leave the room via the input/output device 23 (A910). If it is determined that the terminal 20A is not to leave the room (A910: NO), the controller 21 of the terminal 20A performs a step of transmitting moving image information (A920) and a step of displaying the in-room moving image information (A930), and then ends the in-room moving image distribution processing.

If it is determined that the terminal 20A is to leave the room (A910: YES), the controller 21 of the terminal 20A transmits leaving request information for making a request to leave the current meeting room, to the server 10 by means of the communication I/F 22 (A940).

After step S920, the controller 11 of the server 10 determines whether or not the leaving request information has been received by means of the communication I/F 14 (S930). If it is determined that the leaving request information has not been received (S930: NO), the controller 11 performs a step of transmitting in-room moving image information to the terminal 20A (S940), and then ends the in-room moving image distribution processing.

If it is determined that the leaving request information has been received (S930: YES) the controller 11 of the server 10 transmits other-room information, which is information related to the other rooms, to the terminal 20A by means of the communication I/F 14 (S950). In this case, the user A.A is removed from the room members of the room A due to leaving the room A, and the other-room information may include room information regarding the respective rooms including the room A, in a non-limiting example. Note that information that can be included in the other-room information is as described above.

After step A940, the controller 21 of the terminal 20A turns OFF the display of the meeting room of the room A and causes the display 24 to display the other-room information received from the server 10 by means of the communication I/F 22 (A950). The controller 21 of the terminal 20A then ends the in-room moving image distribution processing. That is, the terminal 20A performs control to stop outputting the moving image information transmitted and received in the room A, and performs control to display the other-room information including the room A that the user A.A has left.

Returning to FIG. 9-2, after step W910, the controller 11 of the server 10 performs room change processing (W920). In the room change processing, the controller 11 of the server 10 determines, for each room, whether or not room change request information has been received from the terminal 20 by means of the communication I/F 14, based on the processing shown in FIG. 2-6, in a non-limiting example (S201). If it is determined that the room change request information has been received (S201: YES), the controller 11 of the server 10 deletes the application ID of the user of the terminal 20 that has transmitted the received room change request information from the room member IDs associated with the room ID of the current meeting room in the meeting room management data, and adds the application ID of this user to the room member IDs associated with the room ID of the destination room (S203).

Upon receiving the leaving request information from the terminal 20 in step W910, the controller 11 of the server 10 temporarily deletes the application ID of the user of the terminal 20 that has transmitted the received leaving request information from the room member IDs associated with the room ID of the current room in the meeting room management data, and stores and keeps this application ID in the storage 15. As a result, the leaving user is not included in any room.

After step W920, the controller 11 of the server 10 advances the processing to step W160.

Note that the controller 11 of the server 10 may allow the user to leave the room if a set time period has elapsed since or a set time has arrived after the user input was made to leave the room via the input/output device 23 or the controller 21 of the terminal 20 transmitted the leaving request information to the server 10 and the server 10 received this leaving request information.

For example, the controller 21 of the terminal 20 may transmit the leaving request information to the server 10 when a set time period (in a non-limiting example, one minute) has elapsed since or a set time (in a non-limiting example, five minutes past every hour) has arrived after the user input to leave the room was made via the input/output device 23, in a non-limiting example.

Further, in anon-limiting example, the controller 11 of the server 10 may make the user of the terminal 20 leave the room if a set time period (in a non-limiting example, one minute) has elapsed since or a set time (in a non-limiting example, five minutes past every hour) has arrived after the server 10 received the leaving request information from the terminal 20.

This is because the user may feel awkward about leaving the room immediately. This is even more remarkable in the case of moving to another meeting room. If the user is made to immediately leave the current room and moved to another meeting room, the user may feel even more awkward toward the room members in the original meeting room.

### Effects of Ninth Example Embodiment

In the present example embodiment, the terminal 20, which outputs moving image information (a non-limiting example of sound information and video information) transmitted and received in a first meeting room, outputs the moving image information transmitted and received in the first meeting room, which includes the user of this terminal 20, from the display 24 and the sound output device 26. The terminal 20 then performs control to stop outputting the moving image information transmitted and received in the first meeting room based on input (in a non-limiting example, a first input) made to this terminal 20 by the user to leave the room, by means of the controller 21. The terminal 20 then displays other-room information (a non-limiting example of information indicating a first group and information indicating a second group different from the first group) on the display 24.

As an example of an effect of the example embodiment achieved by the above configuration, the terminal can output sound information and video information transmitted and received in the first group including the user of the terminal, and stop outputting the sound information and the video information transmitted and received in the first group based on the first input made to the terminal by the user of the terminal. In this case, due to the terminal displaying the information indicating the first group and the information indicating the second group different from the first group, the user of the terminal can check the information indicating the first group and the information indicating the second group even if the output of the sound information and the video information transmitted and received in the first group is stopped.

Note that in the above processing example, when making the user leave the room, the user and the room are dissociated, and other-room information that includes information regarding the room that the user has left is displayed. However, there is no limitation to this configuration.

A configuration may alternatively be employed in which when making the user leave the room, the user and the room are not dissociated, and room information regarding the room that the user has left and room information (other-room information) regarding the other rooms is displayed.

A configuration may alternatively be employed in which room information regarding the room that the user has left is not displayed.

In this case, the terminal 20 may perform, by means of the controller 21, control (a non-limiting example of control to cease participating in a first group) to transmit leaving request information to the server 10 based on an input (a non-limiting example of a first input) made to this terminal 20 by the user of the terminal 20 to leave the room.

As an example of an effect of the example embodiment achieved by the above configuration, the terminal can perform control such that the user of the terminal ceases participating in the first group based on the first input made to the terminal by the user of the terminal. Further, performing such control makes it possible to make the user of the terminal leave the first group.

In this case, the terminal 20 performs control to participate in another room based on an input made to other-room information (a non-limiting example of information indicating a second group) by means of the controller 21.

As an example of an effect of the example embodiment achieved by the above configuration, the terminal can make the user participate in the second group based on the input to the information indicating the second group.

In this case, the terminal 20 may perform, by means of the controller 21, control to stop outputting moving image information transmitted and received in a first meeting room if a set time period has elapsed since or when a set time has arrived after the input was made by the user of the terminal 20 to leave a room.

As an example of an effect of the example embodiment achieved by the above configuration, the terminal can stop outputting sound information and video information transmitted and received in the first group if the set time period has elapsed or the set time has arrived after the first input. This also makes it possible to prevent the user of the terminal from feeling awkward about immediately leaving the group.

The present example embodiment describes a configuration in which the server 10, which relays moving image information (a non-limiting example of sound information and video information) transmitted and received in a first group, includes: a controller 11 that performs control to stop transmitting, to a first terminal, the moving image information transmitted from a terminal 20 included in the first meeting room, based on an input (a non-limiting example of a first input) made to the terminal 20 by the user of this terminal 20 (a non-limiting example of a first terminal) included in the first meeting room; and a communication I/F 14 that transmits other-room information (a non-limiting example of information indicating a first group and information indicating a second group different from the first group) to the aforementioned first terminal.

As an example of an effect of the example embodiment achieved by the above configuration, the server can stop transmitting, to the first terminal included in the first group, sound information and video information transmitted from terminals included in the first group, based on the first input made to the first terminal by the user of the first terminal. In this case, due to the server transmitting the information indicating the first group and the information indicating the second group different from the first group to the first terminal, the user of the first terminal can check the information indicating the first group and the information indicating the second group even if transmission of sound information and video information transmitted from terminals included in the first group to the first terminal is stopped.

### Tenth Example Embodiment

The tenth example embodiment, which is slightly different from the ninth example embodiment, relates to moving a user who has exited from a meeting room to the aforementioned waiting room.

The content described in the tenth example embodiment can also be applied to any other example embodiments and modifications.

Constituent elements that are the same as those already described are assigned the same reference numerals as those used for corresponding elements, and a redundant description thereof is omitted.

### Data Configuration

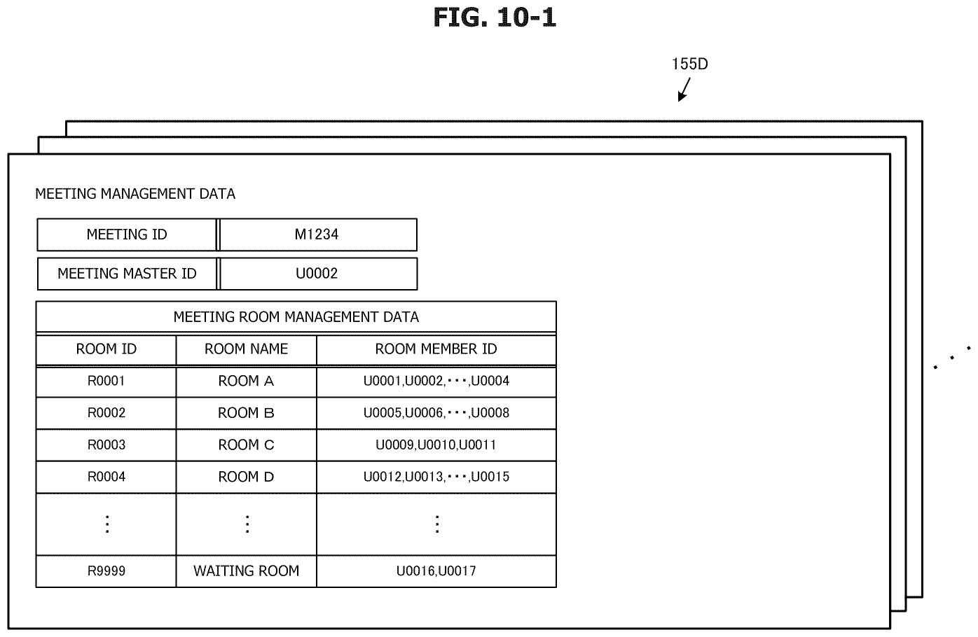

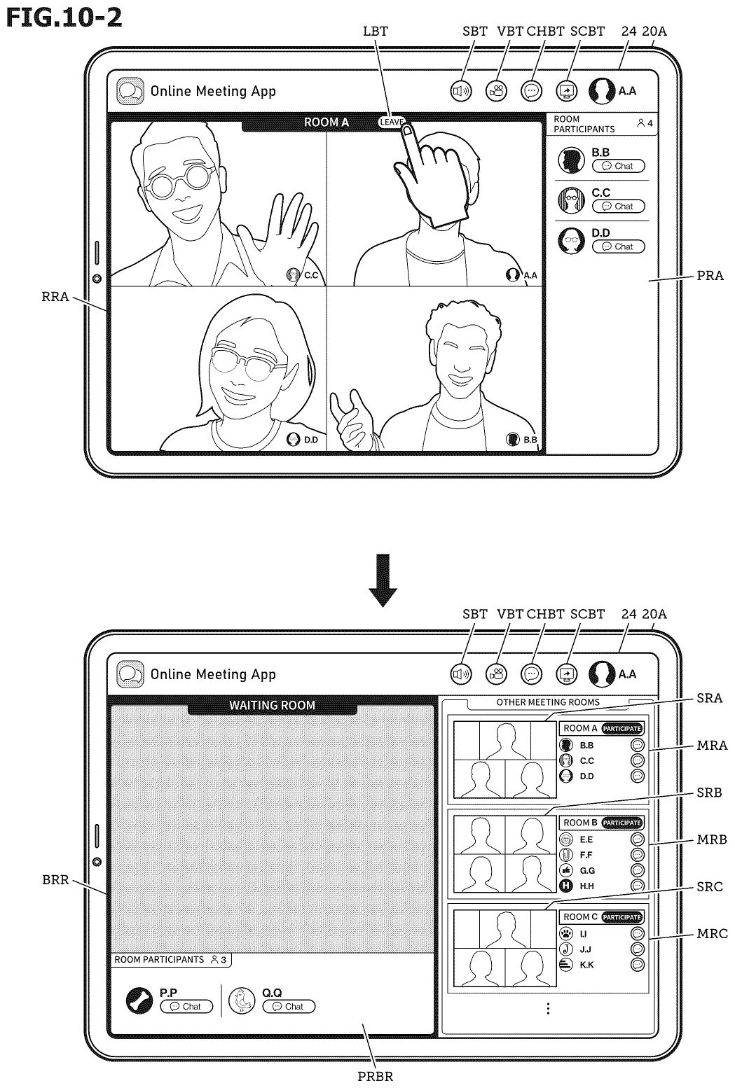

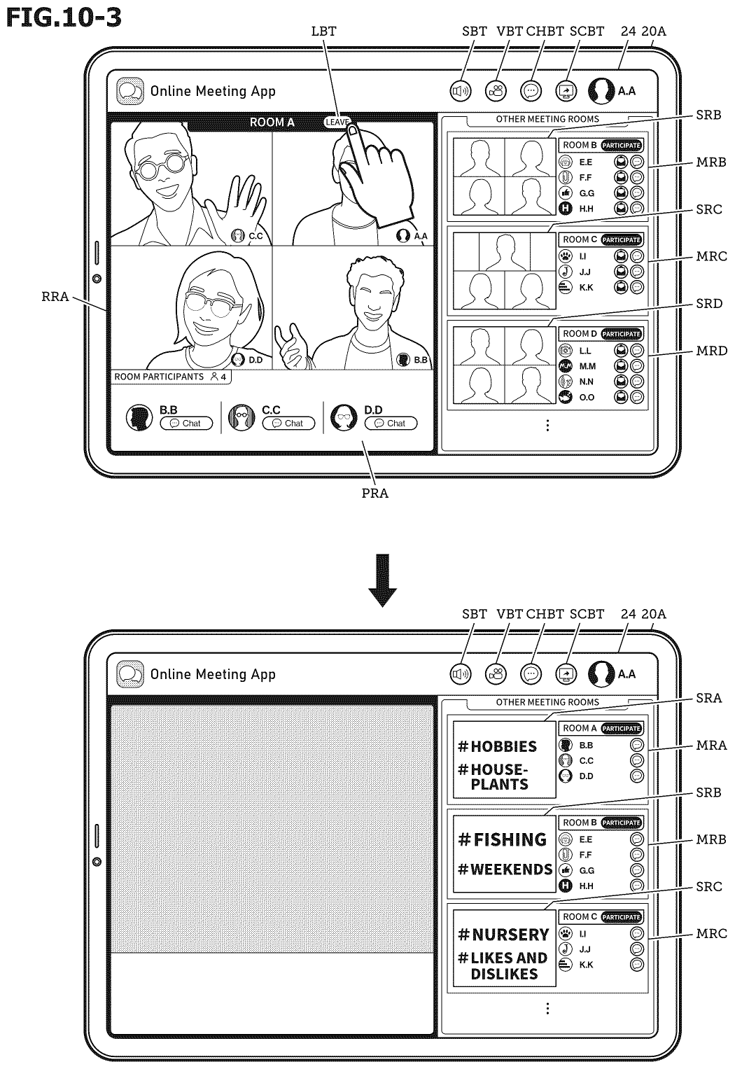

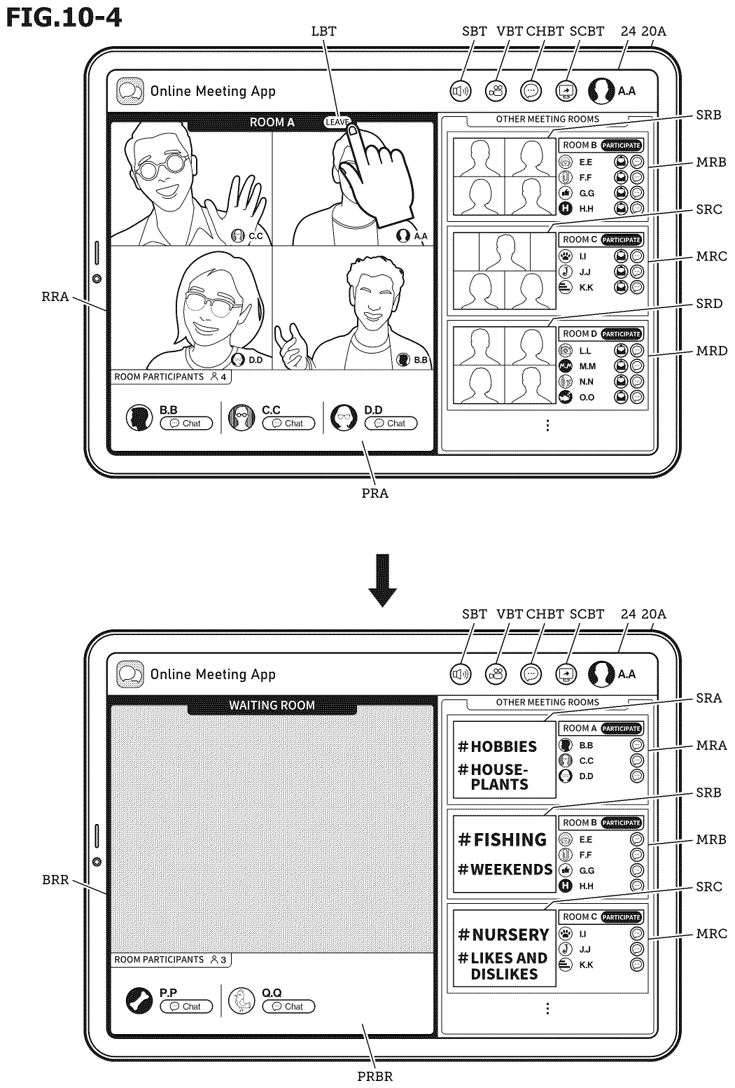

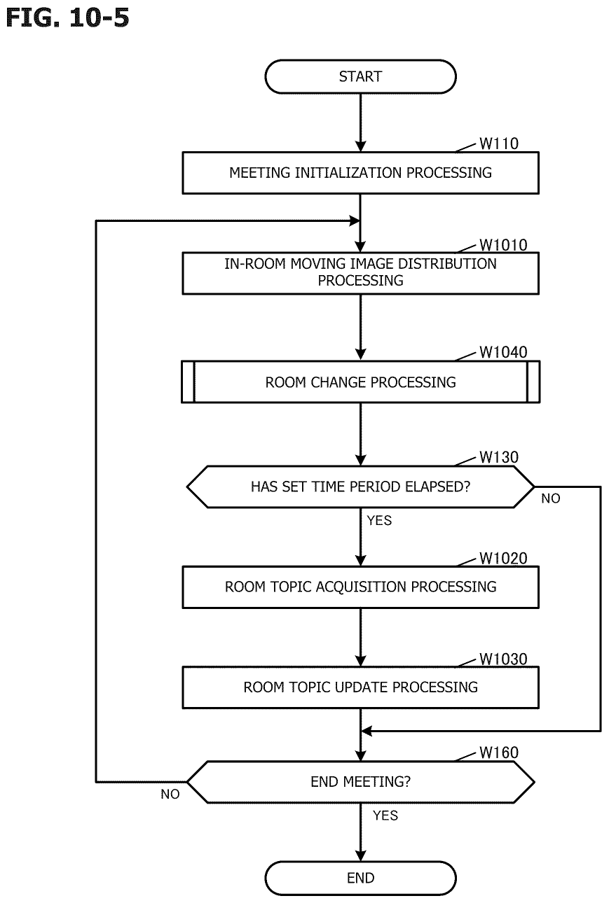

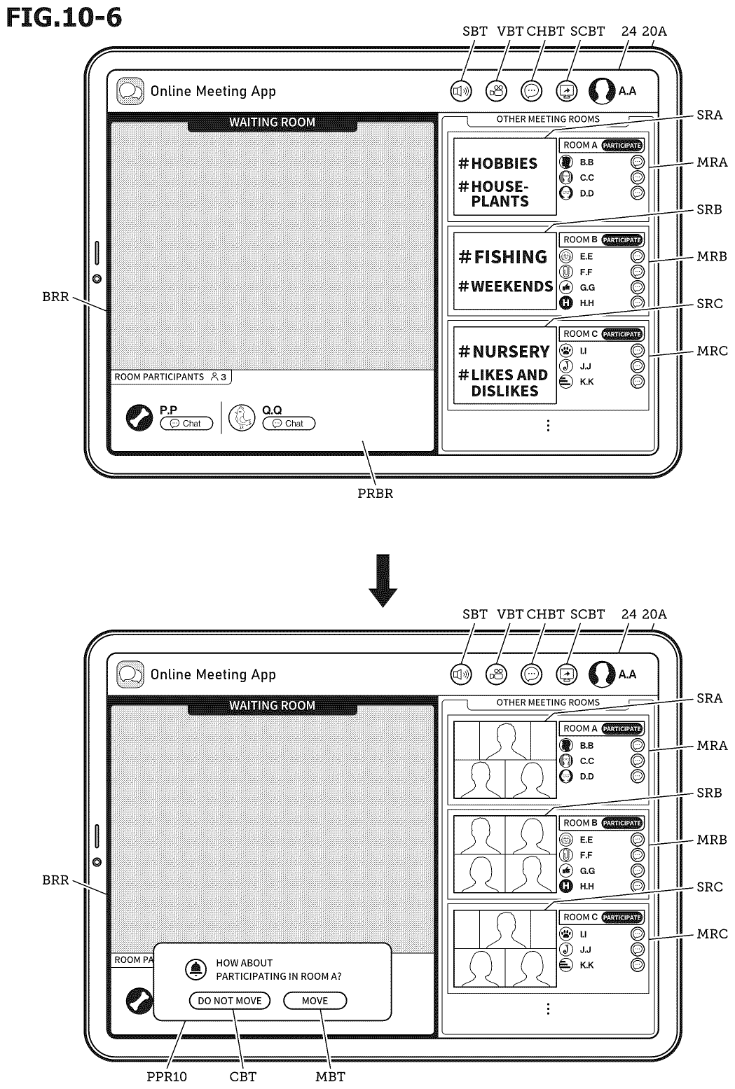

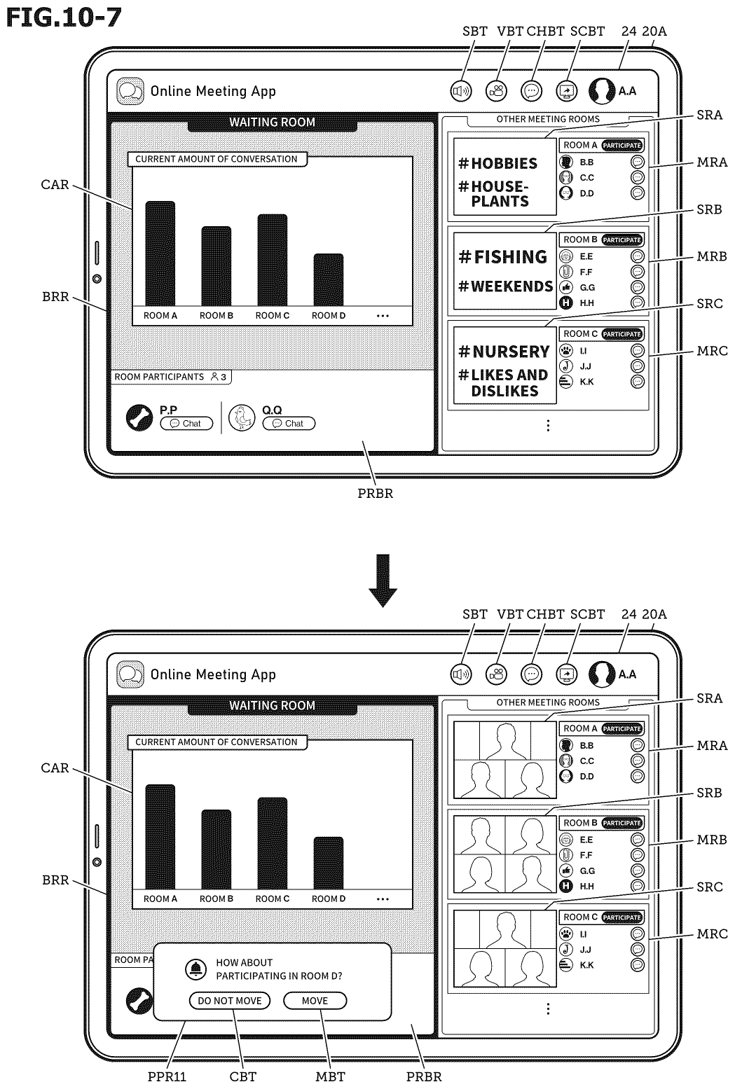

FIG. 10-1 is a diagram showing an example of a data configuration of a meeting management database 155D, which is an example of the meeting management database 155 according to the present example embodiment.

In the meeting management database 155D, room IDs, room names, and room member IDs are stored in association with each other, in a non-limiting example, in each meeting room management data included in the meeting management data.

In the present example embodiment, the room IDs includes a room ID (in this example, “R999”) of a “waiting room” is stored in addition to the room IDs of the aforementioned meeting rooms, in a non-limiting example.

Further. “waiting room” as the room name and application IDs of users included in the waiting room as the room member IDs are stored in association with the room ID of the waiting room, in a non-limiting example.

Note that the meeting room management data may also store, as room information other than the above, the amount of speech of each room member (the amount of speech of each room member ID), a link shared within the room, and an image storage location, in a non-limiting example. Further, the aforementioned room topics or the like may also be stored (except for the waiting room).

As will be described later, messages or the like may be transmitted and received in the waiting room (between room members of the waiting room or terminals of the room members of the waiting room, or within the group in the waiting room). In this case, the controller 11 of the server 10 may infer and acquire a room topic in the waiting room based on the messages or the like transmitted and received in the waiting room. Further, in this case, the room topic may also be stored in the field of the waiting room in the aforementioned meeting room management data.

### Display Screen

An upper diagram of FIG. 10-2 shows an example of a screen displayed on the terminal 20A of the user A.A participating in the room A, similarly to the upper diagram of FIG. 9-1.

A lower diagram of FIG. 10-2 shows an example of a screen displayed on the terminal 20A when the leave button LBT is tapped in the upper diagram of FIG. 10-2.

Based on the user A.A tapping the leave button LBT, the user A.A leaves the room A, and a waiting room region BRR displaying a screen of the waiting room to which the user A.A has moved is displayed in a left part of the display 24 of the terminal 20A, unlike the lower diagram of FIG. 9-1. A waiting room participant region PRBR, which displays information related to users participating in the waiting room (waiting in the waiting room) other than the user A.A, is provided below the waiting room region BRR. In this example, information related to users P.P and Q.Q, who are users other than the user A.A in the waiting room, is displayed.

On the right side of these regions, regions are displayed that include sub-regions SRA, SRB, SRC, . . . displaying video information regarding the other respective rooms are displayed as other-room information display regions MRA, MRB, MRC, . . . for the respective rooms, similarly to the lower diagram of FIG. 9-1.

In this case, the room that includes the user of the terminal is the “waiting room”, and the other rooms are the “meeting rooms”.

Note that messages or the like may optionally be able to be transmitted and received between the room members of the waiting room, as mentioned above.

An upper diagram of FIG. 10-3 shows an example of a screen displayed on the terminal 20A of the user A.A participating in the room A and is almost similar to the upper diagram of FIG. 9-1 and the upper diagram of FIG. 10-2. However, in this example, sub-regions SRA, SRB, SRC, . . . displaying video information regarding meetings taking place in the other respective rooms, and regions each including the room names, participate buttons, information related to room members, an invite buttons, and so on, are displayed as other-room information display regions MRA, MRB, MRC, . . . on the right side of the meeting room region RRA.

A lower diagram of FIG. 10-3 shows an example of a screen displayed on the terminal 20A when the leave button LBT is tapped in the upper diagram of FIG. 10-3.

Based on the leave button LBT having been tapped, a blank screen is displayed in a left part of the display 24 of the terminal 20A, similarly to the lower diagram of FIG. 9-1. On the right side of this blank screen, regions that include sub-regions SRA, SRB, SRC, . . . displaying words (room topic, room tag notification information) of the other respective rooms are displayed as other-room information display regions MRA, MRB, MRC, . . . for the respective rooms.

That is, in this example, if the user A.A leaves the room A, the user A.A does not move to the waiting room and can check topics in the other rooms including the room A that the user A.A has left.

An upper diagram of FIG. 10-4 shows an example of a screen displayed on the terminal 20A of the user A.A participating in the room A, similarly to the upper diagram of FIG. 10-3.

A lower diagram of FIG. 10-4 shows an example of a screen displayed on the terminal 20A when the leave button LBT is tapped in the upper diagram of FIG. 10-4.

Based on the leave button LBT having been tapped, a screen of the waiting room is displayed in the waiting room region BRR in a left part of the display 24 of the terminal 20A, similarly to the lower diagram of FIG. 10-2. On the right side of that screen, regions that include sub-regions SRA, SRB, SRC, . . . displaying words (room topic, room tag notification information) of the other respective rooms are displayed as other-room information display regions MRA, MRB, MRC, . . . for the respective rooms, similarly to the lower diagram of FIG. 10-3.

That is, in this example, if the user A.A leaves the room A, the user A.A moves to the waiting room, and can check topics in the other rooms, including the room A that the user A.A has left.

Note that the other-room information display region may display images related to room topics and shared images, similarly to FIG. 2-1, in a non-limiting example.

Room topics, room tag notification information, and the like may also be displayed based on an input to video information or the like, similarly to FIG. 2-2.

Relevant other-room information may also be displayed in a highlighted manner based on information regarding the user who has moved to the waiting room, as shown in FIGS. 3-1 and 3-3.

### Processing

FIG. 10-5 is a flowchart showing an example of a flow of processing executed in the communication system 1 according to the present example embodiment.

After step W110, the communication system 1 performs in-room moving image distribution processing (W1010). In this in-room moving image distribution processing, if, in a non-limiting example, the leaving request information is received (S930: YES) in the processing shown in FIG. 9-3, the controller 11 of the server 10 transmits other-room information to the terminal 20A by means of the communication I/F 14 (S950). In this case, the other-room information may include the following information, in a non-limiting example, in addition to the aforementioned information:
information regarding room members in the waiting room (in a non-limiting example, the room member names, the room member IDs, and images of the room members in the waiting room).

Further, in the in-room moving image distribution processing, the controller 11 of the server 10 can perform either of the following processing:
not performing the in-room moving image generation processing even if moving image information is received from the terminal 20 of a room member of the waiting room; or
performing the in-room moving image generation processing but not transmitting the generated in-room moving image information to the terminal 20 if moving image information is received from the terminal 20 of a room member of the waiting room.

By doing so, in the above processing example, the display 24 of the terminal 20A can be configured to not display the in-room moving image information.

Unlike the above, the controller 11 of the server 10 may alternatively transmit the in-room moving image information to the terminals 20 of the room members of the waiting room. In this case, in the in-room moving image distribution processing, the controller 21 of the terminal 20 of each room member of the waiting room can be configured to not cause the display 24 to display the received in-room moving image information.

Unlike the above, the controller 21 of the terminal 20 of each room member of the waiting room may alternatively be configured to not transmit the moving image information to the server 10.

By doing so, in the above processing example, the display 24 of the terminal 20A can be configured to not display the in-room moving image information.

As mentioned above, the terminal 20 of each room member of the waiting room may be able to transmit a message via the server 10 to any other user in the waiting room based on a user input made via the input/output device 23. In this case, if contents such as text contents are input via the input/output device 23, and a button for transmitting the contents is tapped, the controller 21 of the terminal 20A transmits the input contents to the server 10. The controller 11 of the server 10 can generate message information based on the received contents and transmit the generated message information to the terminal 20 of any other user in the waiting room.

After step W1010, the communication system 1 performs room change processing (W1040). In the room change processing, the controller 11 of the server 10 determines, for each room, whether or not room change request information has been received from any terminal 20 by means of the communication I/F 14. If it is determined that the room change request information has been received, the controller 11 of the server 10 deletes the application ID of the user of the terminal 20 that has transmitted the room change request information from the room member IDs associated with the room ID of the current meeting room in the meeting room management data, and adds the application ID of this user to the room member IDs associated with the room ID of the destination room.

Further, upon a user input (in a non-limiting example, an operation of a leave button etc.) being made via the input/output device 23 on the terminal 20 to leave the room, room change request information for making a request to move to the waiting room or leaving request information for making a request to leave the current meeting room is transmitted from this terminal 20 to the server 10. Based on the received information, the controller 11 of the server 10 changes the application ID of the user of the terminal 20 in the meeting room management data from a room member ID associated with the room ID of the current room to a room member ID associated with the room ID of the waiting room.

After step W1040, the controller 11 of the server 10 advances the processing to step W130. If it is determined that a set time period has elapsed (W130: YES), the controller 11 performs room topic acquisition processing (W1020).

In the room topic acquisition processing, the controller 11 of the server 10 need not acquire a room topic in the waiting room. However, in anon-limiting example, the controller 11 may infer and acquire a room topic in the waiting room based on a message (contents) or the like transmitted and received between room members of the waiting room, as mentioned above.

Thereafter, the communication system 1 performs room topic update processing (W1030).

In the room topic update processing, the controller 11 of the server 10 can be configured to not transmit room topic information to the terminal 20 of each room member of the waiting room, in a non-limiting example.

By doing so, the terminal 20 of each room member of the waiting room can be configured to not display a room topic, room tag notification information, or the like.

Unlike the above, the controller 11 of the server 10 may alternatively transmit room topic information to the terminal 20 of each room member of the waiting room. In this case, in the room topic update processing, the controller 21 of the terminal 20 of each room member of the waiting room may perform any of the following processing, in a non-limiting example:
not performing room tag notification information generation processing and not displaying room tag notification information even if the room topic information is received;
performing room tag notification information generation processing based on the received room topic information but not displaying the generated room tag notification information; and
not displaying the room topic indicated by the received room topic information (and not displaying room tag notification information either).

By doing so, the terminal 20 of each room member of the waiting room can be configured to not display a room topic, room tag notification information, or the like.

After step W1030, the controller 11 of the server 10 advances the processing to step W160.

### Effects of Tenth Example Embodiment

The present example embodiment describes a configuration in ich the terminal 20 performs, by means of the controller 21, control to move to the waiting room (a non-limiting example of a third group), which is one of the rooms different from the current meeting room, based on an input (a non-limiting example of a first input) made to this terminal 20 by the user of the terminal 20 to leave the room.

As an example of an effect of the example embodiment achieved by the above configuration, the user of the terminal can be moved to the third group different from the first group, based on the first input.

In this case, the waiting room (a group in a waiting room) may be configured such that moving image information cannot be transmitted and received within the waiting room (a group in a waiting room).

As an example of an effect of the example embodiment achieved by the above configuration, the third group can be configured such that a user cannot transmit or receive voice information and video information within the third group after moving to the third group different from the first group based on the first input, thus enabling the user to wait.

In this case, the waiting room (a group in a waiting room) may be configured such that messages can be transmitted and received.

As an example of an effect of the example embodiment achieved by the above configuration, in addition to the above, voice information and video information cannot be transmitted and received within the third group, but simple communication can be performed within the third group using messages by enabling transmission and reception of messages.

In this case, if the user of a terminal 20 is included in the waiting room (a group in a waiting room), the terminal 20 may perform, by means of the controller 21, control to display information indicating the previous room (group) in which the user has been included before moving to the waiting room and information indicating the other rooms (other groups).

As an example of an effect of the example embodiment achieved by the above configuration, even if the user of the terminal is included in the third group, it is possible to display the information indicating the first group and the information indicating the second group and enable the user of the terminal to check the information indicating the first group and the information indicating the second group.

### Modification (1)

In the above example embodiment, a suggestion or the like for participating in a meeting room may be made to a user included in the waiting room based on a set condition having been met.

An upper diagram of FIG. 10-6 shows an example of a screen displayed on the terminal 20A of the user A.A participating in the room A, similarly to the lower diagram of FIG. 10-4.

After the screen of the waiting room shown in the upper diagram of FIG. 10-6 has been displayed, in this example, member invitation information (which may also be referred to as room participation suggestion information) that includes text (in this example, text stating “How about participating in room A?”) that prompts the user A.A to participate in the room A, a move button MBT, and a cancel button CBT is displayed in a pop-up region PPR10, which is displayed in the form of a pop-up, as shown in a lower diagram of FIG. 10-6.

In a non-limiting example, the controller 11 of the server 10 may transmit the member invitation information to the terminal 20A based on a set condition having been met. In a non-limiting example, the set condition may be either one of the following:
a set time period having elapsed since the user moved to the waiting room; and
a set time having arrived after the user moved to the waiting room.

In this case, in a non-limiting example, the controller 11 of the server 10 can determine the destination room to suggest, to be any of the following rooms:
a room including the user of the terminal 20 that has transmitted, to the server 10, the aforementioned member invitation request information (the terminal 20 that has received the member invitation request information);
a meeting room in which a room member of the waiting room was participating immediately before moving to the waiting room;
a meeting room determined based on user information regarding a room member of the waiting room (using the same method as that of the above-described example embodiment); and
a randomly determined meeting room.

Suggesting a room including the user of the terminal 20 that has transmitted the member invitation request information to the server 10 as a destination room means receiving an invitation given to a room member of the waiting room and making a suggestion to the user to move to the inviting room.

In this example, in the upper diagram of FIG. 10-6, the sub-regions SRA, SRB, SRC, . . . in the other-room information display regions MRA, MRB, MRC, . . . for the other respective rooms displayed on the right side of the waiting room region BRR and the waiting room participant region PRBR display corresponding words (room topics, room tag notification information) of the other respective rooms. However, based on the aforementioned set condition having been met, the words (room topics, room tag notification information) that have been displayed are erased in the sub-regions SRA, SRB, SRC, . . . , and video information regarding the other respective rooms is displayed instead, in the lower diagram of FIG. 10-6.

Note that in this case, based on the aforementioned set condition having been met, the other-room information display regions may alternatively be configured to not display any other-room information on the screen on the lower side of FIG. 10-6.

Upon the move button MBT being tapped, room change request information is transmitted from the terminal 20A to the server 10, and the server 10 performs room change processing, thereby moving the user A.A to the suggested destination room (in this example, the room A).

Note that the controller 21 of the terminal 20A may alternatively determine whether or not a set condition (same as above) has been met and cause the display 24 to display the member invitation information if it is determined that the set condition has been met, instead of the configuration in which the controller 11 of the server 10 transmits the member invitation information to the terminal 20A and the controller 21 of the terminal 20A causes the display 24 to display the received member invitation information.

### Modification (2)

An upper diagram of FIG. 10-7 shows an example of a screen displayed on the terminal 20A of the user A.A participating in the room A.

In this example, a region that includes the sub-regions SRA, SRB, SRC, . . . displaying corresponding words (room topics, room tag notification information) of the other respective rooms as the other-room information display region MRA, MRB, MRC, . . . for the other respective rooms is displayed on the right side of the waiting room region BRR and the waiting room participant region PRBR.

Further, in this example, a conversation amount region CAR representing the amount of conversation in each of the other rooms in a bar chart is displayed in the waiting room region BRR. The controller 11 of the server 10 can aggregate the amount of conversation in each of the other rooms based on the amount of speech of each room member stored in association with the room in the meeting room management data, in a non-limiting example. Information regarding the amount of conversation in each room obtained as the result of the aggregation is transmitted from the server 10 to terminal 20. In this example, the controller 21 of the terminal 20A can cause the amount of conversation in each of the other rooms to be displayed in the form of a graph based on the received information regarding the amount of conversation.

Note that the controller 11 of the server 10 may alternatively generate a graph and transmit the generated graph to the terminal 20.

Note that the controller 21 of the terminal 20 transmits speech amount request information for making a request for information regarding the amount of speech of the user of the terminal 20 to the server 10 by means of the communication I/F 22, during a meeting in the meeting room. The controller 11 of the server 10 may then transmit information regarding the amount of speech of the user to the terminal 20 of the user based on the speech amount request information having been received from the terminal 20 by means of the communication I/F 14. The controller 21 of the terminal 20 may cause the display 24 to display the received amount of speech. Note that a request for information regarding the amount of speech of any selected/designated user, rather than the amount of speech of the user themself, may be made to the server 10 to acquire that information. Further, the controller 21 of the terminal 20 may acquire the amount of speech of the user of the terminal 20 based on sound information that is input by means of the sound input device 25.

After the screen of the waiting room shown in the upper diagram of FIG. 10-7 has been displayed, in this example, member invitation information that includes text (in this example, text stating “How about participating in room D?”) prompting the user A.A to participate in the room D, a move button MBT, and a cancel button CBT is displayed in a pop-up region PPR11, which is displayed in the form of a pop-up, as shown in a lower diagram of FIG. 10-7.

The room participant information can be transmitted to the terminal 20A by the controller 11 of the server 10 based on a set condition having been met (in a non-limiting example, a set time period having elapsed since the user moved to the waiting room or a set time arriving after the user moved to the waiting room), similarly to FIG. 10-6, in a non-limiting example.

In this example, the controller 11 of the server 10 can determine the destination room to suggest based on the amount of conversation in the other respective rooms, in a non-limiting example. For example, the controller 11 of the server 10 can determine a room with the smallest amount of conversation as the destination room to suggest, in a non-limiting example.

In this example, in the upper diagram of FIG. 10-7, the sub-regions SRA, SRB, SRC, . . . in the other-room information display regions MRA, MRB, MRC, . . . for the other respective rooms displayed on the right side of the waiting room region BRR and the waiting room participant region PRBR display corresponding words (room topics and room tag notification information) of the other respective rooms.

However, based on the aforementioned set condition having been met, the words (room topics, room tag notification information) that have been displayed in the upper diagram of FIG. 10-7 disappear in the sub-regions SRA, SRB, SRC . . . , and video information regarding the other respective rooms is displayed instead, in the lower diagram of FIG. 10-7.

Upon the move button MBT being tapped, room change request information is transmitted from the terminal 20A to the server 10, and the server 10 performs room change processing, thereby moving the user A.A to the suggested destination room (in this example, the room D).

Note that the controller 21 of the terminal 20A may alternatively determine whether or not a set condition (same as above) has been met and cause the display 24 to display the member invitation information if it is determined that the set condition has been met, instead of the configuration in which the controller 11 of the server 10 transmits the member invitation information to the terminal 20A and the controller 21 of the terminal 20A causes the display 24 to display the received member invitation information.

In the examples shown in FIGS. 10-6 and 10-7, each room member of the waiting room is asked about whether or not to move to the proposed destination room, and if the user agrees to move, the user is moved to the proposed destination room. However, there is no limitation to this configuration.

The controller 11 of the server 10 may alternatively perform room change processing without agreement by the user and move the user to the suggested destination room (which may also be referred to as forced move from the waiting room).

The controller 11 of the server 10 may also force the user to exit from the waiting room (hereinafter referred to as “forced exit (forced leaving)” based on a set condition having been met. In this case, in a non-limiting example, the controller 11 of the server 10 temporarily deletes the application ID of this user from the room member IDs associated with the room ID of the waiting room, and stores and keeps this application ID in the storage 15. This is to make it possible to keep track of the user who has been forced to exit the waiting room. As a result, the user is not included in any room (including the waiting room).

As mentioned above, when the controller 11 of the server 10 forces a user to exit from the waiting room, the controller 11 may stop transmitting other-room information to the terminal 20 of the user such that the other-room information is not displayed on the terminal 20 of the user if the aforementioned set condition is met, in a non-limiting example. That is, the user forced to exit from the waiting room may be made unable to check information regarding the other rooms.

In the present modification, if the user of the terminal 20 is included in the waiting room (a group in a waiting room) and the terminal 20 receives member invitation information or room participation suggestion information (a non-limiting example of information related to an invitation) by means of the communication I/F 22, the controller 21 may perform control to move to a room (group) based on the member invitation information or the room participation suggestion information.

As an example of an effect of the example embodiment achieved by the above configuration, if the user of a terminal is included in a third group and the terminal receives information related to an invitation, the terminal can move the user of the terminal to a group based on the information related to the invitation. Further, performing this control makes it possible to force the user to move from the third group to an inviting group.

In this case, if the user of the terminal 20 is included in the waiting room (a group in a waiting room) for a set time period or longer or until a set time, the controller 21 of the terminal 20 may perform control to cause the display 24 to not display other-room information (a non-limiting example of information indicating a first group and information indicating a second group).

As an example of an effect of the example embodiment achieved by the above configuration, if the user of the terminal is included in the third group for a set time period or longer or until a set time, it is possible to make the user unable to check the information indicating the first group and the information indicating the second group by causing the display to not display the information indicating the first group and the information indicating the second group. Further, performing this control makes it possible to force the user to exit the third group, in a non-limiting example.

In this case, if the user of the terminal 20 is included in the waiting room (a group in a waiting room) for a set time period or longer or until a set time, the controller 21 of the terminal 20 may perform control to move the user to a room (group) different from the waiting room (a group in a waiting room)

As an example of an effect of the example embodiment achieved by the above configuration, if the user of the terminal is included in the third group for a set time period or longer or until a set time, the user can be moved to a fourth group different from the third group. Further, performing this control makes it possible to force the user to move from the third group to the fourth group, in a non-limiting example.

In this case, the terminal 20 may acquire the amount of speech of the user of this terminal 20 by means of the controller 21, the communication I/F 22, the sound input device 25, or the like (a non-limiting example of an acquirer).

As an example of an effect achieved by the above configuration, the terminal can acquire the amount of speech of the user of the terminal. Further, in a non-limiting example, the terminal can enable the user of the terminal to ascertain the amount of speech of displaying the acquired amount of speech on the display.

### Eleventh Example Embodiment

In the eleventh example embodiment, it is possible to make a user leave a room based on a set condition having been met.

The content described in the eleventh example embodiment can also be applied to any other example embodiments and modifications.

Constituent elements that are the same as those already described are assigned the same reference numerals as those used for corresponding elements, and a redundant description thereof is omitted.

As described in the ninth and tenth example embodiments, the user can leave a room by making a user input (in anon-limiting example, tapping a leave button) to leave the room. This user input being made may also be considered as a set condition.

In the present example embodiment, a user is enabled to leave a room based on a condition having been met that is other than a user input having been made. As an example, a method is described in which the terminal 20 acquires information related to the user of the terminal 20, and automatically makes the user of the terminal 20 leave a room based on the acquired information related to the user.

### Display Screen

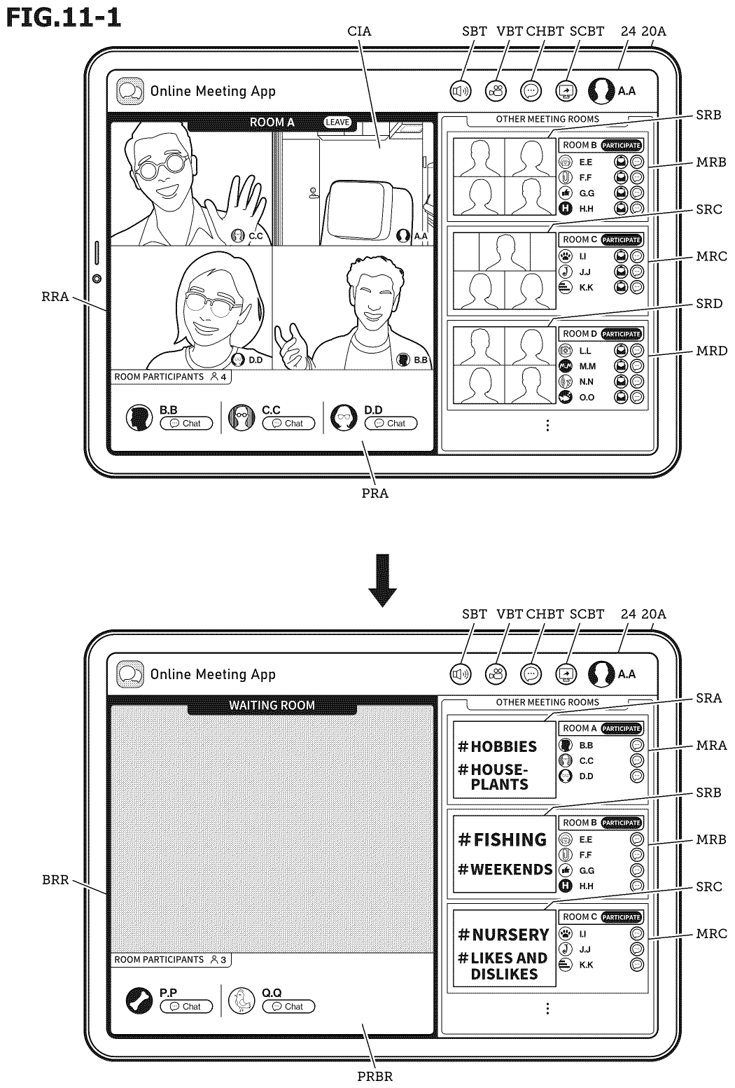

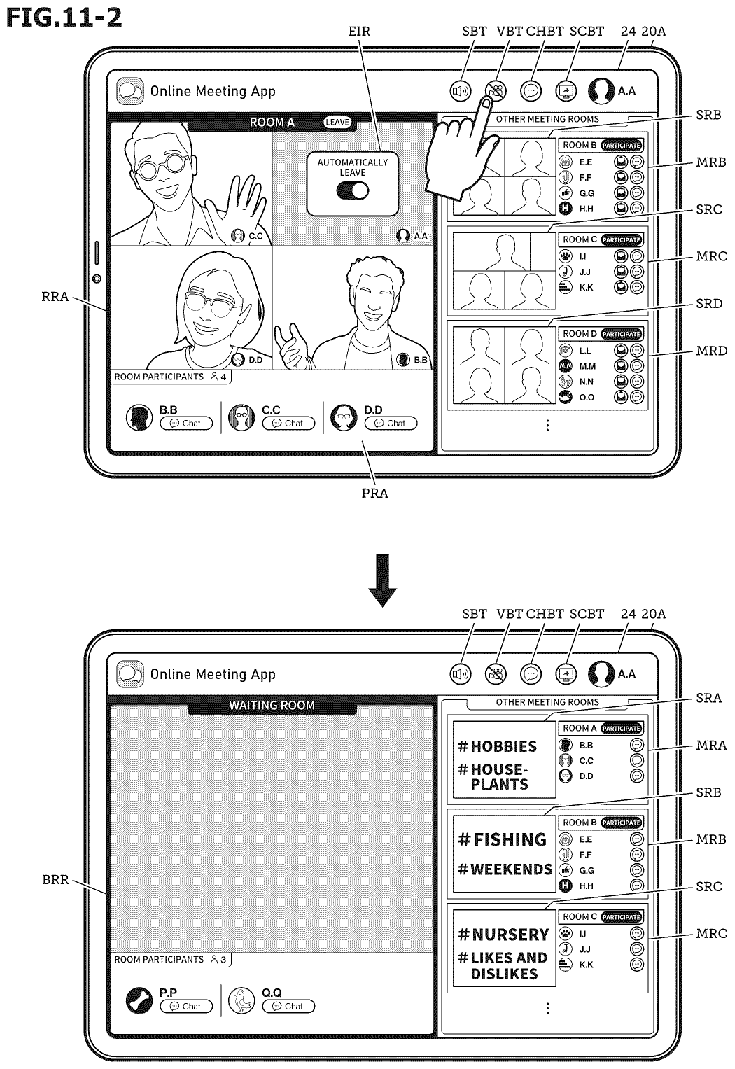

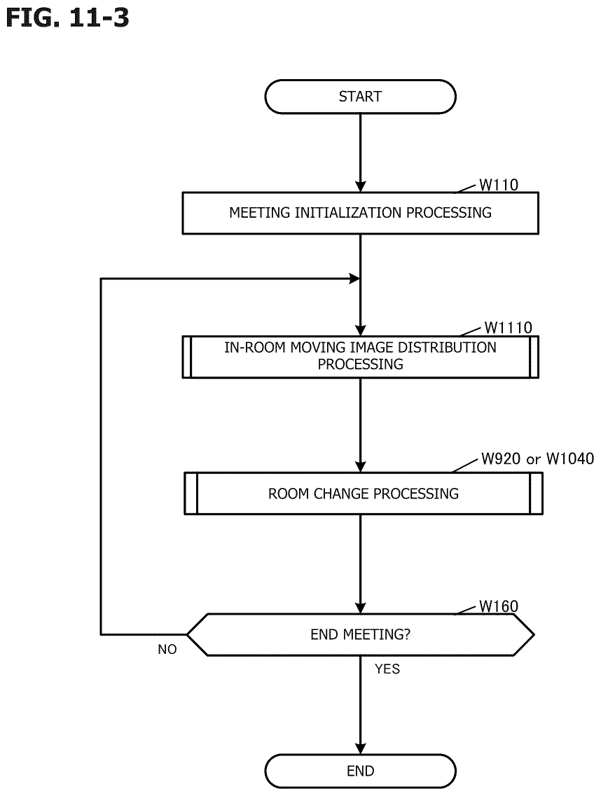

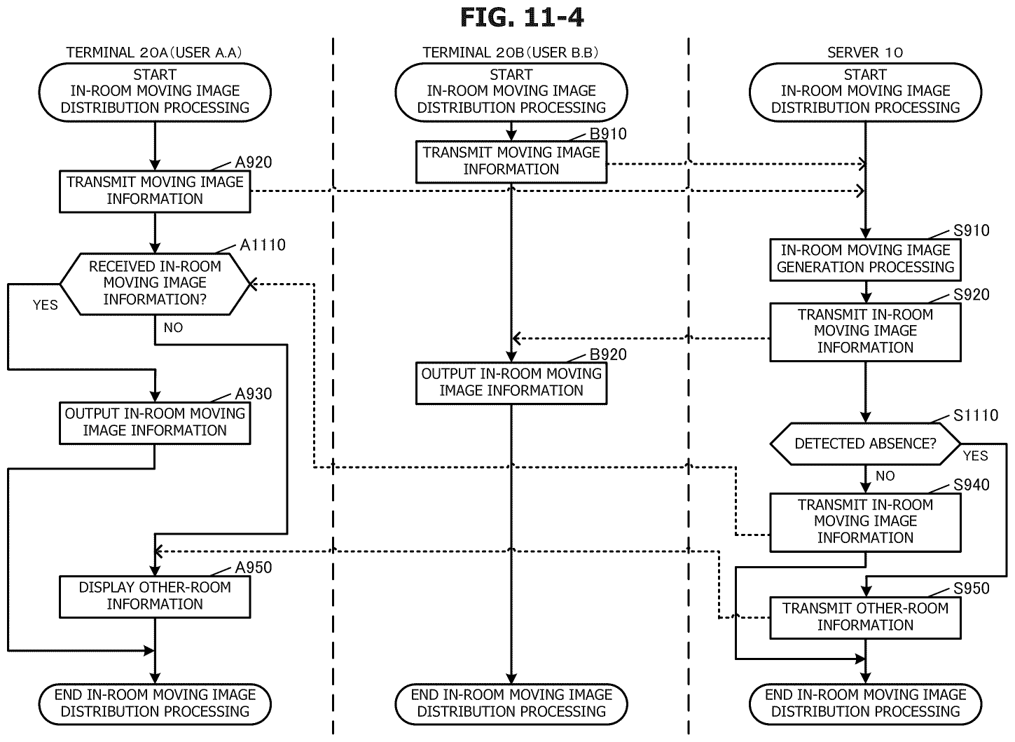

An upper diagram of FIG. 11-1 shows an example of a screen displayed on the terminal 20A of the user A.A participating in the room A.

In this example, as a result of a user A having left their seat during a meeting, a video showing that the user A.A has left their seat (a video including a chair in which the user A.A has been sitting), which is captured by the image capturing device 27, is displayed in a region in the meeting room region RRA where the video of the user A is to be displayed.

A lower diagram of FIG. 11-1 shows an example of a screen displayed on the display 24 of the terminal 20A if, thereafter, a set condition is met.

In this example, it is determined that the user A.A is away from their seat (in a non-limiting example, a state of being away from their seat for a fixed time period or longer) based on no person having been detected for a set time period or longer (or for more than a set time period) in the video captured by the image capturing device 27 of the terminal 20A, in a non-limiting example. In this example, a state is shown in which the user A.A has moved to the waiting room based on the determination result.

For example, a screen including the aforementioned waiting room region BRR and waiting room participant region PRBR is displayed. Further, other-room information display regions MRB, MRC, MRD, . . . that include respective sub-regions SRA, SRB, SRC, . . . displaying words (room topics, room tag notification information) related to topics in the other rooms including the room A are displayed on the right side of the waiting room region BRR and the waiting room participant region PRBR.

An upper diagram of FIG. 11-2 shows an example of a screen displayed on the terminal 20A of the user A.A participating in the room A.

In this example, as a result of the user A tapping a video button VBT on the terminal 20A of the user during a meeting, the video (in a non-limiting example, a video captured by the image capturing device 27 of the terminal 20A) of the user is hidden. Further, in this example, a slide button is displayed together with a word “auto-leave” in a region for displaying the video of the user A.A in the meeting room region RRA, and the slide button has been turned ON by the user A.A.

The slide button can be a button to be used to make the user of the terminal (in this example, the user A.A) automatically leave the room A, in a non-limiting example.

Further, in this example, the user is moved to the waiting room if a set condition is met after the video button VBT was tapped or after the slide button was turned ON.

Note that a configuration may also be employed in which if the slide button is turned OFF, the user is not made to automatically leave the room even if the set condition is met.

A lower diagram of FIG. 11-2 shows an example of a screen displayed on the display 24 of the terminal 20A if the aforementioned set condition is met.

In this example, the user A.A has been moved to the waiting room based on a set time period or longer has elapsed (or more than the set time period has elapsed) since the video button VBT was tapped or the slide button was turned ON, in a non-limiting example.

Here, the user A.A in this example automatically leaves the room based on the video button VBT having been operated to turn OFF video, but there is no limitation to this configuration.

In a non-limiting example, the user A.A may alternatively be automatically made to leave the room in the same manner as described above, based on the user A.A operating a speaker button SBT to turn OFF sound (mute sound).

### Processing

FIG. 11-3 is a flowchart showing an example of a flow of processing executed in the communication system 1 according to the present example embodiment.

After step W10, the communication system 1 performs in-room moving image distribution processing (W110).

FIG. 11-4 is a flowchart showing an example of a flow of in-room moving image distribution processing according to the present example embodiment. The flowchart shows processing executed by the controller 21 of the terminal 20A, processing executed by the controller 21 of the terminal 20B, and processing executed by the controller 11 of the server 10, in order from the left.

After step S920, the controller 11 of the server 10 performs user absence detection (S1110). For example, in a non-limiting example, it is determined whether or not any user is away from their seat based on moving image information transmitted from the terminal 20A and moving image information transmitted from the terminal 20B (as well as moving image information transmitted from the other room member terminals). “Absence/being away from their seat” means that a user is temporarily away from their seat for some reason (e.g., rest).

More For example, in a non-limiting example, the controller 11 of the server 10 performs person detection processing on video information included in each piece of the moving image information, and if no person is detected for a set time period or longer (or for more than a set time period), the controller 11 determines that the user of the terminal 20 that has transmitted the corresponding piece of moving image information is away from their seat.

Note that in this case, the controller 11 may alternatively determine that the user of the terminal 20 that has transmitted the corresponding piece of moving image information is away from their seat if no person is detected until a set time.

Further, in a non-limiting example, a configuration may alternatively be employed in which the controller 11 of the server 10 performs speaker detection processing on sound information included in each piece of the moving image information, and if no speaker is detected for a set time period or longer (or for more than a set time period), the controller 11 determines that the user of the terminal 20 that has transmitted the corresponding piece of the moving image information is away from their seat (this may be considered as absence determination based on the amount of speech of the user of the terminal 20).

Note that in this case, the controller 11 of the server 10 may alternatively determine that the user of the terminal 20 that has transmitted the corresponding piece of the moving image information is away from their seat if no speaker is detected until a set time.

As mentioned above, the controller 11 of the server 10 may determine that the user of the terminal 20 is away from their seat if a set time period or longer has elapsed (or more than a set time period) since the user of the terminal 20 turned OFF video.

Note that in this case, the controller 11 may alternatively determine that the user of the terminal 20 is away from their seat if video remains OFF until a set time after the user of the terminal 20 turned OFF the video.

As mentioned above, the controller 11 of the server 10 may determine that the user of the terminal 20 is away from their seat if a set time period or longer (or more than a set time period) has elapsed since the user of the terminal 20 turned OFF sound.

Note that in this case, the controller 11 may alternatively determine that the user of the terminal 20 is away from their seat if sound remains OFF until a set time after the user of the terminal 20 turned OFF sound.

If it is determined that the absence has been detected (S1110: YES), the controller 11 of the server 10 advances the processing to S950.

On the other hand, if it is determined that the absence has not been detected (S1110: NO), the controller 11 of the server 10 advances the processing to S940.

After step A920, the controller 21 of the terminal 20A determines whether or not the in-room moving image information has been received from the server 10 by means of the communication I/F 22 (A1110).

If it is determined that the in-room moving image information has been received (A1110: YES), the controller 21 of the terminal 20A advances the processing to A930.

If it is determined that the in-room moving image information has not been received (A1110: NO), the controller 21 of the terminal 20A advances the processing to A950.

Returning to FIG. 11-3, after step W1110, the controller 11 of the server 10 performs room change processing (W920 or W1040). If the user A.A is not moved to the waiting room, the room change processing in the aforementioned step W920 can be applied. If the user A.A is moved to the waiting room, processing in the aforementioned W1040 can be applied.

The controller 11 of the server 10 then advances the processing to step W160.

Note that the server 10 performs the absence detection in the above processing, but there is no limitation to this configuration. The terminal 20 may alternatively perform the absence detection. In this case, the terminal 20 can perform absence detection for the user of the terminal 20 using the same method as above, and if it is determined that the absence has been detected, the terminal 20 can transmit absence detection information indicating that the absence has been detected to the server 10 by means of the communication I/F 22.

In a non-limiting example, the absence detection performed by the controller 21 of the terminal 20 may be realized by means of person detection processing based on video information (an image captured by the image capturing device 27) as mentioned above, or may be realized by means of speaker detection processing (determination about the amount of speech of the user of the terminal 20) based on sound information input by means of the sound input device 25 as mentioned above. In some example embodiment, the absence detection may be realized based on video or sound having been turned OFF, as mentioned above.

If absence is detected, in a non-limiting example, a blank screen may be displayed without moving the user to the waiting room as shown in FIGS. 9-1 and 10-3, instead of moving the user to the waiting room and displaying the screen of the waiting room as shown in FIGS. 11-1 and 11-2, in a non-limiting example.

### Effects of Eleventh Example Embodiment

In the present example embodiment, the acquirer of the terminal 20 acquires information related to the user of this terminal 20, and the controller 21 performs control to stop outputting moving image information transmitted and received in a first meeting room, based on the acquired information. The terminal 20 then displays other-room information (a non-limiting example of information indicating a first group and information indicating a second group different from the first group) on the display 24.

As an example of an effect of the example embodiment achieved by the above configuration, the terminal can acquire information related to the user of this terminal and stop outputting sound information and video information transmitted and received in the first group, based on the acquired information. In this case, due to the terminal displaying the information indicating the first group and the information indicating the second group different from the first group, the user of the terminal can check the information indicating the first group and the information indicating the second group even if the output of the sound information and the video information transmitted and received in the first group is stopped.

In this case, the acquirer of the terminal 20 is the image capturing device 27 of the terminal 20, and the terminal 20 may use an image captured by the image capturing device 27 to acquire whether or not the captured image includes the user of the terminal 20.

As an example of an effect of the example embodiment achieved by the above configuration, the terminal can easily and appropriately acquire (detect) whether or not the image captured by the image capturing device of the terminal includes the user of the terminal, and stop outputting sound information and video information transmitted and received in the first group, based on the acquired information.

In this case, the terminal 20 may acquire the amount of speech of the user of the terminal 20 by means of the sound input device 25 (a non-limiting example of an acquirer).

As an example of an effect of the example embodiment achieved by the above configuration, the terminal can acquire the amount of speech of the user of the terminal and stop outputting sound information and video information transmitted and received in the first group, based on the acquired amount of speech.

In this case, the terminal 20 performs, by means of the controller 21, control to stop outputting moving image information transmitted and received in the first group if video information captured by the image capturing device 27 of this terminal 20 is OFF for a set time period or until a set time (a non-limiting example of a case where video information captured by an image capturing device of a terminal is not transmitted to a first group for a set time period or until a set time). The terminal 20 then displays other-room information (anon-limiting example of information indicating a first group and information indicating a second group different from the first group) on the display 24.

As an example of an effect of the example embodiment achieved by the above configuration, the terminal can stop outputting sound information and video information transmitted and received in the first group if video information captured by the image capturing device of the terminal is not transmitted to the first group for the set time period or until the set time. In this case, due to the terminal displaying the information indicating the first group and the information indicating the second group different from the first group, the user of the terminal can check the information indicating the first group and the information indicating the second group even if the output of the sound information and the video information transmitted and received in the first group is stopped.

### Twelfth Example Embodiment

A twelfth example embodiment relates to an action that a meeting master can perform, in a non-limiting example.

The content described in the twelfth example embodiment can also be applied to any other example embodiments and modifications.

Constituent elements that are the same as those already described are assigned the same reference numerals as those used for corresponding elements, and a redundant description thereof is omitted.

### Display Screen

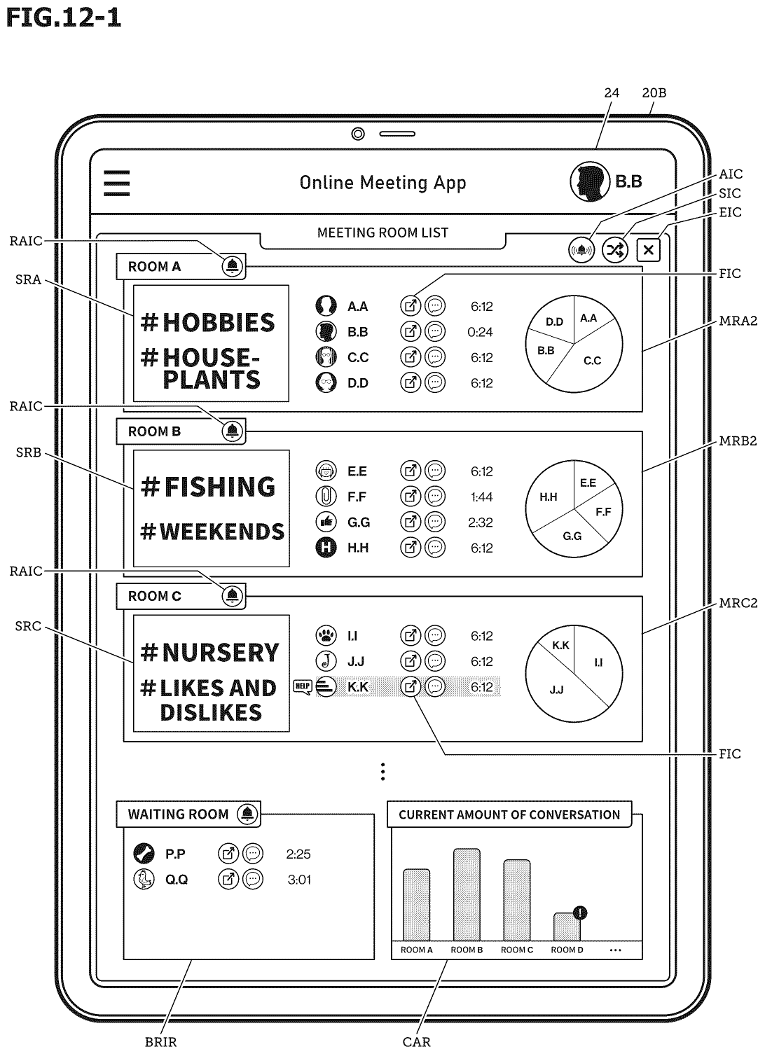

FIG. 12-1 is a diagram showing an example of a screen displayed on the display 24 of the terminal 20 of the meeting master. Here, an example of the screen is shown that is displayed on the display 24 of the terminal 20B of the user B.B, who is the meeting master and included in the room A.

This screen is an example of a meeting master management screen, and displays room information regarding respective rooms including the room of the meeting master, together with text “meeting room list”, in a non-limiting example.

In this example, room information display regions MRA2, MRB2, MRC2, . . . , which are similar to the aforementioned other-room information display regions MRA, MRB, MRC, . . . , are displayed for the respective rooms. For the respective rooms, the room information display regions MRA2. MRB2, MRC2, . . . include sub-regions SRA, SRB, SRC, . . . , which are similar to those of the aforementioned other-room information display regions MRA, MRB, MRC, . . . . In this example, words related to topics in the respective rooms are displayed.

A general announcement icon AIC for the meeting master to make a general announcement to all rooms, a shuffle icon SIC for shuffling room members for all rooms or some of the rooms, and a meeting end icon EIC for ending the meeting are displayed above the right side of the uppermost room information display region MRA2 for the room A.

If the general announcement icon AIC is tapped, and thereafter voice for a general announcement of the user B.B is input by means of the sound input device 25 of the terminal 20B, voice information for the general announcement is transmitted via the server 10 to each terminal 20 and is output in the form of sound on the terminal 20.

Note that the general announcement may alternatively be realized by transmitting a message.

Upon the shuffle icon SIC being tapped, room members are randomly shuffled by the controller 11 of the server 10, in a non-limiting example.

Note that the meeting master, namely the user B.B may be able to designate a room in which room members are to be shuffled.

Upon the meeting end icon EIC being tapped, meeting end information is transmitted to each terminal 20 via the server 10, and thereafter the meetings in all rooms end.

A room announcement icon RAIC for the meeting master to make a room announcement to the corresponding room is provided on the right side of the room name in the room information display region for each room.

If the room announcement icon RAI is tapped, and thereafter voice for a room announcement of the user B.B is input by means of the sound input device 25 of the terminal 20B, voice information for the room announcement is transmitted via the server 10 to each terminal 20 included in the corresponding room is output on the terminal 20.

Note that the room announcement may alternatively be realized by transmitting a message.

Information related to room members of each room is displayed on the right side of the sub-region within the corresponding room information display region, and information such as the icon image, the username, the chat icon of each room member, as well as a forced move icon FIC for forcing the room member to move to another room, and a time period for which the room member has been staying in the meeting room, is displayed.

On the right side of that information, a speech amount graph is displayed that represents the amount of speech of each room member in the corresponding meeting room in a pie chart, in a non-limiting example. Performing such display enables the meeting master to ascertain the degree to which each room member speaks in the corresponding meeting room.

Note that the speech amount graph is not limited to a pie chart, and may alternatively be a bar chart or the like. In some example embodiment, specific numerical values (of the number of times, frequency etc.) indicating the amount of speech may be displayed.

In this example, a waiting room information display region BRIR including information related to the waiting room is also provided at a lower left portion of the screen. In the waiting room information display region BRIR, information related to room members of the waiting room is displayed, and information such as the icon image, the username, and the chat icon of each room member in the waiting room, as well as a time period for which the room member has been staying in the waiting room is displayed, in a non-limiting example.

Further, a conversation amount region CAR displaying information regarding the amount of conversation in each meeting room is provided on the right side of the waiting room information display region BRIR. In this example, the conversation amount region CAR displays a conversation amount graph, in which the amount of conversation in each meeting room are represented in a bar chart, in a non-limiting example.

The conversation amount region CAR also displays cautionary information in association with a meeting room with the smallest amount of conversation. In this example, a caution mark is displayed in association with a bar of the room D in the conversation amount graph based on the amount of conversation in the room D being the smallest. Performing such display enables the meeting master to ascertain the liveliness of conversation in each meeting room.

Note that the conversation amount graph is not limited to a bar chart, and may alternatively be a pie chart or the like. In some example embodiment, specific numerical values indicating the amount of conversation may be displayed. Further, without limitation to displaying a caution mark, a bar corresponding to the room with the smallest amount of conversation in the bar chart may be displayed in a blinking manner.

In this display screen example, a help sign indicating that a user K.K, who is a room member of the room C, is asking for help is displayed in a field displaying information related to the user K.K, and the display field of the user K.K is displayed in a display mode different from that of the display fields of the other users.

This can be displayed on the meeting master management screen based on help information being transmitted from the terminal 20K of the user K.K to the server 10. In a non-limiting example, a user who is bored with the meeting in the meeting room of the user or wants to exit from this meeting room can transmit the help information to the server 10 by operating the terminal 20 of the user. The controller 11 of the server 10 can transmit the received help information to the terminal 20 of the meeting master.

In this example, upon receiving the help from the user K.K, the meeting master, namely the user B.B can operate the forced move icon FIC displayed in association with the user K.K in a non-limiting example, and move the user K.K to the room D with the smallest amount of conversation, in a non-limiting example.

Note that to carry out the forced move, the user B.B may optionally gain consent from the user K.K.

Note that forced move can be realized through the aforementioned room change processing performed by the controller 11 of the server 10, and the description thereof is omitted accordingly.

### Processing

Regarding processing performed in the present example embodiment, the controller 11 of the server 10 determines whether or not a request for information for displaying the meeting master management screen has been received from the terminal 20 of the meeting master at a timing before step W160, for example, in the processing performed in the communication system 1 including the processing shown in FIG. 1-10, in a non-limiting example. If it is determined that the request has been received, the controller 11 of the server 10 acquires information necessary for displaying the meeting master management screen.

For example, in a non-limiting example, the controller 11 of the server 10 identifies the meeting management data in which the meeting master ID of the meeting master is stored, in the meeting management database 155. Based on the meeting room management data included in the meeting management data, the controller 11 acquires various types of information regarding each room, such as the latest room topic, the amount of speech of each room member, and the participation status (ON/OFF) of each room member.

The controller 11 of the server 10 calculates, for each room, a ratio of the amount of speech between room members within the room based on the amount of speech of each room member included in the room.

The controller 11 of the server 10 also calculates, for each room, the amount of conversation in the room by, for example, adding up the number of times of speech by the room members in the room. The controller 11 then turns ON a low conversation amount flag for a room with an amount of conversation that is smaller than or equal to (or smaller than) a set number.

The controller 11 of the server 10 transmits the above information to the terminal 20 of the meeting master by means of the communication I/F 14. The terminal 20 of the meeting master displays the meeting master management screen on the display 24 based on the information received from the server 10.

Note that the server 10 generates display information for displaying the meeting master management screen including graphs and the like, and transmits the generated display information to the terminal 20 of the meeting master. The terminal 20 of the meeting master user may display the meeting master management screen including the graphs and the like based on the received display information.

In some example embodiments, the terminal 20 of the meeting master may generate graphs and the like based on information received from the server 10 and display the graphs and the like on the meeting master management screen.

That is, during display of the meeting master management screen, whether the terminal 20 or the server 10 generates constituent elements such as the graphs may be programmed in any manner.

Further, in a non-limiting example, the terminal 20 of the meeting master may transmit information regarding the amount of speech of each room member to the terminal 20 of the room member via the server 10. The terminal 20 may display the received information regarding the amount of speech on the display 24.

Note that the controller 11 of the server 10 may transmit information regarding the amount of speech of a user other than the meeting master to the terminal 20 of the user based on a request from the terminal 20 of the user as mentioned above, instead of a request from the terminal 20 of the meeting master.

By doing so, the user of each terminal 20 can be aware of the amount of speech thereof.

The present example embodiment describes a configuration in which the terminal 20 acquires the amount of speech of the user of the terminal 20 by means of the controller 11, the communication I/F 14, or the like (a non-limiting example of an acquirer).

As an example of an effect achieved by the above configuration, the terminal can acquire the amount of speech of the user of the terminal. Further, in a non-limiting example, the terminal can enable the user of the terminal to ascertain the amount of speech thereof by displaying the acquired amount of speech on the display.

### Thirteenth Example Embodiment

In the thirteenth example embodiment, the method of the present disclosure is applied to a meeting different from face-to-face meetings described in the above first to twelfth example embodiments and respective modifications.

The content described in the thirteenth example embodiment can also be applied to any other example embodiments and modifications.

Constituent elements that are the same as those already described are assigned the same reference numerals as those used for corresponding elements, and redundant description thereof is omitted.

Unlike the first to twelfth example embodiments and the respective modifications, the present example embodiment describes an example in which groups of users are formed without rooms or the like (rooms, teams, channels etc.). That is, groups according to the present example embodiment do not involve rooms or the like.

However, the present example embodiment is the same as the first to twelfth example embodiments and the modifications in that a group can be considered as a gathering consisting of at least one user when users communicate using an application or the like, and can also be considered as a type of data (data configuration), as mentioned above.

### Display Screen

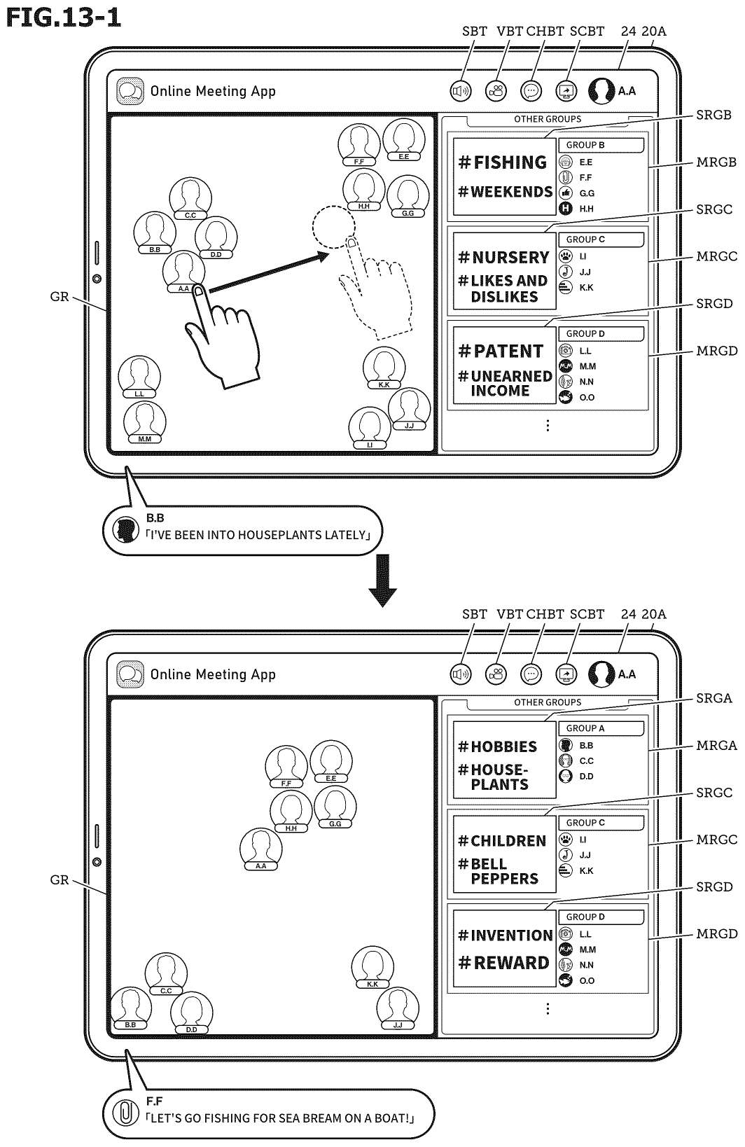

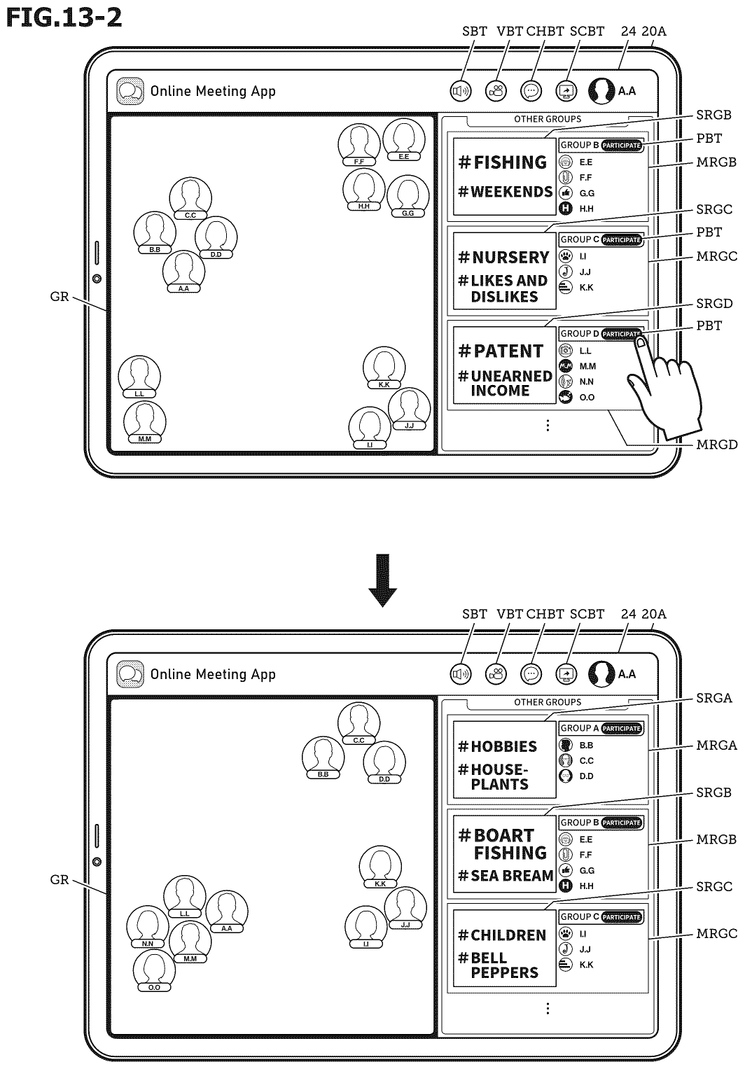

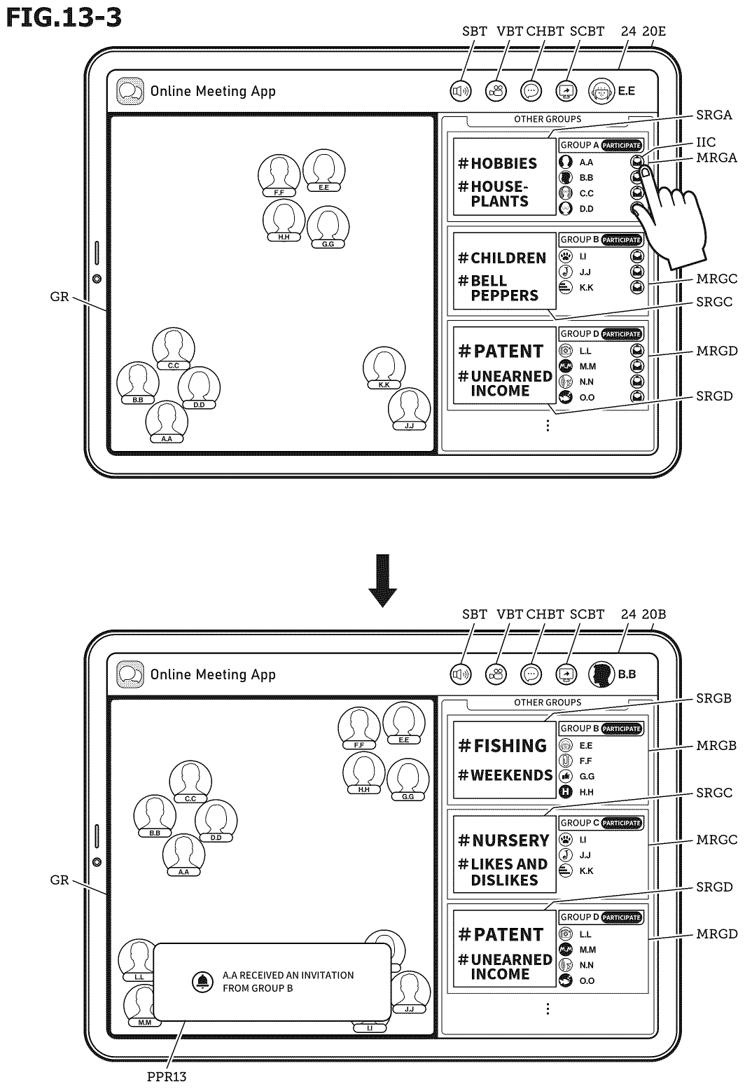

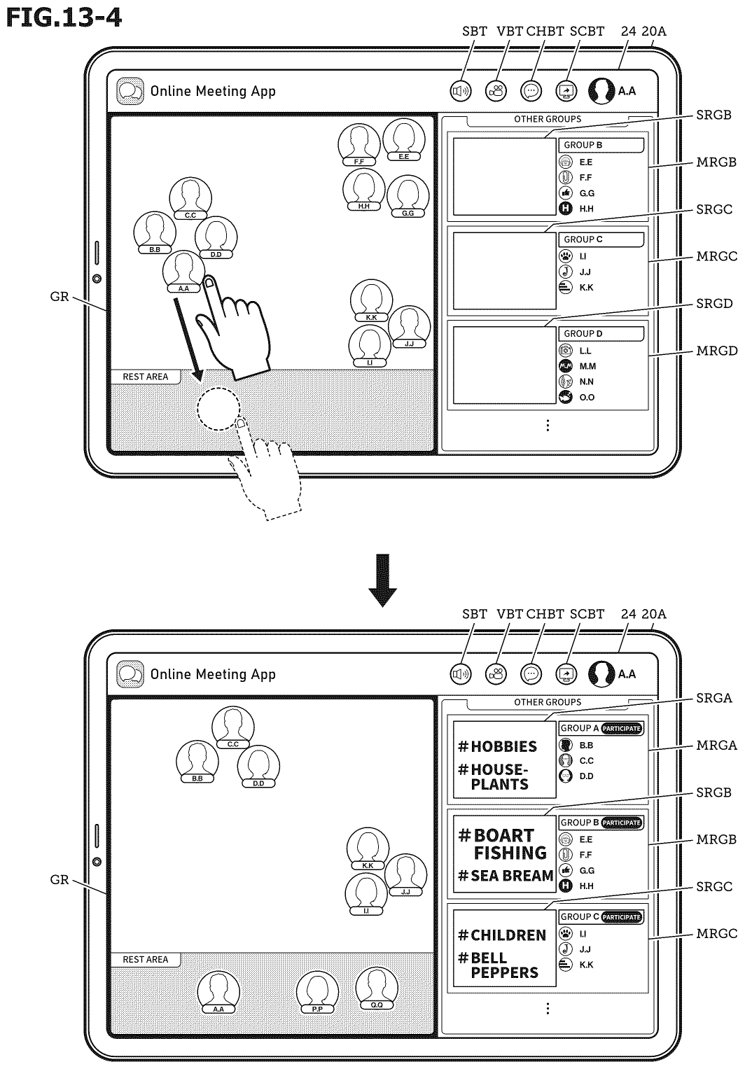

An upper diagram of FIG. 13-1 shows an example of a screen displayed on the display 24 of the terminal 20A of the user A.A in the present example embodiment.

In a non-limiting example, this screen is an example of a screen in which information indicating users of the terminals 20 is displayed in a two-dimensional virtual space (virtual two-dimensional space, virtual plane).

The information indicating each user (as a mode of indicating each user) may be at least one of a username, an icon image, a character, an avatar, and an image of the user's face, in a non-limiting example. In this example of the display screen, each user is indicated by information combining the icon image and the username (which will be hereinafter referred to as an “avatar” for convenience of description). A virtual region GR, which includes avatars of the users, is displayed.

Note that the virtual space may also be considered a type of metaverse. The virtual space may also be a three-dimensional space (virtual three-dimensional space). In this case, a character, an avatar, or the like that is modeled in the virtual three-dimensional space may be used as the information indicating each user.

In this example, the user of each terminal 20 can operate the terminal 20 at their preferred location (a location that is convenient for the user) and have conversations or the like with other users via the server 10 while operating their own avatar located in the virtual space.

Conversations in the virtual space can also be considered a type of online meeting, and the term “online meeting application” is also used here similarly to the above example embodiments. However, there is no limitation thereto, and a term such as “metaverse application” may also be used.

In the present example embodiment, users whose avatars are included in a certain range in the virtual space can transmit and receive sound information (in a non-limiting example, voice information of each user that is input to the sound input device 25) and video information (in a non-limiting example, video information captured from the viewpoint of the avatar of the user; an image of the user's face captured by the image capturing device 27 may also be transmitted) between those terminals 20 via the server 10, in a non-limiting example. This may make the users feel as if users close to each other in the virtual space can hear each other's voices and see each other.

More For example, although each user can operate their avatar located in the virtual space and freely move and converse without being aware of the concept of groups (users are not explicitly grouped), in the method of the present disclosure, the terminals 20 and the server 10 can perform processing similar to that of the above-described example embodiments while considering a cluster consisting of a group of avatars (users thereof) in the virtual space as a “group”.

In this example, the server 10 performs grouping (group classification), and information regarding the other groups is displayed as information based on the grouping results on the right side of the virtual region GR. In this example, information indicates that the users are grouped into a group A, a group B, a group C, . . . . In the present example embodiment, users included in the same group may be referred to as “group members”, and the terminals 20 of the users included in the same group may be referred to as “group terminals”.

In a non-limiting example, the controller 11 of the server 10 performs grouping based on the distance between the avatars in the virtual space.

In a non-limiting example, in a first step, users of two avatars between which the distance is shorter than or equal to a set distance (or shorter than the set distance) in the virtual space are grouped together, and a representative position (in a non-limiting example, a barycenter) of this group is calculated. In a second step, if there is an avatar located within the set distance (or within less than the set distance) from the representative position, the user of this avatar is also included in the group, and the representative position is calculated again. Thereafter, the second step is repeated. That is, a user of an avatar that is included in a desired (or alternatively, predetermined) range from the barycenter of a group is included in that group. Note that the barycenter may be calculated from the positions of the avatars of all users included in the group, or may be calculated from the positions of the avatars of some of the users included in the group.

If an avatar moves away from the representative position by more than a set distance (or by the set distance or farther), the user of this avatar is removed from the group, and the representative position of the group is calculated again.

Note that the position of an avatar of a specific user included in a group may be the representative position, instead of the barycenter. In this case, the avatar of a user that has approached the avatar of the specific user included in a group is included in that group.

Each user performs a moving operation, i.e., touches and moves their avatar, which is then moved in the virtual region GR.

In this example, currently, the server 10 has classified the users A.A to D.D as the group A, the users E.E to H.H as the group B, the users I.I to K.K as the group C, and the users L.L to O.O as the group D.

Along with this, in the upper diagram of FIG. 13-1, another-group information display regions MRGB, MRGC, MRGD, . . . corresponding to the respective groups B, C, D, . . . , namely the groups (other groups) other than the group A as which the user A.A has been classified, are displayed in the same manner as the aforementioned other-room information display regions, on the right side of the virtual region GR. The another-group information display regions include sub-regions SRGB, SRGC, SRGD, . . . , which are similar to the aforementioned sub-regions. In this example, words (group topics, group tag notification information) related to topics in the respective groups are displayed in the sub-regions.

This example illustrates a state in which the user A.A has performed a moving operation, i.e. touched their avatar and slid the avatar to a location close to the cluster of the avatars of the users E.E, F.F, G.G. and H.H that is located in an upper-right direction. Then, a lower diagram of FIG. 13-1 is displayed.

As a result of the above moving operation, the avatar of the user A.A is moved and displayed near the cluster of four avatars of the users E.E, F.F. G.G. and H.H. Consequently, the user A.A is classified as the group B by the server 10, and the group B now includes a total of five group members, namely the users A.A and E.E to H.H. That is, reclassification of groups is performed.

Along with this, in the lower diagram of FIG. 13-1, the another-group information display regions MRGA, MRGC, MRGD, . . . , which include the another-group information regarding the groups A, C. D, . . . , i.e. groups including the group A from which the user A.A has exited and excluding the group B into which the user A.A has newly joined, are displayed on the right side of the virtual region GR.

An upper diagram of FIG. 13-2 shows an example of a screen displayed on the display 24 of the terminal 20A of the user A.A in the present example embodiment.

In this screen, a participate button PBT, which is similar to that of the above-described example embodiments, is provided in a region displaying the group name and the like in each of the another-group information display regions MRGB, MRGC, MRGD, . . . . This example illustrates a state where the user A.A has tapped the participate button PBT included in the another-group information display region MRGD for the group D. Then, a lower diagram of FIG. 13-2 is displayed.

After the above operation of the participate button PBT, the avatar of the user A.A is moved and displayed near the cluster of four avatars of the users L.L, M.M, N.N, and O.O in the virtual region GR. As a result, the user A.A is classified as the group D, and the group D now includes a total of five group members, namely the users A.A and L.L to O.O. That is, reclassification of groups is performed.

Along with this, in the lower diagram of FIG. 13-2, the another-group information display regions MRGA. MRGB, MRGC, MRGE, . . . that include the another-group information regarding the groups A, B, C, E, . . . i.e. includes the group A from which the user A.A has exited and excludes the group D into which the user A.A has newly joined, are displayed on the right side of the virtual region GR.

An upper diagram of FIG. 13-3 shows an example of a screen displayed on the display 24 of the terminal 20E of the user E.E in the present example embodiment.

In this screen, an invitation icon IIC, which is similar to that of the above-described example embodiments, is provided in association with each of the group members of the other groups in a region displaying the group name and the like in the another-group information display regions MRGA, MRGC, MRGD . . . . This example illustrates a state where the user E.E has tapped the invitation icon IIC associated with the user A.A included in the another-group information display region MRGA for the group A.

A lower diagram of FIG. 13-3 shows an example of a screen displayed on the display 24 of the terminal 20B of the user B.B included in the group A in this case.

As a result of the user E.E operating the invitation icon TIC to invite the user A.A included in the group A as mentioned above, information PPR13 indicating that the user A.A has been invited from the group B is displayed in the form of a pop-up in a lower part of the virtual region GR.

Note that in this example, member invitation information can be transmitted to the group terminals of the group A, similarly to the above-described example embodiments, and the information can also be displayed on the display 24 of the terminal 20B of the user B.B, i.e. a user other than the invited user A.A

Note that the member invitation information may alternatively be transmitted only to the terminal 20A of the invited user A.A, similarly to the above-described example embodiments.

An upper diagram of FIG. 13-4 shows an example of a screen displayed on the display 24 of the terminal 20A of the user A.A in the present example embodiment.

In this screen, no information is displayed in the sub-regions SRGB, SRGC, SRGD, . . . of the another-group information display regions MRGB, MRGC, MRGD, . . . .

Further, a rest area in the virtual space is provided below the virtual region GR. The rest area is a region equivalent to the aforementioned waiting room. This example illustrates a state in which the user A.A has performed a moving operation, i.e., touched their avatar and slid the avatar to the rest area. Then, a lower diagram of FIG. 13-4 is displayed.

As a result of the above moving operation, the avatar of the user A.A has moved to the rest area. In addition, based on the users PP and Q.Q also having performed a moving operation to move to the rest area, this example illustrates a state where three users, namely the users A.A, P.P. and Q.Q and are in the rest area, and these three users have been classified as a group in the rest area by the server 10.

With the movement to the rest area, words (group topics, group tag notification information) corresponding to the other respective groups are displayed in the sub-regions SRGA, SRGB, SRGC, . . . in the another-group information display regions MRGA, MRGB, MRGC, . . . for groups including the group A from which the user A.A has been removed, in the lower diagram of FIG. 13-4.

Note that the display may be switchable from a meeting screen represented by the above virtual space to a face-to-face meeting screen described in the first to twelfth example embodiments, and vice versa.

In this case, in a non-limiting example, a button such as a “switch mode” button may be provided on the display screen displayed on the terminal 20 of each user, and the controller 21 of the terminal 20 may switch the screen (mode) under the control of the server 10 based on the button having been tapped, and vice versa.

Even though such mode switching can be performed by one user, it is substantially impossible to conduct a meeting in either mode unless at least two users are in the same mode. Thus, a configuration may also be employed in which a message prompting users of the other terminals 20 to switch the mode is transmitted, or information similar to the aforementioned member invitation information (member-inviting state) is transmitted thereto.

### Processing

Processing in the present example embodiment can be similarly realized in accordance with the processing described in the first to twelfth example embodiments and the respective modifications, and the description thereof is omitted accordingly.

The content described in the first to twelfth example embodiments and the modifications can be applied similarly to the thirteenth example embodiments.

### Thirteenth Modification (1)

In the thirteenth example embodiment, at least one virtual building (in a non-limiting example, an image of a conference room or a meeting room) may be configured as a type of area in the virtual space, in addition performing the grouping based on the distance between the avatars (a non-limiting example of information indicating users) in the virtual space as described above. The server 10 may classify users of avatars located in the same building as the same group. That is, the users may be grouped based on the locations of the avatars in the virtual space.

Note that at least one area (meeting space etc.) other than a building(s) may be configured in the virtual space, and the same processing may be performed for that area.

In these cases, when an avatar enters an area, the display of the terminal 20 may be automatically switched to the face-to-face meeting screen described in the first to twelfth example embodiments, under the control of the server 10. Alternatively, after the avatar has entered the area, the screen (mode) may be manually switched by operating a button or the like, similarly to the above.

In a non-limiting example, the server 10 may transmit information indicating that group users have been classified as the same group to group terminals of these group users classified as this group. Each of the group terminals that have received the information may perform control to change the display mode of information indicating the user of the terminal 20 based on the received information. If, in a non-limiting example, an avatar is used as information indicating a user, control may be performed such that the same color is applied to avatars in the same group, or the same mark or icon is attached to the avatars in the same group.

The server 10 may designate a range in the virtual space that includes information indicating users corresponding to users classified as the same group, and the terminal 20 may display, based on that designation, an effect indicating that these users are in the same group in the virtual space.

In the above example, groups are clearly displayed in the virtual space from the viewpoint of the terminal (user), and the user can ascertain which group the user belongs to by looking at the display in the virtual space. If, in a non-limiting example, this display is considered as a type of UI (GUI), each group may also be considered as being expressed by the UI (GUI), as mentioned above. Further, each group may also be considered as being the same as or similar to the aforementioned room or the like (room, team, channel etc.).

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

It should be understood that example embodiments described herein should be considered in a descriptive sense only and not for purposes of limitation. While some example embodiments have been particularly shown and described, it will be understood by one of ordinary skill in the art that variations in form and detail may be made therein without departing from the spirit and scope of the claims.

1. A non-transitory computer readable medium storing a program that, when executed by processing circuitry, causes a terminal to output sound information and video information transmitted and received in a first group of an online meeting, by performing a method comprising:
receiving, by a communication device of the terminal, information transmitted to the first group and related to an invitation to a second group given to a user of the terminal; and
performing, by the processing circuitry, control to give notification of the information related to the invitation.

2. The non-transitory computer readable medium according to claim 1, wherein the information related to the invitation is transmitted from a first user included in the second group to the first group, or transmitted from the second group to the first group.

3. The non-transitory computer readable medium according to claim 1, wherein the notification of the information related to the invitation is given by displaying the information on a display of the terminal.

4. The non-transitory computer readable medium according to claim 3, wherein
the information related to the invitation includes first information for participating in the second group, and
the method further comprises causing the terminal to perform processing related to participating in the second group by the processing circuitry, based on an input to the first information by the user of the terminal.

5. The non-transitory computer readable medium according to claim 1, wherein the method further comprises:
causing the terminal to display information indicating the second group and information indicating a third group on a display of the terminal; and
controlling the terminal to change, by the processing circuitry, a display mode of the information indicating the second group, based on reception of the information related to the invitation.

6. The non-transitory computer readable medium according to claim 1, wherein
the information related to the invitation is transmitted from a first user included in the second group to the first group, and
the method further comprises causing the terminal to display, on a display of the terminal, information regarding the first user included in the information related to the invitation.

7. The non-transitory computer readable medium according to claim 6, wherein the information regarding the first user includes video information transmitted from a first terminal of the first user.

8. The non-transitory computer readable medium according to claim 6, wherein the methods further comprises:
causing the terminal to perform, by the processing circuitry, processing to invite the first user included in the second group to the first group, based on an input made by the user of the terminal to the information regarding the first user displayed on the display.

9. The non-transitory computer readable medium according to claim 1, wherein
the information related to the invitation is first invitation information, and
the method further comprises causing the terminal to display, if second invitation information different from the first invitation information is received by the communication device, information regarding a first inviter of the first invitation information and information regarding a second inviter of the second invitation information on a display of the terminal.

10. The non-transitory computer readable medium according to claim 1, wherein the method further comprises:
causing the terminal to transmit, by the communication device, to the second group, information related to an invitation to the first group given to a second user included in the second group.

11. The non-transitory computer readable medium according to claim 10, wherein the information related to the invitation to the first group includes information regarding a message for the second group.

12. The non-transitory computer readable medium according to claim 1, wherein the method further comprises:
causing the terminal to transmit, by the communication device, second information indicating interest in the second group to the second group or a second user included in the second group, based on an input made to the terminal by the user of the terminal.

13. The non-transitory computer readable medium according to claim 12, wherein the second information includes information related to making a request to transmit the information related to the invitation.

14. The non-transitory computer readable medium according to claim 12, wherein the method further comprises:
causing the terminal to display third information that is based on information transmitted and received in the second group on a display of the terminal; and
transmitting, by the communication device, the second information based on an input to the third information.

15. The non-transitory computer readable medium according to claim 1, wherein
the notification of the information related to the invitation is given by displaying the information on a display of the terminal, and
the method further comprises causing the terminal to transmit, by the processing circuitry, information related to declining the invitation to an inviter that has transmitted the information related to the invitation, based on an input to the information related to the invitation.

16. The non-transitory computer readable medium according to claim 1, the method further comprises:
causing the terminal to perform, by the processing circuitry, control related to participating in the second group if a set time period has elapsed since, or a set time has arrived after the notification of the information related to the invitation is given.

17. An information processing method to be performed by a terminal that outputs sound information and video information transmitted and received in a first group of an online meeting, the method comprising:
receiving, by a communication device of the terminal, information transmitted to the first group and related to an invitation to a second group given to a user of the terminal; and
performing, by processing circuitry of the terminal, control to give notification of the information related to the invitation.

18. A terminal configured to output sound information and video information transmitted and received in a first group of an online meeting, the terminal comprising:
a communication device configured to receive information transmitted to the first group and related to an invitation to a second group given to a user of the terminal; and
processing circuitry configured to perform control to give notification of the information related to the invitation.

19. A terminal configured to output sound information and video information transmitted and received in a first group of an online meeting, the terminal comprising:
a processor configured to read a program stored in a memory and execute processing based on the program such that the processor is configured to cause the terminal to
receive, by a communication device of the terminal, information transmitted to the first group and related to an invitation to a second group given to a user of the terminal, and
perform control to give notification of the information related to the invitation.

20. A server configured to relay sound information and video information transmitted and received in a first group of an online meeting, and relay sound information and video information transmitted and received in a second group different from the first group, the server comprising:
a communication device configured to receive information transmitted by a second terminal of a second user included in the second group and related to an invitation to the second group given to a first user included in the first group; and
processing circuitry configured to perform control to cause the communication device to transmit the information related to the invitation to a terminal included in the first group.
